(19) United States
(12) Patent Application Publication
(10) Pub. No.: US 2026/0018012 A1
(43) Pub. Date: Jan. 15, 2026

(54) Item Distribution System

(71) Applicant: John Larson, Celina, TX (US)

(72) Inventor: John Larson, Celina, TX (US)

(21) Appl. No.: 19/268,265

(22) Filed: Jul. 14, 2025

Related U.S. Application Data
(60) Provisional application No. 63/671,254, filed on Jul. 14, 2024.
(60) Provisional application No. 63/681,884, filed on Aug. 12, 2024.

(30) Foreign Application Priority Data
Jul. 13, 2025 (GB) 2511319.2

(51) Int. Cl. G07F 11/62; G06Q 20/32

(52) U.S. Cl. CPC G07F 11/62; G06Q 20/322

(57) ABSTRACT

A method for providing item access comprises an item being locked in a storage area of a storage apparatus via a lock; an unlocking code, to unlock the lock, being provided to a user, via an electronic device of the user; and the storage area being unlocked by the user via using the unlocking code. Disclosure is provided of the user paying for the item. Short-range communication/interaction technology, such as QR code, may be used to facilitate the unlocking code being provided to the user.

### REFERENCES TO RELATED APPLICATIONS

This application claims priority to provisional application U.S. 63/671,254, (filed Jul. 14th 2024); and provisional application U.S. 63/681,884, (filed August 12th 2024). This application also claims priority to British Patent Application [GB] number 2511319.2, (filed 13th July 2025). The disclosures of all of the aforementioned referenced applications are incorporated herein by reference, in their entirety.

The present invention relates an item distribution system. Disclosure is provided of a method of providing item access, wherein an item is locked in a storage area, and an unlocking code is provided to a user, via an electronic device.

### Terms/Definitions

### ‘Arrangement’:

The term arrangement is a technical term which means a feature, or combination of features, (usually with a given purpose). For example, a ‘measuring arrangement’ is a feature or features, to facilitate measuring. A ‘holding arrangement’ is a feature or features, to facilitate holding.

### ‘Feature’:

The term ‘feature’ is a broad term that includes within its scope any feature under the Sun. A feature may, for example, be an element, body, member, or may even be an aperture (eg opening/hole/gap or the such like). Thus the term ‘holding feature’ includes within its scope, for example, any element, body, member, or even aperture, to facilitate holding. A ‘feature’ may also be a ‘part’ of a broader feature; for example, if a part of an invention is disclosed/claimed as comprising a ‘padding feature’, this does not limit the padding feature to being a separate feature that is added to the invention (eg a sponge element, adhered to the invention); the invention, for example, may have a part made of sponge, or have an inner sponge (or soft) layer-in such a case, if that part of the invention is clearly of a material/nature that provides padding, then this falls within a scope of what is defined in the present application as a ‘padding feature’.

### ‘Substantially’:

It is known, to those with skill in the art of patenting, that the word ‘substantially’ can, in some instances, be used to broaden a term. It should be stated that, in the present application, use of the word ‘substantially’ with a term, to define a (characterizing) feature(s), gets all the benefit (ie the benefit of any broadening) afforded by use of the word ‘substantially’, and also includes within its scope the feature(s) being that term exactly, (without broadening). For example, if two features are described/defined in the present application as being ‘substantially parallel’, then that includes, within its scope, the features being ‘close’ to parallel (in so far as the word ‘substantially’ is deemed to broaden the term ‘parallel’), and also includes within its scope the features being ‘exactly’ parallel).

### ‘Velcro®’ and ‘Velcro®-Type’:

It will be known that the term ‘Velcro®’ has become synonymous (in layman's terms) for hook-and-hook, hook-and-loop, loop-and-loop, and all such similar attachment solutions. In the present application, where the term ‘Velcro®’ is used, in includes within its scope all of the above, and whatever solutions would be considered to be, from a layman's point of view, ‘Velcro®’. Thus it is a broad term. The term ‘Velcro®’, or ‘Velcro®-type’, may be used, (in the disclosure generally, and may also be used in a claim(s)), and is thus a broad term which includes within its scope any solutions/features which would be considered, from a layman's point of view, to be ‘Velcro®’

### ‘Attached’ And ‘Connected’:

If a feature (or two features) are defined in a claim as being attached, that would include within its scope the feature (or two features) being permanently attached, (of course), and would also include within its scope the feature (or two features) being removably attachable, (because, if removably attachable, the feature (or two features) can be attached, and therefore, when attached, would be within a scope of being ‘attached’). Furthermore, the feature (or two features) being defined in a claim as being ‘attached’ would also include within its scope the feature that is defined as being ‘attached’ being formed as one part with a portion or a whole of the other feature it is defined as being ‘attached’ to. For example, if a table leg is defined in a claim as being ‘attached’ to a table top, that would include within its scope the table leg being formed as one part with a whole of the table top (eg if the table leg and table top were formed as one piece of plastic, for example) and would also include within its scope the table leg being formed as one part with a portion (rather than a whole) of the table top (eg if the table top was formed of more than one part, and the table leg was formed as one part with a part of the table top, but not a whole of it). (It would also include within its scope a portion (rather than a whole) of the feature that is defined as being ‘attached’ being formed as one part with a portion (or a whole) of the other feature it is defined as being ‘attached’ to. Thus if the table leg had a separate top half and bottom half, for example, (that are attached together, in use), an embodiment where the top half of the leg is formed as one part with a portion (or a whole) of the table top would also be within a scope of the table leg being ‘attached’ to the table top). It should be noted, some (few) patent offices require structural connection/relationship terms (in claims), to define structural connection/relationship between features of the claim. With this in mind, (and if it should be required, although it often is not), the term ‘connected’, if used in a claim, is a broad term, which includes within its scope direct connection, and also includes within its scope indirect connection. (′Direct′ connection would be where two features, for example, are directly connected to each other (eg an arm is ‘directly’ connected to a shoulder). ‘Indirect’ connection would be where two features, for example, are connected, but via intermediate feature(s) (eg a person's foot is ‘connected’ to their head, but ‘indirectly’, (via their leg, abdomen, torso, etc, which are ‘intermediate features’)). Where the term ‘connected’ is used in a claim, it includes within its scope ‘direct’ connection, and also includes within its scope ‘indirect’ connection. The term may be used in a claim, (and is deemed supported), whether ‘direct’ and/or ‘indirect’ connection embodiment(s) is (/are) disclosed in the present application, and, as stated, includes within its scope ‘direct’ connection, and also includes within its scope ‘indirect’ connection. Furthermore, if a feature(s) is (/are) defined as being ‘connected’, that would include within its scope the (or any-ie more than one of the said) feature(s) being removably attachable, if, when attached, the feature(s) is (/are) in a state of being ‘connected’, (directly or indirectly). Thus if a first feature is defined as being ‘connected’ to a second feature, it would include within its scope the first feature and/or the second feature being removably attachable, if, when attached, the first feature is connected to the second feature, (directly or indirectly). Furthermore, of course, (and similarly to the word ‘attached’), if a feature (or two features) are defined in a claim as being ‘connected’ it would also include within its scope the feature that is defined as being ‘connected’ being formed as one part with a portion or a whole of the other feature it is defined as being ‘connected’ to.

### ‘The Or Each’ And ‘The Or Any’:

The term ‘the or each’ (either in disclosure and/or a claim) can refer back to a single feature/thing, and/or can refer back to a plurality of features/things. When the term is read as referring back to a plurality of features/things, it should be taken as meaning, and including within its scope, ‘at least one, or more, or all (ie each)’ of the said features/things. Thus, to give an example, if a square is referred to/disclosed that has four corners, if the term ‘the or each corner’ is used, it includes within its scope ‘one of the corners, (or two, or three, or all of the corners)’.

When any one feature/thing is afforded any feature(s)/definition in the present application, it is taken as read that, where a plurality of the said feature/thing is provided, ‘the or each’ said feature/thing may be provided/claimed comprising the said feature(s)/definition (ie at least one, or more or all). Similarly, wherever a plurality of the said feature/thing are afforded any feature(s)/definition, it is taken as read that ‘the or each’ said feature/thing may be provided/claimed comprising the feature(s)/definition (ie at least one, or more, or all of the plurality), and/or that even just one said feature/thing may be provided/claimed comprising the feature(s)/definition in an embodiment/claim wherein an invention is defined as comprising ‘a’ (eg singular) said feature/thing.

(The term ‘the or any’ may be used (again including within its scope, ‘at least one, or more, or all (ie each)’, instead of the term ‘the or each’).

### ‘User Means’:

It will be well known that, in certain patenting territories, (for example, the United States), use of the term ‘means’ or ‘means for’, if used in a (granted) patent claim, can be seen as a limiting term, limited to only giving the applicant/proprietor of the patent protection of means that are disclosed in the granted patent, or ‘equivalent’ means. This is not the case with the term ‘user means’ as it is used in the present application. The term ‘user means’ is a very broad term that is used in the field of product design/user-interface, and defines any means under the sun, provided for a user, for whatever action/result the user means is provided for. For example-a ‘user means’ to turn on a television could be provided by way of an ON/OFF button on the television. But it could also be provided by a button on a remote control which turns on the television when pressed. Both of these would fall (in the technical field of product design/user-interface) under the scope of the term ‘user means’ to turn on the television. Similarly, with certain inventions/products, a ‘user means’ may be provided to ‘initiate’ an action, for example. Thus, in the present application, a claim that defines an invention which comprises a ‘user means’ for [a particular action/result] is not subject to any ‘means for’ limitations that certain patent office territories (such as the United States) may appropriate to the term ‘means for’, but should be read as (and given protection for, if granted) any means under the sun, provided for a user, for [that particular action/result defined]. ‘User means’ is a technical term in the field of product design/user-interface.

### Reference To Multiple Similar Elements In Plural

In the present application, there may be provided/numbered features wherein the same primary number is used, with a suffix. For example, a first side of the/an invention may be numbered 600′, and a second side of the/an invention numbered 600″. In any such case, (or where any other suffix is used, such as ‘L’ and ‘R’ to denote ‘left’ and ‘right’, or ‘a’ and ‘b’, for example), when such features are referred to together (ie ‘the sides’), the plural may be numbered/referred to with the primary number (without the suffix). Thus the first side 600′ (or 600a, for example) and second side 600″ (or 600b, for example) may, for example, be referred to simply as ‘the sides 600’. Furthermore, if a side is referred to (not specifying 25 which one of the sides), the primary number (ie 600, for example) may be used, without any suffix.

### BACKGROUND

Over the past few decades, multiple industries have been disrupted and democratized. Not long ago, taxi and chauffeur businesses were some of the few businesses that could sell rides to people. With the introduction of ride-hailing apps, now almost anyone with a car and a phone can use their car to earn income by providing people with rides. Ride-hailing apps effectively ‘democratized’ the business of transporting people, opening up opportunities for people (to generate money/profit/income) that were not previously available.

Similarly, in the past, lodging income was gained primarily from people who owned a hotel, hostel or bed-and-breakfast. With the introduction of technology that allowed people to use their phones (or, generally speaking, to use ‘the internet’, (via any relevant device(s)) to offer their own houses for short-term rentals, the lodging industry was ‘democratized’, where now almost anyone with a house and an electronic device (such as a smartphone) can earn income by offering a short-term rental of their home, (or even simply just a room(s) within their home).

Now speaking about distribution of items, machines that distribute items, (such as snack vending machines, for example), are common throughout the United States and other countries of the world. These machines typically have a power source connected to the machine and have a means of making payment via the machine itself, such as any of: a coin slot, cash receiver, credit card reader, text-to-pay, QR code payment system, etc, etc (or the like). However, these machines do not provide a means of distributing an item corresponding to a digital payment unless the parts in or on the machine are connected to a power source. For example, these types of modern vending machines that accept digital payments, such as a credit card, require electronics and therefore a form of power, such as a direct connection to an electrical outlet, (ie ‘mains’ outlet), for example, or a battery source to power the/any electronic/digital payment module/aspect (or any electronic interface(s) and/or system(s)). (Power may also be required for other aspects/actions, eg the movement of coils, (or any relevant feature(s)) of the machine, to distribute snack(s) after the/a payment is made. Without a source of power, (such as battery-power or electricity), these machines do not operate. Because of this, these machines typically need to be located in areas with a power source close by, such as a wall outlet, (ie ‘mains’ electricity outlet). However, this poses a challenge, since there are many areas/locations that people may like to purchase items with a digital payment method that are not close to a power source, (and may areas/locations that could be retain opportunities for such sales to be made), such as, for example, when people are sitting out on a beach without nearby power sources or in an area(s) of a room, for example, where an electricity outlet, (eg a mains power plug input point), or battery source is not present.

(Furthermore, even if an interface, such as a QR code, were provided where a user could use their smartphone to purchase an item (stored in a machine), the machine would still require electronics to unlock and distribute the item, and thus would still require a power source, and would suffer from all the other pitfalls that electronics can, in terms of possible malfunctions, etc).

An additional challenge with item distribution machines that require a power source is maintenance costs, which can be high, as there are more technical components that can wear out or malfunction, (such as the chip(s) (or any relevant electronic component(s)) used to operate the/a payment module, for example, and/or mechanical piece(s) (eg relevant to electronic functioning) of the machine itself wearing out.

Electrical cord(s), for example, can fray over time and may require replacement. Furthermore, the software used for the machine to function may require occasional updates and/or checks from IT staff, for example. A further challenge is that most of these machines require a Wi-Fi connection to be available nearby in order to operate the digital payment module. (This may be relevant for the functioning of the/a credit card reader, for example). This further limits where these machines can be placed, since, even if they have a nearby power source, they also then need a nearby Wi-Fi source to operate. Needing Wi-Fi available for these machines can potentially mean additional costs to access the Wi-Fi as well as the risk of the payment module (and thus the machine itself, potentially) not operating when Wi-Fi is down/interrupted for any reason(s), (such as the maintenance of Wi-Fi passwords changing, to give just one example).

Furthermore, item distribution apparatuses, such as modern vending machines, that require power have electrical components that may require the machine to be larger, (as opposed to an apparatus that does not need a power source). This ‘size’ issue may be even further exacerbated if the machine has moving parts, (eg a coil(s) or the like), that are used to ‘move’ any item(s) that has been purchased, for example). This ‘size’ issue is more important than one may at first think, because it may well rule out use of such a machine (ie a machine that requires electrical power) in places/positions that could otherwise be used as potential sales locations/positions, eg use on a chair, (eg hung on a chair, or merely positioned on a chair in any place/way), on side of a chair, on a (small) desk, in a recess of a wall, (or a shelf(s) for example, or, (as will be explored), in a vehicle, for example, as well as many other possible places/venues), by/near a mirror, on a door, (eg hung on or in any way held to (eg attached to) a door), and/or any other place(s), as a few examples. If an apparatus was provided that could be used in any such locations, it would provide significant opportunities in location placement. With this in mind, (and recognizing and understanding such missed opportunities), very significant opportunities for people to purchase items (and sellers to sell items) via electronic payment are being missed. Furthermore, machines such as modern vending machines, (for any or all of the above reason), can be relatively expensive to manufacture and/or buy. It would be desirable if far cheaper apparatuses (for selling from), possibly even what could be stated as being more ‘low-tech’ apparatuses) could be provided. This could allow person(s), (potential ‘sellers’), a low-cost, low-hassle way of generating revenue they otherwise would not be able to generate. These could be sellers who would otherwise not be able to afford such machines (eg vending machines, as mentioned), and/or would consider it too much of a risk (or simply too much work/consideration), to enter into selling items in such a way.

(It should also be briefly mentioned, there are some forms of distribution apparatuses that do not require a source of power to operate, such as traditional bubble gum dispensers, for example, which use mechanical mechanisms to distribute candy after coins are inserted. However, these dispensers, and similar machines, are unable to distribute their items in response to electronic payment, (they do not offer this), Furthermore, they do not involve the possibility of transfer of data, (eg online, or in any other way). (Thus they do not offer functionality such as the possibility of submission of payment or data into a (online) form, for example, since they only accept physical types of payment, such as coins, etc). (And they do not provide any possibility for interaction/communication with a smartphone (or any electronic device of a user), at all). Furthermore, even though these machines accept physical payment types, such as coins, today, a large portion of people use digital forms of payment more than coins and cash, (or don't even keep cash on them), as the popularity of mobile devices (and electronic payment via them) has grown. Because of this, many users do not have coins and cash on them when they encounter a traditional item distribution apparatus (such as a bubble gum dispenser). An additional challenge with machines that distribute items without electricity and don't accept digital forms of payment, (such as bubble gum machines), is that the time and money needed to operate them can be higher, as employees need to regularly visit the machine to empty out coins and then deposit those coins in a bank, which requires additional travel time, possible wear-and-tear on a vehicle, for example, and labour hours, as opposed to electronic payment that receive funds and automatically deposit those funds into a bank account without staff needing to visit the apparatus (eg bubble gum dispenser) and transport the coins to a bank. There is also more security/protection required for these types of apparatuses, (in terms of ‘build structure’), such as using heavier, more durable material(s) for the machine, (like metal, for example), to prevent people from tampering with the apparatus, (to get to where money is stored in the apparatus), which becomes another added cost in the production of the machine.

There are also traditional forms of item distribution, such as fruit stands with shelves, often placed on the side of the road, which are used to sell items based on an ‘honour system’, where customers place money into a tin can when they purchase a piece of fruit. This system of item distribution does not require a source of power, however, this form of item distribution does not provide protection for the items before they are sold. (They are not secured in any way). Some customers may take items without paying for them, since the items are not secured. (This is as opposed to modern vending machines, for example, where the item(s) tends to be behind a covering (often glass or plastic), thus preventing access until the item(s) is purchased).

It would be desirable if a solution was provided that leverages all the benefits of an apparatus, (for storing (and possibly selling) item(s))), that does not rely upon electronics to store item(s) securely, but that allows for electronic payment (eg via a smartphone of a user) to allow access to the item(s).

### SUMMARY

An invention(s) is defined by the accompanying claims, to which reference should now be made.

Examples of the present invention seek to provide a solution to any or all of the above problem(s) by providing, according to one aspect of what is invented: a method for providing item access, comprising: an item being locked in a storage area of a storage apparatus via a lock; an unlocking code, to unlock the lock, being provided to a user, via an electronic device of the user; and the storage area being unlocked by the user via using the unlocking code; wherein the lock is a non-electronic lock.

Note: The term ‘non-electronic lock’ refers to the lock ‘function’-ie as opposed to an electronic lock that can be unlocked remotely with a smartphone, (or any relevant electronic device), for example. Thus, as stated, the term ‘non-electronic’ lock refers to the lock ‘function’, (in terms of unlocking). For example, if a lock was provided that requires manual unlocking, (being a ‘non-electronic lock’), even if inane further electronics were added, (eg a lighting system, (with electronics for the lighting), to light the lock in the dark), that would still, for the sake of the present application, be a ‘non-electronic lock’, because the lock function itself is ‘non-electronic’. Thus the term ‘non-electronic’ refers to the lock ‘function’ itself, and does not preclude the possibility of a lock that comprises electronic element(s) that are not to do with the lock function itself. (For example, if a lock was provided that requires manual unlocking, (in no way being an ‘electronic lock’ in terms of how it locks/unlocks), then even if electronics were added to it to be able to play audio, for example, it would still, for the sake of the present application, be an example of (and thus within a scope of) being a ‘non-electronic lock’, because the electronics to do with the playing of audio have nothing to do with the actual lock function itself, which is non-electronic. Thus, to make clear again, when using the term ‘non-electronic’ lock, this is referring to the ‘lock function’, (ie non-electronic, in lock function). Thus this has been made clear. (Nevertheless, disclosure is provided in the present application (eg in the Figures) of wherein the (or any) lock(s) have no electronics (for any reason/function), and thus require no electric power at all. Examples are shown in the Figures that are within a scope of wherein at least one lock requires no electric power at all. Examples are shown in the Figures that are within a scope of wherein a plurality or all of the locks require no electric power at all).

Preferably the storage apparatus comprises more than one storage area. (Disclosure is provided in the present application within a scope of wherein the storage apparatus comprises more than one storage area within which an item is locked via a lock). However, it should be stated, even an apparatus that comprises just one storage area would be an example of a storage apparatus, (and would, of course, be an example of a storage apparatus that comprises a storage area).

Preferably there is more than one storage area within which an item is locked via a lock, the method further comprising: the user choosing one or more than one of the storage areas to unlock; and an unlocking code being provided to the user, via the electronic device of the user, for each of the storage areas chosen by the user for unlocking. (Disclosure will be provided/explained/explored of wherein a separate unlocking code is provided for each of the storage areas chosen by the user for unlocking). (More than one of the storage areas may be provided by way of a storage unit. Preferably all the storage areas are provided by way of one storage unit).

The method may comprise a user paying for the item via the electronic device of the user. This can become a useful way to generate revenue. However, it should be stated, it may be free to unlock the/a storage area(s). (For example, ‘free trials’ could be provided. This could allow companies to provide an item free to the user. Data from the user may even be captured that can be helpful to the/a provider(s) of the item). Thus various options and/or embodiments are possible.

The method/apparatus may be used in many ways. For example, it could be used in a vehicle. It could be used in a train, for example. A particularly interesting and/or beneficial use may be if it is used for a taxi, for example. Thus the storage apparatus could be provided in a taxi. (Furthermore, the/a driver may be able to choose stock and/or to re-stock, etc). (The/a driver may be able to change unlocking code(s) for storage area(s)). (A storage unit(s) of the storage apparatus may be held to a seating apparatus(es) of the vehicle, (eg in this example, a seating apparatus(es) of a taxi). (The term ‘held to’ includes within its scope being hung on and/or attached to, for example). (Note: A storage unit(s) may be held to any area(s) of a vehicle, not limited to being held to a seating apparatus(es). For example, some taxis, especially, have a ‘divide’, (may be referred to as a ‘partition’, or ‘wall’ or ‘barrier’), that separates the driver area and the passenger area. In such case, it is feasible a storage unit(s) is held to such a feature, (which maybe referred to by any of the terms just mentioned). This can aid desired positioning of the storage unit. This can also aid security, (eg by attaching the storage unit, to help prevent possible theft of the storage unit)). Passengers may then be able to purchase item(s) from the storage apparatus. Thus a ride-hailing app driver (or any taxi driver) earning income with their car/taxi can now also put a version of the storage apparatus in their car, (eg hung on a seat(s), eg over the back of a seat(s)) so that a passenger(s) can use their smartphones, for example, (or any usable electronic device, perhaps) to purchase and get access to item(s)-Items could include gum, mints, drinks, (eg bottled drinks, eg canned drinks, etc), and/or other item(s) during their ride. This therefore can open up the possibility of added income for the driver. (It should be stated, such use could generate money for a party(s), not limited to (and possibly not even including) the/a driver). And because the apparatus need not rely upon electronics for any locking, (and because embodiments can be provided that do not rely upon electric power at all, (for any reason/function)), it is possible the storage apparatus could be significantly inexpensive, (especially compared to a modern electric-powered vending machine, for example). And it could potentially be significantly compact in size. Items can now potentially be sold to passengers/customers in the vehicle while driving passengers/customers to their destination.

Note: It is here made clear, (for the sake of the present application at least), that the term ‘taxi’, if used in a claim, does not limit only to cars that are designed to clearly look like a taxi, (ie ‘black cabs’ in London, UK, or the traditional yellow cabs, (sometimes just referred to as ‘taxicabs’), prevalent in some parts of America). For example, more modern ‘car-hailing/hiring’ services, (often now run through apps on a smartphone, for example), where the car is a normal-looking car, but it is a passenger-fare based service, (clearly, of course, being a ‘taxi’), are included within the scope of being a ‘taxi’. Similarly, some taxi/cab services allow users to call a phone number to book/get a car to come pick them up. Again, this is a charged service, and is also a taxi service, (even though the car will often be a ‘normal-looking’ car. Thus the term ‘taxi’ does not require that the car look especially like a specialist taxi, (like the black and yellow cab services just mentioned, for example). Furthermore, the term ‘fare’ does not require that, (as in black cabs, for example, the amount charged is accrued during the taxi/cab journey-it will be apparent that many taxi services charge a set amount, dependent typically on the distance of journey. (Total payment may include consideration of other factors, as well, eg when the journey is undertaken, etc). Thus a ‘set amount’ charged is also, (at least for the sake of the present application), a ‘fare’. This is thus also relevant to trains, for example, (where the fare tends to be (or always is) a set amount. A ‘bus’ is another example of a vehicle. (And is another example of a passenger fare vehicle). A tram is another example.

The method/apparatus could also be used in accommodation. For example, it could be used in rental accommodation. (Eg rooms in hotels, (or any rental accommodation, eg bed-and-breakfasts, etc)). Again, this could be used to generate extra income. For example, a person renting out a room/place could include the storage apparatus in the room/place. Thus this could be used to facilitate the user (who is renting) purchasing item(s). Similarly, the method/apparatus could also be used in classes, (eg such as dance and/or exercise classes, for example). Gyms could also benefit.

Preferably the storage apparatus is in no way electrically powered. (This can be beneficial for the storage apparatus being as simple and/or inexpensive as possible).

Whilst Preferably the method comprises: the item being locked in the storage area prior to the user having any access to the item, the item not being a belonging of the user before being locked in the storage area, it should be stated, it is feasible the method comprises: the item being a belonging of the user before it is locked in the storage area; the user putting the item in the storage area before it is locked in the storage area; the user locking the item in the storage area; and after the user has locked the item in the storage area, the user using the unlocking code to unlock the storage area to get access to the item. This could be particularly relevant, for example, if the storage area at a holiday destination and/or venue and/or special event location. (The storage area could be a locker, for example). (It could be used at a location such as a theme park, for example. Or it could be at a theatre, for example. Or it could be at a festival, for example. User could put clothes and/or any personal item (s in the storage area, for example. Thus any of these things could be the/an ‘item’ that they may want to lock in a storage area. They can then come back at a later point, unlock the storage area, and get their item(s)). Thus various options are possible.

Preferably the electronic device is a smartphone. (However, it could be any electronic device. For example, it could be a desktop computer. (Thus, for example, the user could get the unlocking code on a desktop computer, via an email, for example). (Thus, for example, the user could make a selection on a desktop computer, for example). (Thus, for example, the user could pay for an item(s) on a desktop computer, for example). Thus various options and/or embodiments are possible). A smartphone is just one example of a portable electronic device. Other examples of a portable electronic device include, for example, tablet, laptop, smart watch, etc, etc. Thus disclosure is provided of wherein the electronic device is a portable electronic device. (And as has been stated, a smartphone is simply one example of a portable electronic device). (Note: The term ‘mobile device’ may be used, (rather than ‘portable electronic device’). The term ‘mobile device’ tends to be used more, to define such an electronic device).

The method may comprise the user scanning a QR code with the electronic device. (Disclosure will be provided of wherein this facilitates getting the unlocking code). (Preferably the QR code is provided on the storage apparatus. However, it should be stated, the/a QR code could be provided in proximity to, but not ‘on’ the storage apparatus. For example, (provided simply by way of example only), the/a QR code could be on a wall (or any surface) nearby to the storage apparatus, for example). But QR code is just one form of short-range communication technology, another being near-field communication (NFC), for example. Bluetooth is another example. Thus various options and/or embodiments are possible.

(Note: For the sake of the present application, QR code technology is considered to be within the scope of the term ‘short-range communication technology. It will be apparent that, in theory, scanning of QR code can be done from a very long way away, (ie if the QR code is big enough). But for the present application, (ie how it is used here), it will be used at short-range. Thus it is considered to be within the scope of being a ‘short-range communication technology’. (So too are NFC and Bluetooth, of course). It should also be stated, rather than the term ‘short-range communication technology’, the term ‘short-range interaction technology’ may be used. (Again, this includes NFC and Bluetooth, for example, within its scope. It will be understood that QR code can be a very effective and efficient short-range interaction technology. Millions of people each year use QR codes to facilitate interaction with their smartphones, and it can be an extremely time and cost effective solution).

Similarly, this method/apparatus can be extremely useful for adding to accommodation, (of any type). For example, host(s) (or any admin party) for rental places (eg room(s) or whole residences, for example-eg short-term vacation rental), can now not only carn income by renting, they can utilize the method/apparatus by adding a storage apparatus(s) to the premises, (whether it be shared premises or not), thus allowing guests/renters etc (or any person(s)) to purchase item(s), eg such as snacks, cookies, toys etc during their stay.

Furthermore, fitness instructors teaching classes, (or anyone teaching classes or having a gathering, or any event/meeting) can easily use one or more than one storage apparatus, (eg to a class they are teaching). Thus they can open up a retail opportunity. (And there is the added convenience of not having to actively ‘transact’/oversee the sale themselves, (and not needing any person(s) (eg staff)) either, to do this, but instead letting customers most likely handle the transaction via their own smartphone. Thus the customer could carry out electronic payment themselves and get access to the item themselves). And furthermore, because the storage apparatus can have such capacity to be highly transportable, the seller (eg a fitness or dance instructor, in this example), does not have to have a ‘dedicated’ studio/premises-instead, even if they travel to different places to do their instruction/classes/meetings/events, it is highly possible they may simply bring a storage apparatus(es) to wherever they go. Thus this can be a highly transportable retain opportunity.

Even businesses that traditionally have focused less on in-person retail experiences beyond drinks and food, (such as gyms, for example), could begin offering an expanded selection of items for sale, such as earbuds, fitness belts, gel inserts for shoes, for example, and/or any other items, by having a storage apparatus(es) in the gym/premises. (Multiple storage units could feasibly be used).

Many businesses may be able to expand their retail offerings, (or even provide retail offerings when they previously did not provide any). And this could be done without the need for constructing special/′designated′ retail space. And it is potentially feasible, in some or many cases, that it could be possible to do this without hiring more staff.

According to another aspect of what is invented, there is provided: a method for providing item access, comprising: an item being locked in a storage area of a storage apparatus via a lock; an unlocking code, to unlock the lock, being provided to a user, via an electronic device of the user; and the storage area being unlocked by the user via using the unlocking code. Thus, according to this aspect, the lock is not limited to being a non-electronic lock. For example, the lock may be an electronic lock. Furthermore, it should be stated, (and in line with this aspect of what is invented), it is here stated that, for any invention(s)/disclosure in the present application that comprises a non-electronic lock, according to this aspect of what is invented, there may be provided a lock, not limited to being a non-electronic lock. Thus the mere term ‘lock’ may be used. (ie Not limiting the lock). Thus, according to this aspect, the lock may be any lock. Thus the lock may be an electronic lock, for example. This lock may benefit from any of the benefits of electronic locks. It is therefore made clear here that a claim that does not limit the lock to being a non-electronic lock is fully supported, and this aspect may leverage/benefit from/include/be afforded any other feature(s)/disclosure provided in the present application. Thus this has been made clear. (Disclosure is here provided of wherein the/a lock(s) is not connected to an external power source. Even if a lock were to be provided that was electronic in any way to do with its lock function, if it is not connected/does not connect to an external power source, it is within this scope. Thus disclosure, for example, is provided of a lock does not require an external power source. Thus disclosure, for example is provided of a lock that does not require an external power source, to operate. Disclosure, for example, is here provided of a lock(s), for example, that operates independently of an external power source. Disclosure, for example is provided of a lock(s) wherein locking function of the lock operates/works independently of an external power source).

Note: Any of the aspects (of what is invented) may comprise/draw upon any of the feature(s) of any other aspect(s) of what is invented, and may draw upon any of the feature(s) and/or disclosure of the present application, as optional and/or preferable feature(s). Any aspect(s) (of what is invented) may comprise/draw upon any feature(s) of any other aspect(s) (of what is invented), whether the feature(s) be essential or preferable and/or optional to the other aspect(s) (of what is invented).

### BRIEF DESCRIPTION OF THE DRAWINGS

Examples of the present invention will now be more particularly described, with reference to the accompanying drawings, by way of example only, in no way limiting a scope of the invention, in which:

FIG. 1 is a front view of a storage apparatus that comprises multiple storage areas, which are shown closed and the locked, each one shown locked via a lock;

FIG. 2 is a close-up front view of one of the storage areas of the storage apparatus as shown in FIG. 1 with particular attention to an example non-electronic lock, so that its manual operation can be explained;

FIG. 3 is depicts an example system/process for how a user can purchase and retrieve an item from the storage apparatus with a smartphone, or any relevant electronic device;

FIG. 4 is a close-up front view of one of the storage area example doors, (which is an example of an openable and closable ‘closure element’), of the storage apparatus shown in FIG. 3, with particular attention to an example combination lock that does not require power, such as mains electricity or batteries, to operate, and with particular attention to a locking mechanism to lock the example storage area/storage area door;

FIG. 5 depicts an example system/process for how a user can get a free sample (free item(s)) from the storage apparatus, showing an example that includes the user submitting their contact information through a form on their electronic device (eg smartphone);

FIG. 6 depicts an example system/process for purchasing an item from the storage apparatus, using, in the example, a smartphone, now showing possible steps relating to re-stocking the storage apparatus and also suggesting ability of the system to monitor inventory, possibly with the ability to (automatically) order more inventory for the purpose of restocking the storage area(s) of the storage apparatus, if/when inventory is needed;

FIG. 7 depicts an example system/process for purchasing an item from the storage apparatus, with particular attention, in the example, to the retrieving (and providing to the user) of an unlocking code, to unlock a storage area, shown being done after the user, in the example, selects (and purchases, if payment is required) a storage area, which may be done by selecting an item(s) that is in the storage area;

FIG. 8 is a front perspective view of an example storage apparatus, showing an example storage unit, with particular attention to a possible display area of the storage apparatus, showing, in the example, the steps a user takes to purchase and get an item from the example storage apparatus, thus providing what could be called instructions to the user, there also being shown a QR code (or other feature) that can be used by the user, in the example, to initiate the process on their smartphone (or relevant electronic device), also showing how the QR code, for example, does not have to be on the storage apparatus, showing the possibility of it being in/on a booklet, for example;

FIG. 9 depicts an example system/process for a user to select and purchase an item from the/a storage apparatus and receive an unlocking code, with particular attention to the possible page(s) and/or screen(s) and/or interface(s) and/or message(s) and/or website URL(s) that may be part of the process;

FIG. 10 depicts an example system/process for a user to access an online interface with a smartphone (or other relevant electronic device) and receive an unlocking code to get item(s) from the storage apparatus, with particular attention to the/a possible system for how item(s) and/or pricing and/or other data/information provided to the user may be different, depending on what URL the electronic device (eg smartphone) of the user is driven to, (with the possibility of how item(s) and/or pricing and/or other data/information may be dynamically updated/changed (and possibly displayed) also explored);

FIG. 11 depicts an example system/process for a user to select and purchase product(s) for various prices from a storage apparatus that does not have a QR code (or the like, eg NFC tag, for example), on the apparatus itself but rather on another item near the apparatus, such as a booklet, in addition to showing examples of non-powered keypad lock(s) used for storage area locking;

FIG. 12 includes a back view of the/an example storage apparatus, with particular attention to an ‘extra opening’, showing how this can be useful for (an) admin party (eg staff), potentially to open multiple (or all) storage areas at once, and also showing/denoting, via a QR code in the example, a way/means for (an) admin party (eg staff) to access an interface (eg digital interface);

FIG. 13 is a basic depiction of a possible interface that may be accessed shown via the scanning shown in FIG. 12, which may be usable to update unlocking code(s) and/or inventory and/or other information/data associated with the storage apparatus;

FIG. 14 is a back side perspective view, showing an example seating apparatus, which may be a seat in a car but could be a seat in a different location, showing an example storage unit held to the seating apparatus, held to the back of the seating apparatus, in the example;

FIG. 15 is a view from an angle closer to a side view, showing a same or similar embodiment of a storage unit as shown in FIG. 14, again shown held to a seating apparatus, the angle showing that the storage unit comprises features to facilitate it being held to the seating apparatus;

FIG. 16 is an open top view of a vehicle, from a back and slightly raised angle, showing an example storage unit secured in the vehicle, secured to two front seats of the vehicle in the example, the storage unit being on the floor of the vehicle in the example; and

FIG. 17 is a basic representation of four possible example items that could be provided/sold via this method, showing an example, from left-to-right, of a chocolate bar, a beverage, gum, and an example ticket, for example to a show at a local theatre.

Note: At some patent offices, when claim(s) are allowed for patent, it is required that Figures that do not show all the feature(s) of the/an invention claimed (and/or that are not within a scope of what is claimed) are denoted as ‘not being claimed’ or ‘not within a scope of what is claimed’ (or words to that effect). Even in such case, it will be apparent that such Figure(s) may or do show feature(s) that are essential, or preferable and/or optional, to the/an invention claimed, which will be apparent, in light of the disclosure. Thus such Figure(s) (and/or disclosure related to such Figure(s) and/or embodiment(s)), should nevertheless be considered relevant to the/an invention claimed.

### DETAILED DESCRIPTION

Referring to the drawings, there is shown a method for providing item access, comprising: an item 13 being locked in a storage area 12 of a storage apparatus 10 via a lock 14; an unlocking code 58, to unlock the lock, being provided to a user, via an electronic device 20 of the user; and the storage area 12 being unlocked by the user via using the unlocking code 58; wherein the lock is a non-electronic lock.

(It should be stated, there could be more than one lock to lock a storage area. if this is the case, it is feasible one unlocking code may be usable to unlock both locks. It is also feasible more than one unlocking code may be provided (and needed), eg separate unlocking codes for two locks. It is stated clearly here, both these fall within the scope of what is defined, (both being considered within the scope of the definition of ‘an unlocking code, to unlock the lock, being provided to a user’). Thus if ‘another’ (eg ‘second’ unlocking code is provided for ‘another’ (eg ‘second’) lock, (to unlock a storage area), that is nevertheless within the scope of ‘an unlocking code, to unlock the lock, being provided to a user’. Thus this has been made clear. Furthermore, if language/definition is stated, stating something along the lines of ‘the user unlocking the storage area, (via) using the unlocking code’, then even if, (as mentioned above), there is more than one lock, that (ie there being more than one lock), is still within a scope of ‘the user unlocking the storage area, using the unlocking code’ if, as part of getting the storage area open, the user uses an unlocking code to open a lock, (whether there are any other locks or not). Thus this has been made clear. (Of course, this would also be within the scope of ‘the user unlocking the lock, using the unlocking code’, (whether there is another lock (eg needing another unlocking code) or not)).

It should also be stated, whilst locks tend to require an alphanumeric unlocking code, for example, it is feasible a lock(s) could be provided/used that instead requires the user to carry out a ‘sequence’, for example. (Thus, in such a case, the ‘sequence’ being provided to the user would be an example of (and thus is considered to be within the scope of) an ‘unlocking code’ being provided to the user). For example, there are locks often referred to as ‘directional combination padlocks’ or the like. These locks, instead of any alphanumeric code, for example, require a combination of manual direction/movement actions, to unlock the lock. For example, a user may have to manipulate an element of the lock first ‘right’, then ‘left’, then ‘up’, then ‘left’, then ‘down’, in order to unlock. Thus this sequence, in this example, would be the/an ‘unlocking code’. This could be communicated to the user in the way just mentioned, or, (perhaps better still), it could be provided in arrow icons, (eg ‘emoji’-type arrow icons).

And, of course, it is feasible this could be used to lock a storage area. (And, as stated, such ‘data/instruction(s)’ provided to the user, used to unlock such a ‘lock’, is considered, for the sake of the present application, to be an ‘unlocking code’, (and is thus within the scope of being an unlocking code)). In short, there are many ways a storage area may be locked, and many different types of lock, and it is made clear that the term ‘unlocking code’ is not at all limited simply to ‘alphanumeric’ codes, for example. Thus this has been made clear.

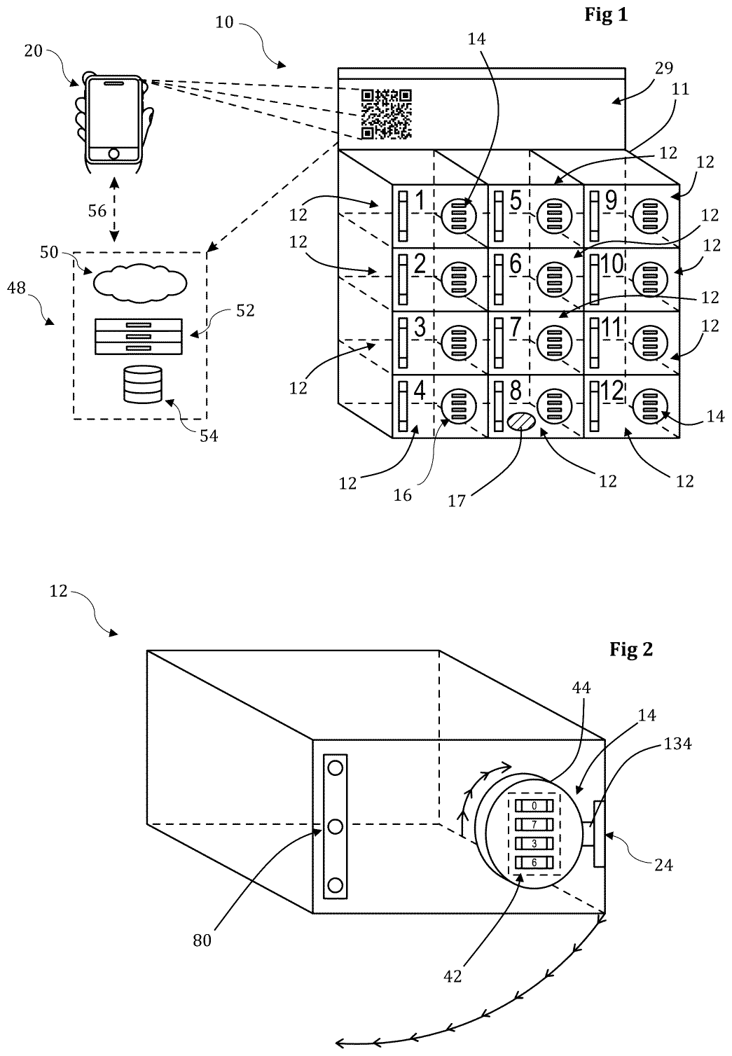

(It should also be stated, it is possible one lock could be used to lock more than one ‘sub-area’ for storage. If this is the case, all the ‘sub-areas’ together (that are lockable/unlockable by the one lock) are deemed to be a ‘storage area’, and each separate one within that storage area may be referred to as a ‘sub-area’ for storage, (ie a storage ‘sub-area’). To explain, looking at the example storage unit in FIG. 1 as an example to help explain this, and looking at the example storage area numbered ‘1’ and the example storage area numbered ‘5’, for example, if it is imagined that, instead of each having separate closure elements and each being separately locked, there was just one closure element, locked, that could be unlocked and opened to open both of those areas, then that would be considered just one storage area, (and each of those areas could be considered/referred to as a ‘sub-area’). (It would be an example of a storage area that comprises more than one ‘sub-area’, (and, as stated, the term ‘sub-area for storage may be used). Thus, as stated/explained, in a slightly differing embodiment to the example of FIG. 1, the example compartments numbered ‘1’ and ‘5’ (or any number of multiple compartments, in the example), could both be openable/closable together and lockable/unlockable together, being just one storage area that comprises multiple compartments, (ic those two example compartments in this example, provided by way of example only. (The example here of using the example storage unit/apparatus of FIG. 1 is taken simply by way of example only, to help explain this). Thus various options and/or embodiments are possible for a storage area, and the examples shown in the Figures, for example, are provided simply by way of example only)).

(It should also be stated, even if the ‘user’, for example, tells another person, (eg a family member or friend, for example), what the unlocking code is, and that other person uses the unlocking code to unlock then storage area, that is still, for the sake of the present application, deemed to be within the scope of ‘the storage area being unlocked ‘by the user’ via using the unlocking code′. Thus the term ‘user’ can be seen as a ‘collective’ term, ie the ‘collective’ user. (And if so desired, if more than one person is involved, with reference to the person that initiate the process, (ie the ‘main person’), the terms ‘direct’ and ‘indirect’ may be used-for example, if the ‘main person’ (who is provided with the unlocking code) gets a member of their family, for example, (or a friend, or a fiancé, for example), to unlock the storage area with the unlocking code the main person has received, this could be considered to be the storage area being unlocked by the ‘main person’ ‘indirectly’, (ia via another person), whereas if the ‘main person’ (who is provided with the unlocking code) does the unlocking themselves, that could be considered to be the storage area being unlocked by the ‘main person’ ‘directly’. Thus, (in any case), it has been made clear that this falls within the scope of the storage area being unlocked by the user via using the unlocking code, (especially since the term user can be seen ‘collectively’ in such way, ie as the ‘collective’ user).

Preferably, the item is a consumable product item. (Note: the term ‘consumable product’ is not a term that requires an item to be ‘edible. (The term ‘consumable products’ is a technical terms and means items that are used up or consumed during normal use and need to be replaced regularly. They are often contrasted with durable goods, which last for a longer period. Examples include food, beverages, office supplies (like paper and ink cartridges), and personal care items (like toiletries). For example, if the item locked in the storage area was a key, this would not be within the scope of being a ‘consumable product’ item. (Instead, it would be an example of a ‘durable goods’ item).

Preferably, the item is an edible item. (Examples of this would include gum, snack bars, beverages, etc).

Preferably, the method comprises the user paying for the item via the electronic device of the user. Note: This is significantly different from (and differentiates from) a situation where a person (user) rents (and therefore pays for) accommodation, for example, and is given an unlocking code to get access to a key that is stored away in a locked storage area. (ic The key is the ‘item’). In that situation, the user has paid for the accommodation-their getting of the key is ‘incidental’ and it is not the key (but instead is the room) that they have paid for. Thus the term ‘paying for the item’ would differentiate from such a situation.

Preferably payment for the item is for the user to own the item, (not merely a deposit for renting the item). (This may be referred to as an ‘ownership payment’). To explain, it is feasible an amount of money could be paid as a ‘deposit’ amount, to ‘rent’ an item. For example, the item could be a key, for example. Thus the key could be locked in a storage area. The user could make the payment, (eg a deposit of $5, for example), get the unlocking code, and unlock the storage area to get the key. The user could then have the key for an amount of time, (eg a prearranged amount of time, eg for access to accommodation). The user could then get their deposit amount (eg $5, in this example) back, after they have returned the key at a later point. Thus this would be an example of where payment is a ‘deposit’ payment for ‘renting’ the item. However, preferably payment for the item by the user results in the user owning the item. (As stated, this could be referred to as an ‘ownership’ payment). (This, (ie ‘owning the item’), does not, of course, require that the user must indefinitely ‘keep’ the item-for example, the item could be an edible item, for example, that thus can be eaten (eg very quickly after purchase). (And. More broadly, the concept of the item being a ‘consumable product’ item has been disclosed and explained, (rather than being a ‘durable goods’ item, for example))).

(It should also be stated, it is feasible payment can be made for an item but where payment is to rent the item, not to own it. For example, the item could be a basketball, and could simply be rented, for example. To explain, at a sports facility that includes a basketball court(s), a user could pay an amount, (eg $2.50, for example), to rent the basketball for an hour, (or any amount of time, with ‘one hour’ here being provided simply as an example). Thus, once they've paid, they can be given the unlocking code, to facilitate getting a basketball from a locked storage area).

(Note: It should be stated, if an item is paid for, and there are any extra additional ‘extraneous’ fees as part of what is paid, (eg a ‘tax(es)’ or special ‘fee(s)’ for using this method/apparatus, and/or for any other reason(s)), that is still within a scope of ‘paying for an item’, which will be apparent. Thus these considerations do not affect things. Furthermore, it should be stated, it is feasible, of course, that there are multiple items in a storage area. In such case, where a user pays to get multiple items from a storage area, (eg two packs of chewing/bubble gum that are in the same storage area, for example, or a beverage and some (eg plastic) cups that are in the same storage area, for example, or a sandwich and a beverage that are in the same storage area, for example), this is still an example of, (and thus is within a scope of ‘paying for the/an item’, because any of the items are ‘an item’ that's been paid for. (Furthermore, if so desired in the present application, the term ‘content’ or ‘contents’ of a storage area may be used. and it will be apparent that examples have been shown and/or described of paying for ‘content’ of a storage area. (Ss stated, if so desired, the term ‘contents’ may be used. Thus examples have been shown and/or described of paying for ‘contents’ of a storage area. (Whether the term ‘content’ or ‘contents’ is used, these terms include within their scope whether there is just one item, or a plurality of items). Thus this has been made clear, and no undue over-limitation should be unnecessarily read onto any terms and/or definitions in the present application)).

(Furthermore, it should be stated, if a fizzy drink, for example, is being bought by a user, (let us imagine for $2.50, for example), and the user pays, and gets the unlocking code for the storage area that has the fizzy drink in it, if the interface says something along the lines of ‘pay to get the unlocking code’ or ‘pay to open the storage area’ or ‘pay to unlock the storage area’, or the like, it will be apparent that this does not change the fact that this is an example of the item, (a fizzy drink, in this example), being paid for. Thus it would not change that this is an example within a scope of ‘the user paying for the item’, (the item here, in this example, (provided simply by way of example only, being then fizzy drink).

Preferably, the method comprises short-range communication occurring with the electronic device of the user via short-range communication technology. (Rather than the term ‘short-range communication’, the term ‘short-range interaction’ may be used. This is stated elsewhere in the present application). (Disclosure will be provided of wherein the method comprises short-range communication/interaction occurring with the electronic device of the user, to link the user to the unlocking code via the electronic device). (Disclosure is provided in the present application within a scope of wherein the unlocking code is electronically stored; and short-range communication/interaction occurs with the electronic device of the user via short-range communication technology, to facilitate the user getting the electronically stored unlocking code via the electronic device).

Disclosure is provided of short-range communication/interaction occurring with the electronic device (eg smartphone) of the user, to provide the user with the unlocking code, via the electronic device. (It can be said that disclosure is provided of short-range communication/interaction occurring with the electronic device (eg smartphone) of the user, to ‘link’ the user to the unlocking code, via the electronic device because, (whether it takes further steps for the user to go through (eg on an interface on their electronic device), the example, (eg using QR code technology, in the example), is an example of interaction that ultimately, (whether further steps are required or not, (eg a selection step and/or payment step, etc), facilitates the use getting the unlocking code. It thus can be said to ‘link’ the user to the unlocking code. As stated, in the example shown in FIG. 1, for example, (and also shown in other examples in the Figures), this is achieved via QR code. This is an example, (provided simply by way of example only), of short-range interaction technology. (At its most basic, there may be no further ‘steps’ necessary′. For example, if the/an unlocking code is being given away free, it is feasible, in some embodiments, a user could scan a QR code, for example, be sent to a URL by the QR code, and the URL, without any further action/steps needed by the user, could show the unlocking code. (This could be relevant, for example, to where a storage unit only has one storage area. Or this could be relevant, for example, in an embodiment where there are a plurality of storage areas, but a storage area(s) has its own QR code (or the like)). However, as will be shown in many of the Figures and the disclosure of the present application, preferably interaction with the electronic device (eg smartphone) drives/sends the user to an interface. (Various steps may occur through the/an interface, (eg selecting, (if there are a plurality of storage areas), and/or payment, etc, etc).

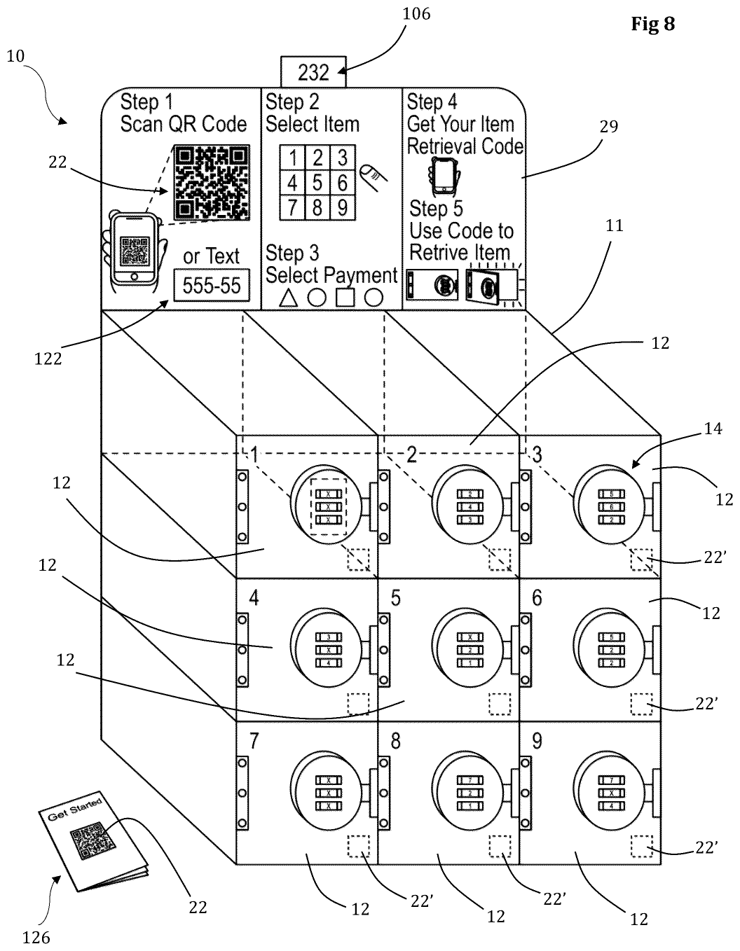

Preferably, the short-range communication/interaction is facilitated by way of a QR code, the method comprising the user scanning the QR code with the electronic device. (Preferably the QR code is on the storage apparatus. However, it should be stated, this may not be the case. For example, the QR code may be in proximity to the storage apparatus, but not ‘on’ the storage apparatus. (FIG. 8 shows/suggests an example of this, showing how the/a QR code can be provided in/on a booklet, as an example. Thus this is an example of wherein a booklet comprises the/a QR code(s). Other possibilities are mentioned elsewhere in the present application. For example, the/a QR code could be on a wall (or any surface) nearby to the storage apparatus, for example). Looking at the example of FIG. 1, there is shown an example QR code on the apparatus. The user scans this QR code. In the example, this is used to initiate an interface on the smartphone that can be used to get the unlocking code. (Thus this is an example of linking the user to the unlocking code via the electronic device of the user, (which is a smartphone, in the example of FIG. 1). (Payment, for example, may be required, to get the unlocking code. However, it has been stated that an item(s)) can be given away free. Thus a user could get the/an unlocking code(s) free, in such a situation.

It should also be stated, a QR code could be provided for each storage area. Of course, it has been stated how payment, for example, may be required, to get the unlocking code. However, it has been stated that an item(s)) can be given away free. Whilst it may (or may not) be that data/information is required from the user in order to get the/an unlocking code(s) free, at its most basic (or at least in an extremely basic possible scenario), scanning the QR of a storage area, (eg if there is a QR code for each storage area), could link the smartphone to a URL that shows (and thus provides) the unlocking code to the user. In the example in FIG. 1, an interface may appear on the smartphone that allows the user to choose which storage area(s) the user wants to unlock. However, whilst more ‘steps’ may be required, in such a situation, for the user to get the unlocking code(s), it is still, of course, within a scope of ‘linking’ the user to the unlocking code, via the electronic device of the user.

(In any embodiment where there is more than one storage area, it is possible embodiments may be provided where the user can only choose one storage area at a time, to unlock. However, it is also possible the user may be able to choose more than one (or even all) storage areas, to unlock).

But QR code is just one form of short-range communication/interaction technology. Another option/possibility is NFC (Near Field Communication), for example. Bluetooth is another option/possibility, for example. Any one or more may be provided. (Thus, in a possible embodiment that provides/utilizes NFC, for example, rather than there being a QR code (or both being provided), there could be an NFC tag, for example. (Broadly speaking, embodiments could be provided wherein, rather than there being a QR code (or both being provided), there could be an NFC chip, etc). As it has been said there could be NFC feature(s), so there could be Bluetooth feature(s), (eg antenna(s), etc. Broadly speaking, there could be chip(s) to facilitate any of these function(s). Thus there could be a chip(s) to facilitate Bluetooth, for example. (As has been made clear, the/a storage apparatus itself does not have to comprise such features-for example, they could be provided nearby (to the storage apparatus), which has been explained/made clear. (It will be apparent, it should be stated, that Bluetooth can have a fairly significant range. Nevertheless, it is considered a ‘proximity’ technology). Thus the example of QR code, (shown in many of the Figures), is provided simply by way of example only. Thus interaction with the/a smartphone (or any relevant electronic device) can be achieved in many ways. (It will be known that NFC can facilitate data transfer. And it has been stated that there are other possibilities for how to achieve this). One benefit of NFC is there it does not need a power source of its own. Thus even if it comprises electronics, (and is seen as an electronic solution/technology), it does not need a power source of its own. Instead, it can (temporarily) use the power from the electronic device (eg smartphone). Thus this has the benefit, (compared to Bluetooth, of course), eg of still allowing for the storage apparatus to not require electric power, with regard to various embodiments. (Note, QR code could be said to be an example of wherein short-range communication/interaction does not require its own power source, (to interact with the electronic device (of the user). Similarly, as has been stated, NFC is another technology that does not need a power source ‘of its own’-it has bene explained how, instead, it can (temporarily) use the power from the electronic device (eg smartphone). Thus it also can could be said to be an example of wherein short-range communication/interaction does not require its own power source, (to interact with the electronic device (of the user)). However, it should be stated, facilitating the user getting the unlocking code for the storage area via the electronic device of the user can be done without (and is therefore not limited to) short-range communication/interaction technology. For example, the method may comprise identifying data being provided to the user, to facilitate the user getting access to the unlocking code via the electronic device; and the identifying data being inputted into the electronic device of the user by the user. (Various examples of ‘identifiers’, (an ‘identifier’ being within the scope of the term identifying data′) will be disclosed). An example of this is denoted in FIG. 8, where it can be seen denoted on the example storage apparatus “or text 555-55”. Thus, in this example, the text number, (ie ‘555-55’, in this example), is ‘identifying data’. The user can then input that into their smartphone, (thus texting that number), and that can then be used, (eg rather than a QR code), to facilitate the user getting the unlocking code. (All these different methods could be said to be methods of linking the electronic device (eg smartphone) to the/an unlocking code(s)). (All these different methods could be said to be methods of linking the user to the/an unlocking code(s), via the electronic device (eg smartphone)).

(In the phone/text example just given, it should be stated, a number to phone/text may not itself be identifying data in some cases. For example, a number could be given for a user to text. When they text the number, they may then be asked to text, (or may have already been given instructions to text that number), identifying data. For example, a storage unit may be called UNIT56A. When they text ‘UNIT56A’ to that number, this may then be what ultimately facilitate them getting the/an unlocking code(s). (As stated, in a most basic example, they could get the unlocking code with no more steps needed. However, at its most basic (or at least in an extremely basic possible scenario), the unlocking code could then be provided immediately to the user. But in most cases, it will direct the user to an interface, (which could be done in any way in this example, eg via a URL/URL hyperlink, or any way), where more step(s) are required. However, whilst more ‘steps’ may be required, in such a situation, for the user to get the unlocking code(s), it is still, of course, within a scope of ‘linking’ the user to the unlocking code, via the electronic device of the user).

Identifying data can be provided in various form(s). A code may be provided to the user. (Eg an alphanumeric code; a number may be provided to text on the electronic device (eg smartphone), (an example of this has already been mentioned, relating to FIG. 8); a number may be provided to text, (an example of this has already been mentioned, relating to FIG. 8);a URL may be provided, for the user to input on their electronic device. (These may all be called ‘identifiers’). The identifying data may be provided on the storage apparatus. However, it should be stated, it may not be provided on the storage apparatus. For example, it could be provided anywhere. It could be provided in proximity to the storage apparatus, but not on the storage apparatus. For example, it could be provided on a nearby wall/surface. It could even be provided on a nearby desk/table, (eg on a sticker, or a placard). And it could be provided a long way away from the storage apparatus. For example, if the method is used in a (large) hotel, the storage apparatus could be on the ground floor, and identifying data could be provided eg in rooms of the hotel. For example, a person staying at the hotel, eg on floor of the hotel, could input the identifying data (that they see in their room) into an electronic device of theirs. In embodiments where the interface informs them what is in the or any storage area(s), they could even possibly get the unlocking code(s) whilst in their hotel room, for example, (in this example), and then travel down, (in this example, 30 floors), to unlock the storage area(s) and get an item from a storage area(s), (eg a snack, (eg a chocolate bar because they were hungry)).

(Note: If so desired, ‘data’ could be referred to as ‘linking’ data if it (ultimately, whether extra steps are required or not), links the user to the unlocking code). Thus disclosure relating to ‘identifying data’, where the identifying data links the user to the unlocking code, (via the electronic device of the user) can be referred to as/considered to be disclosure relating to ‘linking data’).

Preferably, the storage apparatus is in no way electrically powered. It will be apparent that a non-electronic lock needs no electric power, (for locking). However, preferably it is further the case that the storage apparatus has no features at all that require electric power, being in no way electrically powered. This can make the storage apparatus as simple and inexpensive as possible.

Preferably, the method comprises: the item being locked in the storage area prior to the user having any access to the item, the item not being a belonging of the user before being locked in the storage area. Clear examples of this that have already been mentioned would be snacks, a key to get access to accommodation that has been rented, etc. All the examples given of paying for the item, (to get the unlocking code), are examples within a scope of this. However, it should be stated, it is possible that the method comprises: the item being a belonging of the user before it is locked in the storage area; the user putting the item in the storage area before it is locked in the storage area; the user locking the item in the storage area; and after the user has locked the item in the storage area, the user using the unlocking code to unlock the storage area to get access to the item. This may particularly useful for situations such as where the user is at a venue. This could be a holiday location, for example. It could be a theme-park, for example. In such a situation, there may initially be no items in the storage area. It may simply be empty. The user could then use the method, to get an unlocking code for a storage area. Thus they now have a storage area for storing any item(s) of theirs. The storage area may initially already be locked. In this case, the user can use the unlocking code to unlock the lock, out their item(s) in the storage area, and then re-lock the storage area. Now they can go about their trip/day, (eg at a theme=park), and when they are ready, (eg when they finish their trip/day/stay), they can use the unlocking code to unlock the storage area, and get their item(s) back. They may then re-lock the storage area again, or not. (It should also be stated, it is feasible the storage area is not initially locked. In this case, much the same can occur as stated, other than that the user does not initially have to unlock the storage area. (It is also, in such a situation, even feasible/possible, (depending on the nature of how the process of getting the unlocking code works and thus dependent on nature of the embodiment), that the user could put their item(s) in the storage area before even having got the unlocking code). Thus a storage area may be a locker, for example. (However, this possibility for the method, (when the item is a belonging of the user, (before it is locked in the storage area)), is not limited to the storage area(s) being a locker(s). For example, (taken simply by way of example), the storage area could even be very small, (eg a box or the like). Thus various options and/or embodiments are possible.

(Note: Some locks may function such that when the storage area gets closed, the storage area is locked simply by being closed, (not requiring further action). Some locks may function whereby further action(s) is required (by the user), to initiate the lock, (ie to actually ‘lock’ the storage area). For example, the user may have to close the storage area, and then move (eg twist/rotate) a particular element, for example, to exert (initiate) the lock. Thus various options and/or embodiments are possible, which will be apparent).

Preferably the electronic device is a portable electronic device. (It will be apparent that a smartphone is a portable electronic device). This would include within its scope not just smartphones, but laptops, tablets, etc. (A desktop computer, for example, is not considered to be within the scope of being a ‘portable electronic device’, because it is not designed for portability, (in terms of user use). (je It is not designed to be portable for the user). Thus, despite the fact it can be ‘picked up’ and ‘moved’, it is not considered to be within the scope of being a ‘portable electronic device’. (The term ‘designed for portability’ may be used, to make this particularly clear, or a phrase such as ‘designed for portable use by the user’, (or the like)). For example, smartphones, laptops, tablets, etc are all examples of portable electronic devices, designed for portability, (and are all examples of electronic devices that are designed for portable use by the user))). Preferably the electronic device is a smartphone. This has many benefits, which will be apparent, in light of the disclosure in the present application. However, it should be stated, in various embodiments and/or situations, even a desktop computer could be usable. For example, an example was disclosed earlier in the present application relating to use in a hotel. The user, (stated as being on floor 30 of the hotel in the example given), could carry out the required steps on a desktop computer, for example. The user could get the unlocking code by email, (which the user could view on the desktop computer, (or any other electronic device, (eg smartphone)). (The term ‘computer device’ could be used, and it should be stated, a desktop computer, a laptop, a tablet, smartwatch, and a smartphone all fall within the scope of being a ‘computer device’). It should also be stated, an App could be provided. An App may not function on a desktop computer. An App may not function on a laptop computer. An App may only function via smartphones. If the method requires installing (and using) of an App, it could therefore limit what computer devices could be usable. (And even if this is not the case, there may be benefits to using the App, which may thus incentivize use of smartphones).

It is possible the unlocking code may be provided to the user via text message to the smartphone. ((This may be even more likely if the user has used identifying data that is a number to text).

The method may comprise: a contact number being provided to the user; the user contacting the contact number via the smartphone; and, resultant of the user contacting the contact number via the smartphone, the unlocking code being provided to the user via the smartphone. The contact number could be a text number. The contact number could be a phone number.

Preferably, the storage apparatus comprises more than one storage area (within which an item(s) is locked via a lock), the method further comprising: with the electronic device, the user selecting at least one of the storage areas to unlock; and an unlocking code being provided to the user, via the electronic device of the user, for each storage area selected by the user for unlocking. (Thus disclosure is provided of wherein there is a separate unlocking code provided for each storage area selected by the user for unlocking). Various examples are shown in the Figures of wherein there is more than one storage area. For example, FIG. 1 is a good example of this. In FIG. 1, there are 12 storage areas, (within which an item(s) may be locked). And it should be stated, even if it is only allowed for the user to choose just one storage area, that is still within a scope of the user ‘selecting at least one of the storage areas to unlock’. (And getting the unlocking code for that one storage area would, of course, be within the scope of ‘an unlocking code being provided to the user for each storage area selected by the user (for unlocking)’. However, it may well be that the user is able to select more than one storage area at once, (rather than having to repeat the whole process, selecting one storage area at a time). For example, if each of the example twelve storage areas stores an item that is for sale, the user may be able, for example, to buy the items stored in the storage areas numbered ‘3’, ‘6’, and ‘12’, for example, and may be able to pay for them all at once, then being provided with the unlocking codes for each of those storage areas, thus allowing them to get their items they bought. Thus various options and/or embodiments are possible. (It should be stated, any time a user ‘selects’ a storage area for unlocking, that is within a scope of the broad term ‘choosing to unlock a storage area(s)’, because by ‘selecting’ a storage area for unlocking, the user has, of course, chosen, (broadly speaking), to unlock a storage area(s). (And, of course, it is also within the scope of ‘choosing to unlock a storage area(s)’ if the user selects more than one storage area for unlocking. Thus these are all within the scope of ‘choosing to unlock a storage area’, (and even if the user selects more than one storage area for unlocking, that is still within the scope of ‘choosing to unlock a storage area’-it just so happens that the user has chosen to unlock more than one storage area).

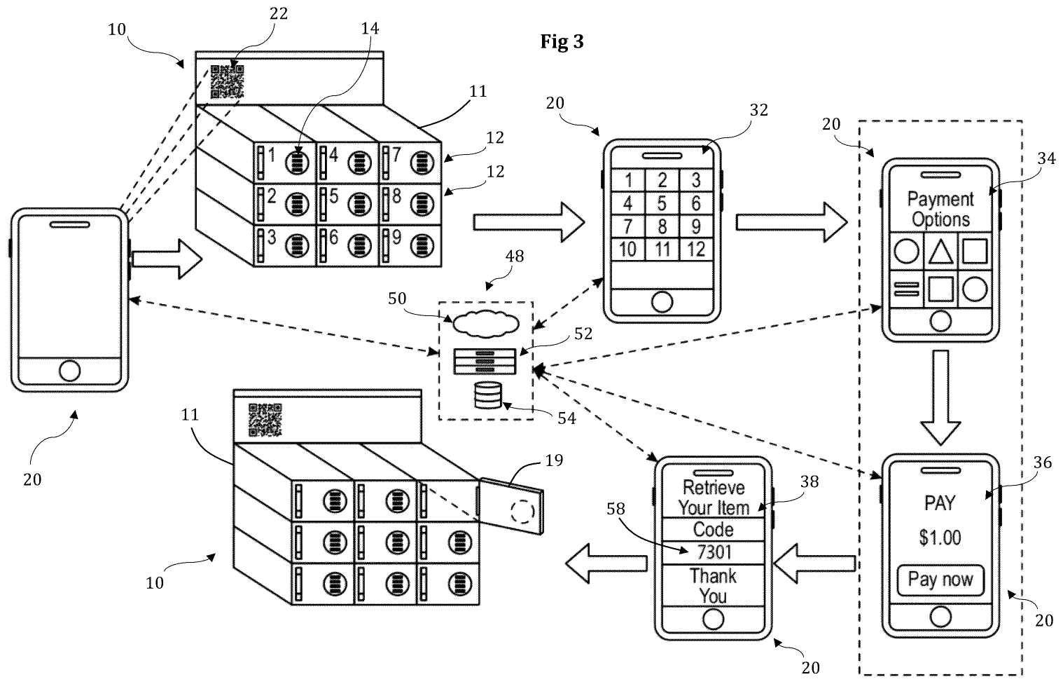

Preferably, more than one of the more than one storage area is provided by way of a storage unit, the storage unit thus comprising more than one of the storage areas. Various examples are shown of this in the drawings. For example, FIG. 1 shows an example storage unit. In the example, the storage unit comprises twelve storage areas. Another example is shown in FIG. 3, for example, of a storage unit that comprises nine storage areas. To explain, looking at FIG. 1, what is shown could be carried out where, instead of there being a storage unit that comprises the twelve storage areas, the storage areas could each, for example, be separate from each other. (This could be considered to be (and would be) twelve storage units, each having just one storage area). However, it will be apparent that what is shown in FIG. 1, (ie where there is a storage unit that comprises the example twelve storage areas), is far more elegant, for several (or many) reasons. For example, there can be huge transportation benefits (ie just ‘moving about’) for what is shown in FIG. 1, (rather than there being twelve separate storage areas). Another benefit is that the storage areas, (when provided as a unit such as that seen in FIG. 1, for example), are already arranged-they don't need to be organized/arranged. (And they will not ‘fall out of place’). Thus there are various benefits. But in either case, (ie whether there is a storage unit such as in FIG. 1, or whether the twelve storage areas were provided separately), both would be examples of wherein the storage apparatus comprises twelve storage areas. Thus the term ‘storage apparatus’ is a broad term and allows for whether there is just one storage unit, (as in the example of FIG. 1), or even whether the storage areas were all provided separately. Thus the (or any) storage apparatus may comprise a plurality of storage units. (Thus there may be multiple storage units. (Thus disclosure is provided that there may be more than one storage unit that each comprise at least one storage area. (Disclosure is provided that there may be more than one storage unit that each comprise a storage area(s)))). To make this even clearer, (and the broad use of the term ‘storage apparatus’), looking at the example of FIG. 1, let us imagine that there are another two storage units that each also comprise twelve storage areas, for example. That would give us a total of thirty-six storage areas. The storage areas for one of the other storage units could be numbered ‘13-24’ and the storage areas for the/a third storage unit could be numbered ‘25-36’. (And the user could thus be able to choose any of the thirty-six storage areas, (to unlock)). Such an example would be an example of wherein the storage apparatus comprises thirty-six storage areas. And to give another example, if looking at the example of FIG. 1, there was just one storage area ‘separate’ from the example storage unit shown, that would be an example of wherein the storage apparatus comprises thirteen storage areas. Thus various options and/or embodiments, (and/or ‘permutations’), are possible. Preferably the storage apparatus comprises at least one storage unit that comprises a plurality of storage areas. However, in a most basic example, a storage apparatus could have just one storage area.

(Looking at FIG. 2 or FIG. 15, although these Figures are simply showing one of the storage areas of a storage unit that comprises a plurality of storage areas, if it was imagined this was the only storage area, (ie there was only one storage area, being an example of wherein the/a storage apparatus only has one storage area), what is shown in those figures, (if that was the case), could be said to be a storage unit, (comprising at least one storage area). (More specifically,, (if that was the case), it would be a storage unit that only has one storage area). It is feasible the storage apparatus could comprise a storage unit that has only one storage area, and there could be other storage units, (comprising at least one storage area, (eg a plurality of storage areas)). Thus various options and/or embodiments are possible). (In embodiments wherein there are a plurality of storage areas, most preferably, (as in FIG. 1, for example), all the storage areas are provided by way of only one storage unit). Disclosure has been provided of wherein the storage apparatus comprises a plurality of storage units that each comprise a storage area(s). Disclosure has been provided of wherein the storage apparatus comprises a plurality of storage units that each comprise a plurality of storage areas. (They are not required to comprise the same amount of storage areas, as in the example where three storage units each comprise the same amount of storage areas, (ie twelve storage areas, in the example)).

(Note: The example mentioned above of there being three storage units that each comprise twelve storage areas, (provided by way of example only-and of course there could be storage units that comprise a different amount of storage areas, (and there could be storage units that comprise a different amount of storage areas from each other)), mentioned that the storage areas could be numbered ‘1-36’. However, this is just an example of storage identifiers. A storage identifier is not limited to being a number. For example, number(s) and/or letter(s) and/or symbol(s) may be used. In one example, for example, (and taking from the example mentioned), the twelve storage areas of one of the storage units could have the identifiers 1a-12a; the twelve storage areas of one of the other storage units could have the identifiers 1b-12b; and the twelve storage areas of the other storage unit could have the identifiers 1c-12c. Again, all of these are simply ‘identifiers’. These can be useful and may be important, to facilitate the user making a selection of which storage area(s) they want to select/choose. Thus a storage area ‘identifier’ may be provided in many different ways.

It should be stated, there may be provided a storage apparatus identifier. (The QR code in FIG. 1 could be said to be a storage apparatus identifier. It facilitates linking the user to the unlocking code(s). This is best shown/denoted in FIG. 3. It can be seen how scanning the QR code shows the user the example storage areas on their smartphone screen. (The numbers ‘1-9’ are storage area ‘identifiers’). The use, in the example, can then choose a storage area(s). In the example, they make payment for unlocking the storage area(s). (It could be said they make payment for getting the unlocking code). In the example, they then get their unlocking code. (In the example, they only got one unlocking code for unlocking one storage area. But in other examples/possibilities, they may be able to get more than one unlocking code, to unlock more than one storage area. (It may be clearly displayed which storage area the unlocking code is for. For example, on the screen shown in FIG. 3, rather than just showing the unlocking code, it my also show the storage area that the code is for unlocking. (And if there are multiple unlocking codes because multiple storage areas have bene chosen, it may clearly show this, eg ‘box 1: unlocking code: 1234’ and also stating, eg ‘box 7: unlocking code: 7693’. Thus various options and/or embodiments are possible.

It has been stated that the QR code in FIG. 1 (and in FIG. 3, for example), is a storage apparatus identifier. It could also be stated that the QR code is a ‘storage unit’ identifier, (because the storage apparatus here is just one storage unit). (In such a case, it is preferred that the broadest term ‘storage apparatus’ is used, and thus that it is said that it is a ‘storage apparatus’ identifier). However, it should be stated, it is feasible an embodiment could be provided, (eg as already mentioned), where there is more than one storage unit, (therefore being an example of wherein the storage apparatus comprises a plurality of storage units). There could be a storage apparatus identifier (eg QR code), (eg one the storage apparatus (ie on a storage unit(s)), or in proximity to the storage apparatus, for example), and when the user interacts with the identifier, (which could be a QR code, but could use NFC, (and thus could be an NFC tag, for example), (and it should be stated, Bluetooth could be used to get much the same result), could bring up an interface on the electronic device (eg smartphone), (either immediately, or with some action(s) required by the user), that could then give the user the option to select which storage unit they want to choose a storage area(s) from. (eg ‘Unit l’; ‘Unit 2’; and ‘Unit 3’). The storage units themselves could have ‘identifiers’, (eg one unit could say ‘Unit 1’ on it; one could say ‘Unit 2’ on it, and the other could say ‘Unit 3’ on it. (It should also be stated, a storage unit identifier of that sort may not need to be actually ‘on’ the storage unit; for example, in the example just given, the identifier(s) could be above each storage unit, for example, eg on a wall. Alternatively, such an identifier could be on a placard, for example, positioned/placed on the storage unit, (but not actually being part of the storage unit). Thus various options and/or embodiments are possible, and there is various disclosure in the present application broadly to do with ‘identifiers’ not needing to be ‘on’ the thing they identify, and it is thought this will be apparent, in light of the nature of the disclosure of the present application). The user can then select the storage unit that want to unlock a storage area(s) of. This is simply mentioned as it is a possible way the process could work. Of course, much the same result could be achieved if each storage unit, (in this example of there being three storage units), has its own storage unit identifier. For example, if each storage unit had its own QR code, and scanning the QR code took the user into a process with their electronic device (eg smartphone) specific to that storage unit, the step of the user then selecting the storage unit on their phone (out of the multiple storage units) could be skipped. Thus various options and/or embodiments are possible.

Bluetooth has been mentioned. It is known how Bluetooth functionality works, (eg when used with smartphones, for example), since it is used by millions of people around the world every year. With respect, for example, to method(s)/system(s)/apparatus(es) disclosed in the present application, a user could check on their electronic device, (eg smartphone), for possible ‘devices’ that can be connected to/paired to. If Bluetooth is provided for method(s)/system(s)/apparatus(es) disclosed in the present application this case, a storage apparatus and/or storage unit(s) and/or storage area(s) may be available to connect/pair to, via Bluetooth. (It is also possible, (rather than having to search for devices available, that the/an electronic device of the user may be ‘notified’ of Bluetooth availability for this, (without them having to search/check). Once connected/paired, the user may be able to/may be taken to any interface shown and/or disclosed in the present application, (eg much like or the same as use of a QR code, for example). Thus various options and/or embodiments are possible. However, if the user's device interacts with the storage apparatus in any way via Bluetooth, Bluetooth requires electric power on the storage apparatus side of things. Thus this may be less ideal, not allowing for interaction with the electronic device of the user without electric power, (on the storage apparatus side of things. (Disclosure is provided that the storage apparatus may, for example, comprise an antenna(s) for Bluetooth use. As has been stated, Bluetooth may not be ideal due to needing electric power. (Nevertheless, disclosure is provided that the storage apparatus may comprise relevant Bluetooth elements/electronics, to facilitate Bluetooth functionality). Many electronic devices (such as smartphones) comprise such feature(s), (ie antenna(s) for Bluetooth, etc), since Bluetooth functionality is so important for many functions).

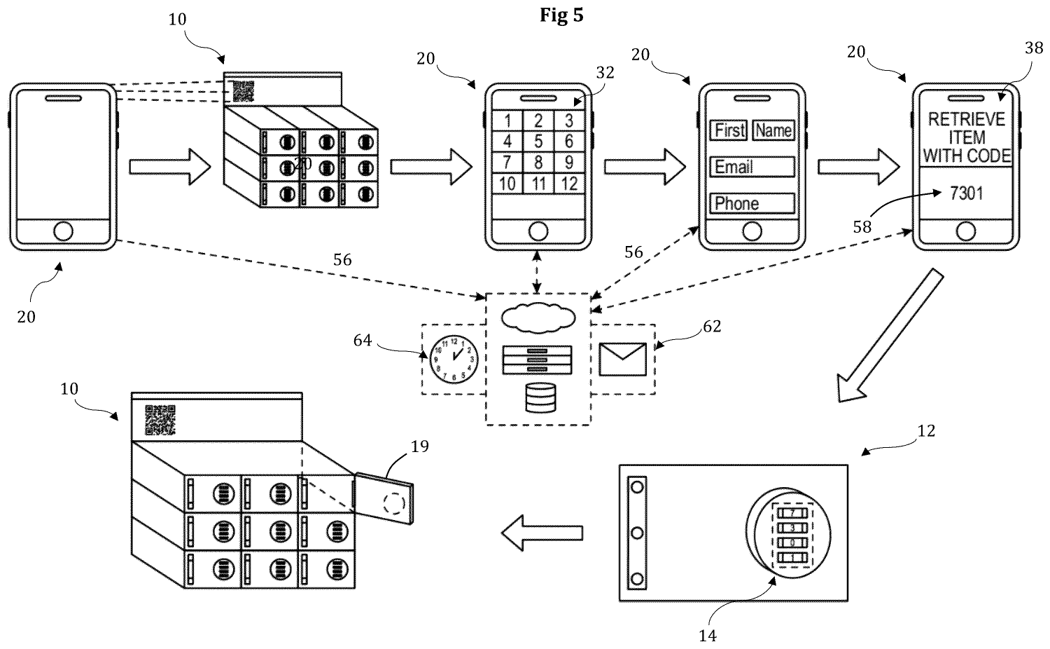

Examples have been shown and disclosed of an openable and closable opening that can be opened by a user. (Eg see FIG. 3 and FIG. 5, which show one of the example openable and closable openings (of an example storage area) having been opened. It has been shown how this can be locked, and how the user can unlock the storage area, using the/an unlocking code. Preferably, there is provided an extra openable and closable opening for opening a/the storage area(s), the extra opening not being openable by the user with the unlocking code. Preferably, the storage apparatus comprises more than one storage area within which an item is locked via a lock, and the extra opening opens a plurality or all of the storage areas. (This could be described as a ‘master opening’, since it opens more than one of the storage areas.

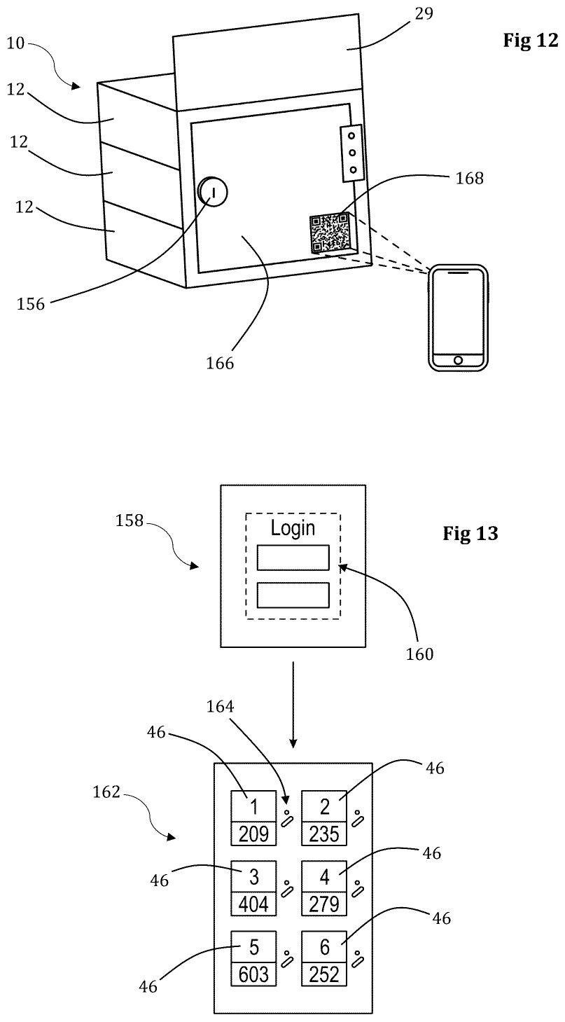

(As stated, the/a master opening may open all the storage areas)). Preferably the extra opening(s) are lockable. (In the example of FIG. 12, the extra opening is lockable. In the example of FIG. 12, the extra openable is lockable (and unlockable) with a key. Thus it does not need an ‘unlocking code’ in the example. Thus it could be said to be locked in a more standard way. However, an extra opening(s) may be lockable in any way. Thus various options and/or embodiments are possible. (The example shown in FIG. 12 would not be unlockable (and thus not openable) by any user because the user would not have the key to unlock the example)).

The storage apparatus may be located in a vehicle. This may be particularly useful/relevant if the vehicle is a passenger fare vehicle. Thus the vehicle may be a passenger fare vehicle. A train would be within this scope. A taxi would be within this scope. Thus the user getting the item may be a passenger of a vehicle. This could be particularly useful for a taxi. For example, a taxi driver could potentially generated extra income from the method. As an example, (in an example where there are a plurality of storage areas, for example, (although, of course, the storage apparatus could be provided in a vehicle with there only being one storage area), one or more of the storage areas could store an edible item(s). In an embodiment where the item is paid for, the user could pay to get the unlocking code(s) for a storage area(s), to get the item(s) to cat/drink. (Note: The term edible is here stated clearly as including within its scope not just food, but also drink/beverages. (It would also include items such as chewing gum, bubble gum, for example).

It has been mentioned that there may be an extra opening(s). With respect to use of the storage apparatus in a vehicle, an extra opening(s) may face towards a front of the vehicle. (Note: For the sake of the present application, with respect to ‘front’ and ‘back’ of a vehicle, if an opening faces more than forty-five degrees, (even by the smallest/tiniest amount more than forty-five degrees) towards the front, it is considered to be within the scope of ‘facing towards a front’ of the vehicle. Similarly, if an opening faces more than forty-five degrees, (even by the smallest/tiniest amount more than forty-five degrees) towards the back of the vehicle, it is considered to be within the scope of ‘facing towards a back’ of the vehicle). This, (ic facing towards a front of the vehicle), could be beneficial. For example, it may make it easier for the driver to re-stock any storage area(s). If there is an extra opening that opens all the storage areas, this may be particularly useful. It is disclosed that if there is an extra opening that opens all the storage areas of a storage unit, this may be particularly useful. (There may be more than one storage unit). One or more (all all) of any opening(s) for the user opening any storage area(s) may face towards a back of the vehicle. However, depending especially on shape/size/position of the storage apparatus, various possibilities are possible. For example, an opening(s) could face more sideways (than front or back), in some embodiments. (As is stated elsewhere in the present application, an extra opening(s) may be lockable).

With regard to use in a vehicle, the method may comprise a storage unit seating apparatus). This could involve hanging said portion or whole of the storage apparatus on a seating apparatus(es), (eg a seating apparatus(es) of a car/taxi for example, but this could also be done for a seating apparatus(es) of a train, or any vehicle, eg a plane). (Note: ‘Hanging’ does not require that the portion or whole of the storage apparatus is tightly secured to the seating apparatus(es). For example, a hooking arrangement (comprising at least one hooking element) could be used to hook over a part(s) of a seating apparatus(es). Whilst it may be beneficial, (for securing tightly in place) for the hooking arrangement to be tight to the seating apparatus(es), the portion or whole of the storage apparatus could be held to the seating apparatus(es) even if the hooking arrangement is not tight. Thus this has been made clear). This could involve attaching said portion or whole of the storage apparatus to a seating apparatus(es) of a vehicle. One example (that is within a scope of being held to a seating apparatus(es)) would even be to use cord(s) or string(s), for example. This could be used to tie the portion or whole of the storage apparatus to the seating apparatus(es). (The storage apparatus may have relevant feature(s), such as an aperture(s)) through which the cord(s)/string(s) can go, to help attach the portion or whole of the storage apparatus to the seating apparatus(es)). (The term ‘cordage’ may be used as a broad term to include within its scope cord, string, etc or the like. The term ‘cordage’ also allows for there to be just one piece of cordage, or multiple, (eg multiple cords). It should also be stated, it is feasible even wire(s) could be used in much the same way. Cordage, wiring, etc may broadly all be considered to be within the term ‘line(s)’. (ie They are all examples of use of ‘line(s)’, to attach a portion or a whole of the storage apparatus to the seating apparatus(es)). (Zip tic(s) could be used, (and would also be within a scope of the term ‘cordage’ and would be within a scope of the term ‘line(s)’). (The term ‘cable(s)’ may also be relevant). Thus if a storage unit is attached to a seating apparatus(es) via use of string(s) and/or cord(s), etc, that is within a scope of wherein a storage unit is attached to a seating apparatus(es) via use of lines. (And this would be within a scope of wherein a storage unit is held to a seating apparatus(es)). (The term ‘lines’, despite sounding plural, is here stated as including within its scope whether there is just one ‘line’ or more than one ‘line’ used. It should also be stated, if so desired, the term ‘at least one line’ may be used, (eg attaching ‘via using at least one line)). The reason the term ‘seating apparatus(es)’, (ie possibly plural), is used is because it is feasible the portion or the whole of the storage apparatus may be held to more than one seating apparatus. For example, a storage unit could be held in some way, (eg hooked on and/or attached to, etc), to two adjacent seating apparatuses. Thus it has been made clear that this is possible. (And, of course, this is within a scope of wherein a portion or a whole of the storage apparatus is held to the/a seating apparatus(es) (of a vehicle)). It should also be stated, being held to a seating apparatus(es) is not limited to being with reference to vehicle use. For example, this could be done at an event, (eg a play/show/musical, or even a cinema, etc, or any place where there are seating apparatus(es). Of course, it could be particularly useful/beneficial, (aside from use in vehicles), in locations/places where there are a lot of seating apparatuses, and where people (possible users) are effectively forced to sit, (eg the examples given of a play/show/musical or the like being examples of this). It should also be stated, with reference to being held to a seating apparatus(es), it is feasible, (in embodiments where the storage apparatus comprises more than one storage unit), that a plurality of storage units could be held to seating apparatuses. For example, a storage unit could be held to one seating apparatus. Another storage unit could be held to another seating apparatus, (eg a seating apparatus that is adjacent/next to the other seating apparatus). (This would, of course, still be within a scope of wherein a portion or a whole of the storage apparatus is held to a seating apparatus(es)). This could be the case in a car/taxi, for example, where a storage unit may be held to the driver's side seating apparatus, and another storage unit may be held to the/a seating apparatus next to/adjacent to the driver's seating apparatus, (often referred to as the/a ‘front passenger's seat’ and that we may refer to as a ‘front passenger's seating apparatus’). It is even possible that more than one storage unit may be held to a seating apparatus. (This could be done with ‘line(s)’, for example, or any other way).

(Note: a ‘line(s)’ is an example of an ‘elongate element’. This terminology may be used, if so desired. Furthermore, since various shapes, sizes and types of features may be used, (to help attach a storage unit(s) to a seating apparatus(es), broad terms such an ‘connecting element(s)’ may be used. Broad terms such an ‘attaching element(s)’ may be used. To give an example of another possibility, clamp (ing) feature(s) may be used. These could clamp to the/a storage unit(s) and/or seating apparatus(es). A clamping feature would be an example of a connecting element. (A clamping feature would be an example of an attaching element).

Broad terms such as clamping arrangement may be used, (which could comprise any amount of clamp (ing) features-ie one or more). Broad terms such as holding arrangement may be used). A zip tie(s), it should be stated, would be within a scope of being a ‘connecting element’. (A zip tie(s), it should be stated, would be within a scope of being a ‘connecting element’). The same goes for a strap(s). It should be stated, a strap(s) could be used, to go around a seating apparatus(es). (Thus a strap(s) could be used, to go around a seating apparatus(es), eg in front of the user, (ie the seating apparatus ahead)). Thus strap(s) could be used, to hold a storage area(s) to a seating apparatus(es). Thus strap(s) could be used, to hold a storage unit to a seating apparatus(es). Various options and/or embodiments are possible).

(Various disclosure has been provided of wherein ‘a portion or a whole of the/a storage apparatus’, (said portion or whole comprising at least one storage area) is held to a seating apparatus(es).

In terms of how a portion or a whole of the storage apparatus is held to a seating apparatus(es), it is even possible this could be done in a more significant way. For example, it could be screwed to the seating apparatus(es), (eg drilled in, for example). It could even be (industrially) glued. (Any combination of any method(s)/way(s) could be used).

It will be apparent, (eg in a train, taxi/car, etc or the like), that having a storage area(s) held to a seating apparatus can be very useful, in terms of positioning. For example, on a train, (and plane, and many forms of transport), there tends to often be a seat in front of another seat. In this way, a storage area(s) can be held to the seating apparatus in front of another seating apparatus where a potential user sits. Therefore item(s), for example, can be ‘on display’ right in front of a person. They may, for example, then be able to buy an item(s), get an unlocking code(s), and thus unlock a storage area(s) to get the item(s). It can be imagined that a person sitting forwards can thus have a storage area(s) held to a seating apparatus(es) in front of them. In this example, the storage area(s) can thus be ‘backwards facing’).

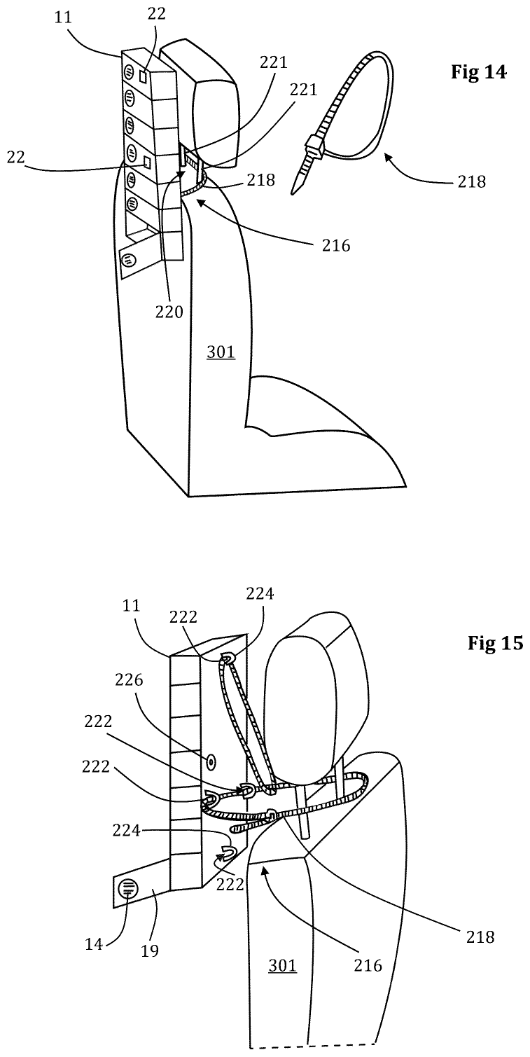

With reference to holding to a seating apparatus(es), it will be apparent that having a storage area(s) at ‘ground level’ (eg within (and with respect to ground of) a vehicle), may not be ideal at all. It may, for example, make it hard to see a storage area(s) and/or any item(s) inside. It also would not be ideal positioning for unlocking a storage area, (and taking what's inside). Thus preferably the portion or the whole of the storage area that is held to the seating apparatus is held above ground level of the vehicle. However, it should be stated, it is feasible a storage unit(s) could be shaped/structured so that a portion of it engages with ground of the vehicle. (Even in such case, a storage area(s) of the storage unit could be higher than the ground level). Thus this is mentioned as being possible. (Even in such case, being held to a seating apparatus(es) may be beneficial). However, as stated, a storage unit(s), (which is a portion or a whole of the storage apparatus), may be held to a seating apparatus(es), and may be held above ground level of the vehicle. Being positioned in this way can create better positioning, eg for users to see item(s) in storage area(s), and, for example, to make it relatively easy to unlock a storage area(s) (and get an item(s)), without this being too uncomfortable or challenging. (Looking at the example in FIGS. 14 and 15, for example, this is within a scope of wherein a portion or a whole of the storage apparatus is ‘suspended’. (Both Figs are within a scope of wherein a storage unit is ‘suspended’). It should be stated, it is even possible that a seating apparatus(es) may be designed to facilitate attachment. For example, a seating apparatus(es) could comprise ‘fixture(s)’, for example. These could be used to hold a portion or a whole of the storage apparatus to the seating apparatus(es). (Thus it is here stated that it is possible a seating apparatus(es) could comprise ‘fixture(s)’, to hold a storage unit(s), (comprising at least one storage area). (It is even feasible that the portion or whole of the storage apparatus may be correspondingly designed, to facilitate this. Thus it may be designed/shaped to ‘fit’ the fixture(s). (Thus it is here stated that it is possible a storage unit(s), (comprising at least one storage area), may be correspondingly designed, to facilitate this)).

Dependent on design of the seating apparatus that is held to, ‘head’ of the seating apparatus may be particularly useful, (for holding to).

(Note: A portion or a whole of the/a storage apparatus may be held to any area(s) of a vehicle (eg car, (eg taxi)), not limited to being held to a seating apparatus(es). For example, some taxis, especially, have a ‘divide’, (may be referred to as a ‘partition’, or ‘wall’ or ‘barrier’), that separates the driver area and the passenger area. In such case, it is feasible A portion or a whole of the/a storage apparatus is held to such a feature, (which maybe referred to by any of the terms just mentioned)).

It should also be stated, various examples are shown of wherein a portion or a whole of the/a storage apparatus is ‘suspended’. Particularly with reference to use with vehicles, various examples are shown of wherein a portion or a whole of the/a storage apparatus is suspended Preferably, the user is able to see the item(s) that is locked in the storage area(s). Thus, Preferably, the method comprises the user secing the item that is locked inside the storage area, the item thus being visible inside the storage area. This can be made possible in various ways. For example, a portion or a whole of the storage area may be transparent, (thus allowing a user to see into the storage area). This is one way of achieving this. Another way, for example, is for the/a storage area to comprise gap(s). (These could also simply be called ‘opening(s)’). (The broad term ‘aperture(s)’ may be used). Thus the storage area, (even when locked), may comprise aperture(s) that allow the user to see into the storage area. Thus this is another possible way of facilitating a user being able to see the item(s) that is locked inside a storage area. Thus various options and/or embodiments are possible.

It should be stated, being able to see inside a storage area is not the only possible way for a user to know what is in the storage area. For example, a physical representation of an item(s) that is in the/a storage area may be provided. This could be done ‘virtually’ (on a computer device interface), and/or could be done as a real image. For example, an example of a ‘real image’ would be if there was a real image, for example, of a particular fizzy drink. Thus, if the storage area stores this particular fizzy drink, (which is provided here simply by way of example only), and if there was a ‘sticker’ for example, stuck on the storage area, for example, (eg on the front of the storage area), then that could, of course, tell the user that that fizzy drink is in the storage area, (even if the storage area cannot be seen into). Similarly, a virtual representation of the fizzy drink could be shown on the electronic device, (eg a smartphone), (eg as a PNG file, or the like), to show that that is what is in the/a storage area. (Thus showing what item(s) is in the storage area). It should also be stated, the user can know what is in the storage area even without a physical representation of the item(s) in the storage area. For example, even just ‘stating’ what is in the storage area can tell the user what is in the storage area. For example, if a bottle of fizzy water is in the storage area, whether it is stated on the electronic device, or on the storage apparatus, (eg on the storage area), (or possibly even close to the storage apparatus-eg stating ‘fizzy water bottle available here’, (or the like)), it could be stated in text. (In the example mentioned above, where there could even be text not on the storage apparatus, but close to it, there could even also be an arrow pointing (generally) towards the storage area, to help communicate this. Of course, if every storage area, (whether there is only one storage area, or more than one), stores the same item, (eg a bottle of fizzy water, in this example), then that could be adequate communication, at least to communicate to the potential user what is in the storage area(s)).

However, mere pictorial representation may not as highly incentivize the user to want the item(s). Many people will want to actually ‘see’ the item itself, for various reasons. Firstly, it is the only way to truly trust that they will get what they expect to get-ie the only way they will truly ‘know’ what they are getting. (They may be concerned they will make a purchase, for example, and then find that the storage area is empty). And providing only ‘text’ is even more unsatisfactory in this regard, because the user does not even get a physical representation of what they will be getting. Thus it is preferred that the user can actually see the item(s) that is locked inside the storage area, the item thus being visible inside the storage area. (Note: It is technically feasible there could be a camera inside the/a storage area(s), to show what it in the storage area(s). (The user may then be able to see what is in the storage area, on an electronic device, (eg smartphone). (ie The electronic device (eg smartphone), could be in communication (eg ‘paired/connected’) to the camera, to display what the camera is able to see/shows). This would be an example of the user being able to see what is in the storage area. But more preferably, the user is able to see ‘into’ the storage area. Whilst the ‘camera’ option is feasible, it may create expense. Furthermore, it would require ‘power’, thus not just potentially making the (or any) storage apparatus more expensive, but having the possible complexities that come from electronics, (eg malfunctions, etc). Thus, preferably, the user is able to see ‘into’ the storage area, (to see the item). Of course, this can be extremely beneficial in helping the user to know if they want the item(s). (Many people will want to see an item(s) before deciding whether to buy it the item(s), for example). (As stated, this can be made possible in various ways. For example, a portion or a whole of the storage area may be transparent. (A portion or a whole of an openable and closable closure element, for example, may be transparent). (And/or a portion or a whole of an openable and closable closure element, for example, may comprise aperture(s), allowing the user to see into the storage area). Thus various options and/or embodiments are possible.

(Note: Rather than the term ‘closure element’, the term ‘closing element’ may be used). Othe terms, such as ‘shutter element’ may be used, or ‘screen/screen element’. As has been made clear in the present application, the examples of ‘closure elements’ are provided simply by way of example only. There are many ways to close an openable and closable opening. (For example, a closure element could ‘slide’ to open and close, for example. For example, a closure element could rotate upwards (or downwards) to open, rather than rotating left/right. Thus various options and/or embodiments are possible, which will be apparent in light of the nature of the disclosure of the present application. (Generally only the example closure elements 19 are numbered in the Figures. This is for clarity, so that numbering of the closure elements that are closed does not get confused with numbering for other feature(s). In FIGS. 3, and 14, for example, numbering is provided of example closure elements that are open). Disclosure is provided in the present application of wherein the/a method comprises a user choosing to unlock at least one said storage area via an electronic device of the user. (Thus disclosure has been provided of a method for providing item access, comprising: an item being locked in a storage area of a storage apparatus via a lock; a user choosing to unlock at least one said storage area via an electronic device of the use; an unlocking code, to unlock the lock, being provided to a user, via an electronic device of the user; and the storage area being unlocked by the user via using the unlocking code; wherein the lock is a non-electronic lock. (As is stated elsewhere in the present application, steps are not necessarily in chronological order, and, within reason, may be carried out (and/or may occur) in any order that is fitting/appropriate. (It should also be stated that any steps in any claim(s) for a ‘method’ may be carried out in any order (that is appropriate), and are not limited to the order they appear in the claim unless this is explicitly stated in the claim, (ie unless words that explicitly make order clear are used). Thus this has been made clear). However, it should be stated, embodiments can occur where the user does not choose to unlock at least one said storage area via an electronic device of the user. For example, in an embodiment where the user pays for accommodation, and then, incidentally, is provided with an unlocking code for a storage area (eg a box) and is given instructions (eg directions, etc for where the storage area is) in order that they can get a key out of the box, then in that case, the user has not ‘chosen to unlock at least one said storage area’ via an electronic device of the user. (It is ‘incidental’, rather than actually ‘choosing’). Furthermore, if storage apparatus is used at a theme-park, for example, to give a user a storage area (eg locker) for item(s) that already belong to them, to put the item(s) in the storage area, lock the storage area, and then unlock the storage area to get the item(s) out later, if the user buys a trip to the theme-park, it is feasible they could be provided (eg by email) with a storage area, (eg a storage area number, so they can find the storage area at the theme-park), and an unlocking code, and this could be done without the user ever even asking for a storage area, (eg locker). If this is the case, then, again, the user has not ‘chosen to unlock at least one said storage area via an electronic device of the user’. Thus various options and/or embodiments are possible. However, embodiments are shown and disclosed in the present application where the user does ‘choose to unlock a storage area via the electronic device’. For example, in FIG. 3, it can be seen how the example electronic device, (which is a smartphone, in the example), shows an interface which includes numbers ‘1-9’. These correspond to the nine example storage areas, in the example. The user can select one (or maybe more than one) of the numbers, (which appear as ‘buttons’ that can be pressed (using the touchscreen of the smartphone), in the example, although this is just one example of how such an interface may appear/look-for example, instead, below (or next to/above) each number, there could be a link (that can be pressed using the touchscreen) that says ‘get this’ or the like), and by selecting one (or maybe more than one) of the numbers, the user can move ahead in terms of getting the unlocking code(s) for the storage area(s). Thus this is action that is certainly within the scope of the user ‘choosing to unlock at least one said storage area’ via an electronic device of the user.

(It should also be stated, a user choosing an ‘item(s)’ that is locked in a storage area, in order to progress with getting an unlocking code, to unlock the storage area that stores the item(s), is considered, (for the sake of the present application), to be within a scope of the user ‘choosing to unlock at least one said storage area’ via an electronic device of the user. To explain, if the interface of the smartphone in FIG. 3, instead of showing the numbers of the nine storage areas, showed the item(s) in each storage area, it will be apparent that the user could go through much the same process, choosing that ‘item(s)’ that they want to get, and thus moving forward with the process of getting the unlocking code. (To give an example, if the user and the storage apparatus is in a taxi, and the user sees a particular fizzy drink that they want in storage area ‘five’ of the storage apparatus, and if the interface on their electronic device then shows the item, rather than the storage area number/identifier, they could choose the item (ie that fizzy drink) on the interface, and could thus move forward with the process of getting the unlocking code, to unlock the storage area with that fizzy drink in it. (And this could in fact be done, potentially, without any numbers (or any identifiers) being provided in any way for the storage areas, (both on the electronic device, but also with reference to the storage areas themselves (ie the storage hardware). (As made clear, ‘number(s)’ are just one possibility for using as ‘identifiers’ for storage areas. Another possibility is letters. Symbols are also another option. (Any combination and/or permutation is possible). Thus there are various options for what can be used as an identifier. (Thus there being an ‘identifier’ for the/a storage area(s) has been disclosed). Thus this example shows that, by choosing the item (in such an interface), the user has chosen to unlock a storage area. (Note: In the present application, (with regard to ‘item’ in a storage area), the term ‘key’ is mentioned/used. It should be stated, (because to include within its scope there being just one key, or there being more than one key. To explain, when a person gets access to accommodation, that can sometimes mean getting just one key. But it often means getting more than one key, (eg for different doors, and/or different locks on the same door, and/or even for other things, such as a window(s), for example). Thus, if it is stated, (eg in a claim), that ‘the item is a key’, (or the like), this includes within its scope there being just one key, or there being multiple keys. Thus this has been made clear. (It should also be stated, it may also be stated that the item is a ‘key or a set of keys’, (ie a term that makes clear there can be one or more than one key). This is also a way to make clear that there may be one or more than one key).

Various examples of a system for managing item distribution are shown in various of the drawings. Data transfer is shown occurring, in various of the drawings.

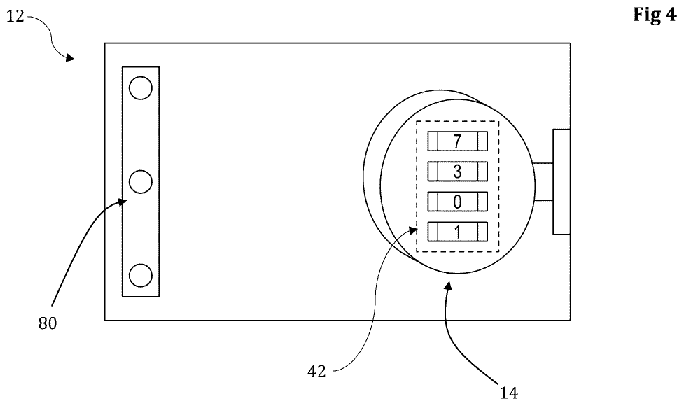

In FIG. 1, (and many other of the Figures), example storage areas 12 are shown. In FIG. 1, the storage areas are shown shut. They are locked. (FIG. 2 (and FIG. 4) shows a close-up of one of the example storage areas, showing an example lock 14 that allows for an example unlocking code 58 to be inputted/used, to unlock the lock, (and therefore open the/a storage area, as shown in FIG. 3, (which shows an example process of this happening/being done)). However, as can be seen in FIG. 3, with an unlocking code 58 having been provided to the user, the user has been able to unlock and open one of the storage areas 12.

(In FIG. 1, an example feature 17 is denoted. This is simply to represent there may be a ‘beacon’ feature. What is meant by this is there may be a feature, (such as GPS) that allows for finding/locating the/an storage apparatus/unit. This could be referred to as a ‘location element’ or ‘locating element’. It could be useful to be able to locate an apparatus(es)/unit(s). There may be administrative benefits/advantages to this. (One benefit could be security, for example). (In the example, the ‘beacon/locating’ element may be provided by way of a ‘beacon tag’. However, the example is provided simply by way of example, only. Ant technology/element(s) may be provided to facilitate this)).

In various example storage units 11 shown in the drawings, (provided by way of example only), the storage unit 11 comprises an example portion/area 29. (In other embodiments, there may or may not be such a portion). The example portion 29, in the examples, is shown at a top of the example storage units. However, it is feasible, in other embodiments, a portion of some sort, (eg like the example portion 30 shown), may be provided elsewhere about the storage unit, (eg at a side(s) of the storage unit, for example). This is a portion that is shown, in various of the embodiments, being used for display features/element. An example QR code 22 is shown in some of the embodiments. (It should be stated, embodiments may be provided without such a portion 29, of course. And it will be apparent in light of the disclosure in the present application, (which explores this), that features such as a QR code or the like could be provided in other ways, and in other positions/places, (and not limited to being provided on the storage apparatus). For example, rather than example portion 29, there could simply be a display element placed eg on the storage unit. (eg A placard, (or any printed element, for example), could be placed here. This could include a QR code(s), for example). (In this example, example portion 29 could be called a display portion).

In the examples, the example QR code can be scanned by the example smartphone. In the example, this brings up an interface on the screen of the smartphone. This is shown well in

FIG. 3, where it can be seen that the numbers of the example nine storage areas of the example storage apparatus are shown on the smartphone screen. This thus allows the user to select a storage area(s). The user is able to select storage area(s) to unlock. Disclosure is also provided of a payment system in FIG. 3. (The screen of the smartphone can be seen stating that the amount to pay is ‘$1.00’ in the example). In the example, the user is provided with payment options, (also shown on the smartphone screen in the example process shown in FIG. 3), shown by way of example only. In other embodiments, there may be only one way to pay, for example, (where payment occurs/is required).

Example(s) are shown of wherein the user can input data. For example, in FIG. 5, an example is shown of a user being able to input personal details. (Thus an example is shown of a user being able to input personal data).

Example(s) are shown of wherein communications 62, (eg emails, for example), may be sent to the user, (example of this denoted in FIG. 5, for example). (Email is just one possible mode of communication. Other possibilities include (and are not limited to) text, call). Example(s) are shown of wherein communications may be sent to the smartphone of the user. However, it is feasible communications may be sent to an electronic device(s) of the user, not limited to the electronic device being a smartphone.

Various software may be designed to achieve what is shown. Various interfaces may be provided. The example interfaces are provided by way of example only.

With particular reference to FIG. 1, there is shown a front view of an example storage apparatus 10. In the example, the storage apparatus comprises an example storage unit 11 that comprises a plurality of example storage areas 12. In the example, there is shown an example

QR code 22. This can be scanned, (which is suggested by dotted lines in FIG. 1 (and other Figures). The electronic device shown/denoted scanning the example QR code is shown as an example smartphone in FIG. 1. Result of scanning can be, for example, to bring up a webpage. By scanning the example QR code, in the example, it brings up an interface, through which the user is able to ultimately take action that results in getting an unlocking code(s) to unlock a storage area(s). Thus the user can get access to an item(s) they desire. (In the particular example shown/denoted in FIG. 1, (shown by way of example only), scanning of the QR code results in the user being taken to a webpage (on the internet). In the example, (provided by way of example only), communication is facilitated with, in the example, an example server(s) 52. In the example, (provided by way of example only), communication is facilitated with, in the example, an example database(s) 54. In the example, (provided by way of example only), communication is facilitated with, in the example, an example database 54. In the example, the database is in the cloud 50. In the example, the database is in the cloud 50. In the example, the server is in the cloud. However, these example elements are all provided/mentioned by way of example only, and any web and/or mobile/smartphone technology may be provided. (In the example, example system 48 is shown. In the example, example system 48 is a software system, in the example. However, as stated, the examples provided are provided simply by way of example only). Arrow 56 in FIG. 1 represents transfer of data. The example, (provided by way of example only), shows how transfer of data can occur.

(Note: Various examples and/or disclosure is provided of use of the cloud. It will be apparent that, whilst there are many possible benefits of use of the cloud, ‘local’ system(s), (rather than the cloud), could be usable. (For example, servers and databases used to often be ‘on the premises’ of those using them. They now tend to be on the cloud). Thus the examples are provided simply by way of example only. Furthermore, examples/disclosure of server(s), database(s), etc. However, an App (on a smartphone) could be used, not requiring a ‘server’, for example. Furthermore, NFC technology could be used, utilizing memory (eg ‘on-chip memory’/′passive memory′) to store uncocking codes (and/or any other data). Thus there are various methods of implementation, not limited to the examples (and feature(s)) often shown and/or denoted in the Figures. (It should be stated, an App may or may not use a server). Thus the examples are provided simply by way of example only, and various options and/or embodiments are possible. Thus this has been made clear.

The example door elements of the example storage areas 12 in FIG. 1 allow for opening when unlocked and can be closed again. (As stated, the broad term ‘closure element’ may be used. (The example door elements are examples of a closure element. (Thus various examples of an openable and closable closure element are shown and/or disclosed). (Various examples of closure elements 19 are shown)). (Rather than the term ‘closure element’, the term ‘closing element’ may be used). (The term ‘closing portion’ may be used. The term ‘openable and closable portion’ may be used). An openable and closable portion may comprise multiple sub-portions 19, (eg two, or more). Thus it may not be provided in one ‘piece’. For example, much how swinging doors, (of the classic ‘cowboy saloon style’), have what could be called two ‘sub-portions’ that each swing, (or at least are able to swing outwardly), so it is possible an openable and closable portion may comprise multiple sub-portions 19′, (and that the/a storage area can nevertheless be locked). And as has been stated, in other embodiments, the door element(s), (openable and closable portion(s)), may be able to slide, stop open and close. Thus various options and/or embodiments are possible. Preferably, it is possible to change the unlocking code, (eg see the close-up of the example combination lock in FIG. 2). Thus after a storage area has been unlocked, (eg following an item being purchased), an admin party may set a different unlocking code. This could be important in some situations. (This could be especially important in situations where a same person may have access to the storage apparatus multiple times, at different times. For example, if a (fitness) instructor, (or dance instructor, for example), adds the storage apparatus to a class where, let us say, a dozen or so students come, and come, let us say, every week, it would not be ideal (or wise), if a storage area(s) is re-stocked, but the same unlocking code to unlock it again is used. This would leave the apparatus open to robbery, because a person who, for example, bought an item from a particular storage area, (and therefore was given an unlocking code to unlock that storage area), would be able to unlock that storage area again, (eg a week later), even after it has been re-stocked. Thus it would be wise to change the unlocking code. Thus the method may comprise changing the unlocking code, (for a storage area(s)). However, there are other occasions where this may be far less necessary. For example, if the storage apparatus is in a taxi and a passenger, for example, buys an item, (or gets an unlocking code even for a free item), unlocking a storage area with an unlocking code, then unless the taxi is a service that serves a particular area/customer(s), it is highly unlikely that that same person will ever be in that taxi again. For example, if the taxi is a black cab in London that simply randomly picks people up off the street, it may not be needed to change the unlocking code, because it is highly unlikely that passenger will ever be in that taxi again. For example, the/a storage area could be re-stocked and re-locked after the person (user) who has unlocked the storage area (eg having purchased an item(s) in the storage area) has left the vehicle. (This could be done almost immediately after they have left (ie having got to their/a destination in the vehicle), or could be done later, (eg at the end of the day/shift, or, for example, at the start of a new day/shift)). Thus a new person/passenger/user could get into the vehicle, and get (eg purchase) an item(s) from the same storage(s) area as the last person, using the same unlocking code(s) as the last person. Thus various options and/or embodiments are possible And it should also be stated, having provided the example of a taxi, use in a vehicle is not limited to a taxi. For example, this could be used for a train. (Furthermore, the broad term ‘car’ may be used, not limited to ‘taxi’, (although a taxi is a car)). Thus a person(s) on a train ride may be able to purchase in this way. (Use on a train may or may not be so limited to the ‘driver’ being in charge of and/or ‘involved with’ the storage apparatus. For example, other staff/person(s) may be involved).

And it should also be stated, storage apparatus(es), (eg in different vehicles), could be owned by a company. The company may have a business model where they own a plurality (eg many) storage apparatus. For example, a company may own storage apparatuses at work in hundreds (or even thousands) of taxis, for example. For example, a company may own storage apparatuses for hundreds or even many, many thousands of passengers on trains (and/or planes, etc or any vehicle). For example, there could be a storage apparatus in front of thousands, or even millions of passengers, on different trains. (As disclosed elsewhere in the present application, the/a storage apparatus could be held to a seating apparatus, (eg in front of the user)). (Trains and plane (ie airplanes) are just two examples of passenger (fare) vehicles. Storage apparatus(es) may be used for any passenger (fare) vehicle, not limited to these two examples).

As has been stated, the/a storage area(s) may, of course, be re-stocked.

Note: The term ‘user’ is used often in the present application. (Eg if a person pays for an item, getting an unlocking code to unlock a storage area, they are referred to as the/a ‘user’. In terms of those involves more on the providing and/or maintenance side of things, various types of party(s)/person(s)/company(s) etc could be involved. For example, in a hotel, a member of staff, (eg a maid, for example), may do changing of unlocking codes and/or restocking, (and/or any other jobs). However, it is highly unlikely, in such a situation, that that member of staff, for example, receives any payment made by any users. It is more likely, for example, that (at least some, or the majority, or all) payment goes to the hotel. The hotel may be a ‘sole’ hotel, or could be a hotel as part of a brand that has many hotels, (eg hundreds, or more). Thus at least some, or the majority, or all) payment may go to a company(s)/party(s)/corporation(s) behind (eg that own) the hotel(s). Thus various options and/or embodiments are possible. (It should also be stated, in a bed-and-breakfast (BnB) type situation, (or any small accommodation situation, (eg a person(s) renting out a portion or a whole of an accommodation (eg house/flat, etc) that they own (or even if they do not won it))), it may be more likely that the person(s) (ie ‘party’) doing the renting out may do a portion or a whole of the maintenance for their storage apparatus(es), (eg changing of unlocking codes and/or restocking). This may or may not involve altering/updating/changing data/information on an interface (with an electronic device). (Interface examples have bene provided and/or alluded to). (Electronic interface examples have bene provided and/or alluded to). Similarly, in the case of use in a taxi, for example, the driver may own the storage apparatus, (or he/she may not). If the driver does own, the driver may carry out all maintenance/jobs, (eg changing of unlocking codes and/or restocking, (and/or any other jobs). (And the driver may well receive (at least some, or the majority, or all) payment for purchasing of items by users, for example). However, (in line with what has been stated with regard to hotels/accommodation), it is possible a company(s) owns many taxis, for example, and it is the company(s) that own the storage apparatus. In this case, the company(s) may well receive at least some, or the majority, or all) payment. (It is also possible that some payment also goes to the driver(s), for example. And even if the company(s) own the storage apparatus(es), (eg for a plurality/many taxis), the driver may still have to.be the one to carry our maintenance job(s), changing of unlocking codes and/or restocking, (and/or any other job(s)). Thus a vast array of options and/or possibilities are possible, with regard to this. For this reason, a broad term ‘admin’, (short for administrator), is or may be used in the present application, which includes all these possible parties within its scope. (The term ‘admin party’ may be used, which again includes all these possible parties within its scope). (It should also be stated, the broad term ‘provider’ may be used, which includes within its scope whoever ‘provides’ the storage apparatus(es)/opportunity for the user. (For example, if a company owns many taxis and owns the storage apparatus in a taxi, (eg that store items that can be purchased by the user), they are the ‘provider’ to the user). (If the storage apparatus was owned simply by the taxi driver, the taxi driver would be the provider). (It should also be stated that any party that sells anything may be referred to as a ‘seller’. (And, to make clear, if a driver, for example, owns the storage apparatus in his/her taxi, and sells item(s) to users (passengers) using it, they are both a ‘seller’ and an ‘admin’, in line with what is stated above). Thus whilst the broad term ‘admin’ or ‘admin party’ is used here, wherever the term ‘admin’ or ‘admin party’ is used, we reserve the right to use any of the other terms mentioned above in this here paragraph, and these terms are deemed, (especially in light of what is stated above in this here paragraph), to support any of these party(s), (eg ‘staff’ and/or ‘seller’ and/or ‘provider’ and/or ‘owner’, etc or the like). Thus these terms/positions, etc are deemed supported, (especially in light of the statement(s) in this here paragraph, when the term ‘admin’ or ‘admin party’ is used. (As has been stated, the term ‘admin’ could, in some situations, cover multiple parties, (eg ‘staff’ and a company that own the storage apparatus (and who may well pay the staff). Thus various options and/or embodiments are possible. (It should also be stated, there could be another party worth mentioning and/or considering-for example, there could be a company that provides the backend workings/interface(s) to facilitate the (or any) method for providing item access. Typically, this will either be a company that has hired in, or has in-house, technical expertise. (Software expertise can be particularly important, for example). (This company could own (and/or may have designed) the backend and/or frontend of a portion or a whole of any interface. (Examples interfaces to facilitate the/a user getting an unlocking code(s) have been shown and/or disclosed)). It should be stated, this company/entity may even get some of the payment made by users for items. Alternatively, (or in combination), they could have a business model where they charge an amount (eg one-off amount and/or subscription), either for set-up of the system and/or for ongoing use of the system. It should also be stated, it could be this party(s), (or any other party(s) that sell the hardware for the method/system. (Eg storage apparatus(s) and/or lock(s), etc, etc). This could form part of a business model. (Such a party(s) could also be considered to be within the term ‘admin’ or ‘admin party’ if they are involved with maintenance to do with the system). Furthermore, the item company(s) themselves-for example, a well-known fizzy drink brand could be involved selling items, (eg fizzy drinks and/or chocolate bars, for example), for being sold using this (or any relevant) system. There could be fairly direct involvement, in terms of business model, for how this works. In this case, the well-known company given as an example would not be an ‘admin’ unless they are involved with the maintenance side of things. Nevertheless, it is feasible such a company/party could even buy storage apparatuses to be used to sell their items, (using this method/system), (or even get more fully involved in the process than that, with maintenance (eg restocking, etc), in which case, they would be an ‘admin’/′admin party′ Thus there are various and many potential parties that may be involved. Thus this has been made clear.

With particular reference to FIG. 2, there is shown a close-up view of one of the example storage areas 12 of the example storage apparatus 10. An example lock 14 is shown. (It is an example non-electronic lock). In the example, it is a combination lock. (However, this is just one type of lock, shown simply by way of example only, and any type of lock at all may be used). In the example combination lock, example dials 42 are shown that turn. (In the example, (provided simply by way of example only), an example lock knob/dial 44 is also able to rotate). (In the example, (provided simply by way of example only), a portion or a whole of the example lock is able to rotate, (this is shown/denoted/achieved, in the example, via the arrowed line denoting that the example knob/dial 44 is able to rotate), and open the storage area after the unlocking code has been entered to the lock). (it is an example, broadly speaking, of a movable element). (It is an example of a rotatable element). There is shown an example hinge 80, (provided simply by way of example only, and depicted in fairly basic fashion), that allows the example door element to rotate when opening, (and closing). In the example, (provided simply by way of example only), there is an example area/portion 24. (In the example, this may be/provide a ‘notch’, for example). In the example, example area/portion 24 of the example lock 14 is positioned/held behind example portion/area 134. (In the example, (broadly speaking), a portion is held. (In the example, a portion is held behind another portion). This, in the example, holds the storage area door element closed when locked. (Thus it is locked).

In FIG. 3, an example of a process of how a user pays for an item, (and gets it from the storage apparatus) is shown/denoted. In the example, (provided simply by way of example only), a smartphone is used by a user to scan the example QR code. A server is denoted. A database is denoted. Cloud infrastructure is denoted. An example interface is provided, (that the user can use on the smartphone). (In the example, the interface is provided by way of a web page(s). In the example, this being brought up is initiated by scanning the QR code). User can select the storage area(s) they would like to unlock, (to get item(s)). They are able to purchase the item(s), (and, in the example, have to do so, to get an unlocking code(s) for the selected storage area(s). In the example, an example interface is shown where user can select their preferred payment method. Thus, in the example, user can select a storage area(s), and then make the required payment. There is shown an example payment screen where the user, in the example, confirms their payment. There is shown an example page/screen where the unlocking code is provided to the user. (It is also feasible that any or all of the shown screens are combined onto one screen-it will be apparent the interface (and nature of how it is provided) is being shown by way of example only, and a large array options and/or embodiments are possible, which will be apparent in light of the nature of the disclosure).

In FIG. 4, there is shown a close-up front view of an example openable and closable portion of one of the example storage areas 12. There is shown an example lock 14, (which, in the example, is a combination lock). There are shown example manually operated dials. (The example dials can be adjusted. In the example, the unlocking code can be changed). There is shown an example hinge. This, in the example, facilitates the openable and closable portion opening and closing in a rotating action. An example hinge 80, in the example, allows the openable and closable portion to rotate out when opened.

In FIG. 5, an example of a process for how a user gets a free item (eg ‘free sample’) from the storage apparatus is shown. Much the same is shown as in FIG. 3, (where an item was paid for). However, payment is not required in what is shown in FIG. 5. There may be more likelihood that user data is provided/received when the item is free. (ie Leveraging the fact the user is getting an item(s) free, this may be an opportunity to get user data that may be usable to generate revenue from the user, eg at a future point. For example, such data could be used to market to the user. (It could be used to market other products). The data could be sold, for example. (The data could be sold to another company(s)). Personal data may be required from the user. This may include contact data, (contact information). (This may include email. This may include phone number). This may include name data. User may have to review terms and conditions. User may have to agree to terms and conditions. It can be seen, in the example of FIG. 5, how the example unlocking code is provided to the user without any payment being required. (Nevertheless, it is possible payment data (eg card data (ic card to pay for future purchases), and/or any other form of payment may be required. An account, (and providing of information/data to create an account), may be required. In the example, (provided by way of example only), the user gets the unlocking code after having submitted their contact information. It is denoted, (by virtue of the letter/envelope icon 62), that there may follow-up communication to the user. (This could rely upon the contact information provided by the user). Follow-up may be via any or all of: email, text, call, etc. Thus there may be relevant system(s) to carry this out. It is possible user may be sent a survey(s). In the example of FIG. 5, internet or Bluetooth technology, for example, may be used. (This can be useful/important, of course, for communicating information). In the example, a server is denoted. In the example, a database is denoted. A clock icon 64 simply denotes that timed communication can be sent to the user. For example, they may get an email once every week following this process. Other forms of communication could be text, (or even call). Any form of communication could be used. Any form of communication could be ‘timed’. If a user already has an account, for example, they may not need to input their contact information. It may be stored. Thus logging in to their account may suffice, in such a situation. Nevertheless, it is possible they may still have to enter contact information. (In the present application, the term ‘data’ may be used, rather than ‘information’ or ‘details’ or the like).

(The clock icon 64 is referring to the fact that the method/system may be able to send timed communications. For example, a user submits their email and then gets a code and retrieves a free sample from the apparatus. Then, over the next four weeks, for example, (or any time amount), that user receives a promotional email, for example, each week, for example, encouraging them to make a purchase online, for example, or in a store, for example).

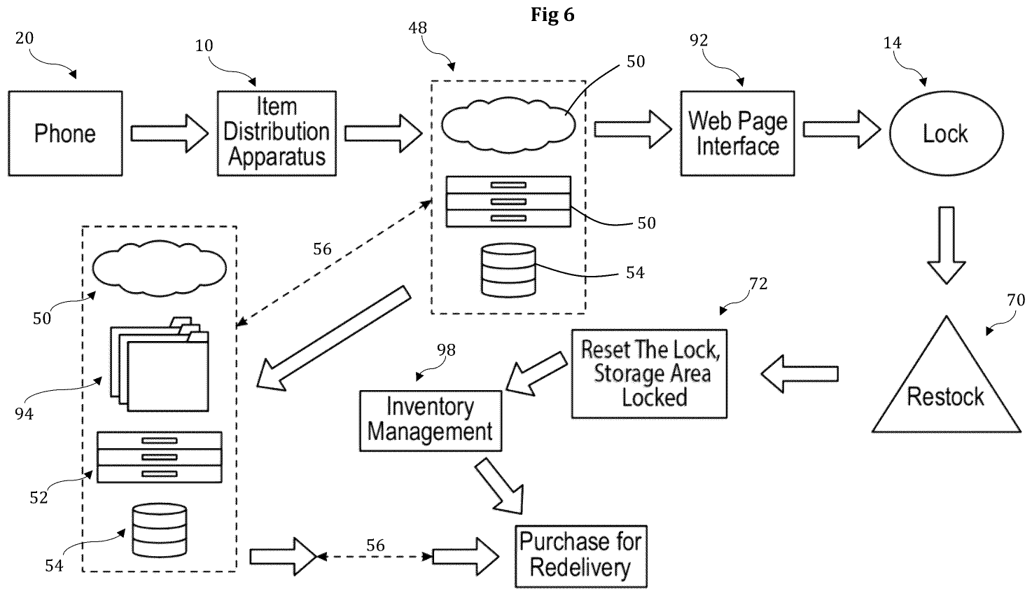

In FIG. 6, an example of a process of restocking of a storage area is shown/denoted. From the top left of FIG. 6, the first two boxes, (numbered with the numbers ‘20’ (for electronic device) and ‘10’ (for storage apparatus), simply denote that, in the example, user is using their smartphone to try to get an item from a storage area of a storage apparatus, (in the example provided, this being done by scanning a QR code, for example). Again, in the example, a server is denoted. Again, in the example, a database is denoted. Again, in the example, the cloud is denoted. (As stated, the example is provided simply by way of example only). (A server, a database, and the cloud are shown. However, it should be stated, communication and/or interaction with the electronic device of the user may be done via any relevant communication/interaction method(s), (eg online method(s))). In the example, user uses an interface on their smartphone screen, (as has already been explored/disclosed). User gets the unlocking code and unlocks the lock. (Disclosure has been provided relating to retrieval of unlocking codes. Examples have been shown of software carrying our retrieval/providing of the unlocking code(s) to the user, (provided by way of example only)). Thus user gets the item from the storage area. Box 70 denotes that the storage area is re-stocked. (This may, for example, be with the same type of item(s). This may, for example, be with a different type of item(s)). This is done, in the example, by an admin party. Box 72 denotes that the unlocking code is changed. The storage area is locked. (With reference to the/an example for the example storage apparatus, the lock is reset and the compartment is closed. It will be apparent that some of these steps can be done in different order, (especially depending on nature of the lock, for example). For example, some locks may not require that the storage area be closed when changing/setting an unlocking code. In this case, the unlocking code could be changed before the storage area is re-stocked, for example. Then the storage area could be re-stocked. Then the storage area could be closed, thus locking it. After user has got the item, restocking of the storage area, (eg by a staff user) is denoted. Thus the storage area may be re-stocked with another item(s) for sale, or sample item(s), (free), for example. Thus the storage area be re-stocked with new item content. In the example of FIG. 6, the unlocking code(s) is reset to a different unlocking code(s) 82. There may be provided an inventory management system, (denoted in box 98). This may be software-based. (An example software system 94 is denoted). If data is received about the item(s) that are got by user(s), the inventory management system may detect that more inventory is needed. This may result in submitting an order for more inventory, (denoted by box 100). This (inventory) could be delivered to a selected address. This could be done through an ordering system. (The ordering system could be an online ordering system). The ordering system could be an integrated ordering system. (The ordering system could be an online integrated ordering system). (It may not be required, (for the/an inventory management system to detect that more inventory is needed), for data relating to the item itself to be inputted, (eg that another of the item has been got by a user). For example, merely inputting the data that the/a storage area itself may effectively do the same, if the system already knows which item(s) was in the storage area.

(Feature number ‘56’ is used for/represents the transfer of data (e.g., the phone retrieving/accessing data to see the web page, for example).

(The order of the process/how things occur in FIG. 6, (and in many of the Figures, and much of the disclosure in the present application), is shown by way of example only. (For example, the order (and what occurs) may vary for different embodiments.)).

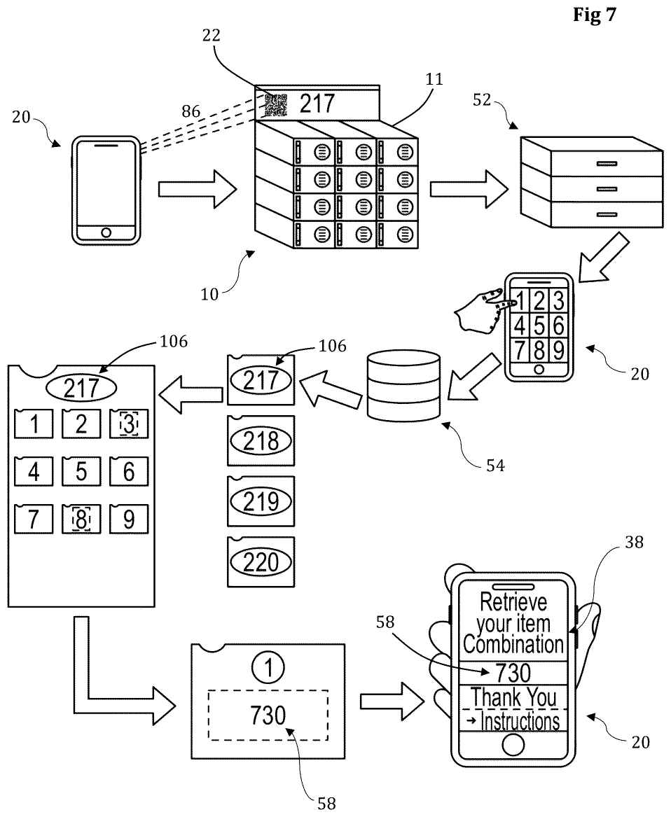

In FIG. 7, an example is denoted of a process for how to retrieve/provide an unlocking code(s) that is/are stored in a database 54. In the example, an example QR code is scanned, (denoted, with number ‘86’ added), by a user with their smartphone. Example database 54 stores the unlocking code. An example server 52 is denoted. In the example, the interface allows the user to select a storage area(s) to unlock. In the example, (provided by way of example only), database retrieval of a specific unlocking code(s) occurs/is carried out. In the example, this is stored in cloud storage; (or any storage, (not limited to cloud storage), in the example. (An ‘identifier’, (numbered 106), (which is ‘identifying data’) is shown, stating, in the example ‘217’). But QR code is able to identify this without the user needing to use the identifier ‘217’ in this example. (However, it is also possible the QR code could direct the user to an interface where the user then inputs the (or an) identifier. Thus various options and/or embodiments are possible. User makes a selection of storage areas ‘3’ and ‘8’ in the example, on example interface/screen 104. The user is provided with the unlocking code(s) on an example interface/screen/page, the unlocking code being ‘730’, shown on the example mobile device 20. (This is just showing an example where one storage area has been selected to be unlocked. However, as alluded to and stated, it is feasible a user may be able to select more than one storage area. In such situation, rather than there being one unlocking code (as shown, there may thus be more than one unlocking code shown). (In the example, (provided by way of example only), it can be said that an unlocking code(s) has been ‘retrieved’). (In the example, it can be said that an unlocking code(s) has been ‘delivered’).

FIG. 8 is a close-up front view of an example storage unit. It shows various data that may be displayed. (In the example, this is shown displayed on the unit/apparatus itself. However, as has been made clear, this is not required. It will be apparent for example, that much or all of the data displayed could be displayed elsewhere, (eg in proximity to the example unit/apparatus). (Both may feasibly be provided). In the example, steps for a user to take in order to get an item from the storage apparatus are displayed. (These act as ‘instructions’ for the user). (Although the example embodiment shows an example portion, (at a top of the apparatus, in the example) with a QR code 22 on it and a phone number 122 for accessing an online interface associated with the storage apparatus, it is feasible that the QR code, for example, could be printed and could be somewhere else, not on the storage apparatus. In line with this, an example booklet 126 is shown. This could be on a table, for example. Thus it could be on a table, (or an any item/surface), near the storage apparatus. It is also feasible that a QR code 22 would not be used to access an interface (eg online page), such as a interface (eg page/screen) for selecting an item, for example; for example, in a different embodiment, a user could directly (ie ‘manually’) enter a website URL into a web browser. In another embodiment, user may be able to text a (phone) number, (to access an interface). The user could, for example, then get a link texted back to them, to get to an interface. However, it could be stated, it is feasible the user would never need a webpage and could just get the unlocking code(s) via a computer/program that would text chat with them, for example (eg being programmed to do this). this could be similar or same to a ‘chatbot’. It could be a ‘computer agent’ type program, for example. In another embodiment, user may be able to call a phone number, (to access an interface) this could work similarly to calling a bank, for example. (banks often have automated call systems for many functions). for example, it could be an automated voice (eg one that is programmed). It could ask to identify the storage apparatus (and/or storage unit and/or storage area(s)). it could ask what (storage area(s) the user wants (to unlock). It could ask what the user wants to purchase. It could give prices, etc. it could ask which storage area(s) the user wants. The user could reply (eg by touch of numbers on phone interface, for example, or by voice, for example). It could then gives the user a payment link, eg to the same device (eg the same phone (eg smartphone) number the user called on. once the user has paid, it could give the user the unlocking code(s). This could be done verbally. and/or this could be done via text, etc. (any or all of the above things may be carried out in this way, (by calling a phone number). Thus it has been made clear that any or all of these things mentioned, (with regard to the method of calling a phone number), may be done/happen/occur. In another embodiment, user may be able to use an app to access an interface. (Examples of an interface for selecting storage area(s) to unlock have already been disclosed). (Any one or more than one (or all) of these methods may be possible, for example).

Note: For the sake of the present application, selecting an item(s) contained in a locked storage area, to get an unlocking code, to unlock the storage area, is considered to be within the scope of ‘selecting a storage area’. (And vice versa-ie, for the sake of the present application, similarly, selecting a storage area(s), to get an unlocking code, to unlock the storage area, to get item(s) stored within the storage area(s), can be considered to be within the scope of ‘selecting the item(s)’ (that are stored in the storage area(s)), (to be unlocked)).

Thus, for the sake of the present application, this is considered to be within the scope of ‘selecting a storage area’ (for unlocking). To explain, (and give an example of this), if a person orders a taxi, it will be well known, many taxi services/systems these days work through an App that the user can use on their smartphone, for example. (A smartphone, of course, is an example of an electronic device). (A smartphone, of course, is an example of a portable electronic device). Let us imagine, then, that a user has ordered a taxi, and has used the/an App. Let us now say that inside the taxi, there is a storage apparatus, which, in this example, we will say has a beverage of some sort locked in a storage area. (This ‘beverage’ example is provided by way of example only, and the contents of a storage area could comprise any item(s), not limited to a beverage, of course). Now let us say that, having used the App to order the taxi, the App is aware of the taxi that the user is in. (This may well be the case since that taxi has been ‘designated’ to the user). (It is also possible user's presence is acknowledged through proximity technology, (eg GPS, for example)). Thus the App, in such a situation, could offer the user the chance to get said ‘beverage’, (or whatever content is in the storage area), (rather than offering the user the chance to specifically select a ‘storage area’. (This could be possible, for example, if information as to the content of a storage area(s) has been uploaded to/stored by the/a system. It could thus be visible to the viewer, on their electronic device, (eg smartphone), to select. This will most likely involve the user buying the content. But it is feasible content could be provided free. Thus, if the content in this example is a bottle of a well-known fizzy drink, for example, the user may be able to select said well-known fizzy drink via their electronic device, and may be able to get an unlocking code to unlock the storage area, to get the said well-known fizzy drink. (In one example, (provided simply by way of example only), an image of the content could appear on their electronic device. This could be helpful, of course, in soliciting a sale, for example, of the content. For example, when the user is in the taxi, (or at any time), an image of content of one or more than one a storage area could appear on the user's phone, (eg at the bottom of the screen of their phone, as often happens for up-sales, for example, when using a smartphone/smartphone App). Thus an image, (in the example provided), of the bottle of the well-known fizzy drink could appear (eg ‘pop-up’) on the user's smartphone. This image may be clickable, (or relevant clickable link(s)) may be provided. Thus this is an example of how the process of the user getting (being provided with) an unlocking code(s), (to get the content), can be initiated. As stated, for the sake of the present application, this is considered to be within the scope of the user ‘selecting a storage area(s) to unlock’. Typically, (as explained/disclosed in the present application), the user will be able to visually see the content of the/a storage area(s). Thus, in this example, if the user is able to visually see the content, (eg the bottle of the well-known fizzy drink, in this example), and, knowing it is present and locked in the storage area, then selects the content, in order to get an unlocking code(s), to unlock the storage area and get access to the content, then this is an example of the user visually seeing the content in the/a storage area, and selecting the content with a clear view to getting an unlocking code, to get access to the content. Thus, as stated, for the sake of the present application, this is considered to be within the scope of ‘selecting a storage area’ (for unlocking). It is clear their selection of the ‘content’, (locked in the storage area), is tantamount to selecting the actual storage area(s) that the content they are selecting to access is in. Thus, as stated, for the sake of the present application, it is considered to be within the scope of ‘selecting a storage area’ (for unlocking).

(Having said that, ‘for the sake of the present application, similarly, selecting a storage area(s), to get an unlocking code, to unlock the storage area, to get item(s) stored within the storage area(s), can be considered to be within the scope of ‘selecting the item(s)’ (that are stored in the storage area(s)), (to be unlocked)′. It should be stated, however, preferably selecting of a storage area(s), (eg storage area ‘number’ (or any storage area identifier)) is done, (rather than selecting of item(s)), because this can have significant backend and/or admin advantages. For example, if an item is sold from a storage area, then if that same storage area is restocked with a completely different item, if the interface facilitates selecting storage area(s), (rather than item(s), then the interface need not change/be updated. But if the interface was using selecting of item(s) as the way to select (eg with images of items), then changing/updating would be needed, (eg to change the image from the old item to the new item the storage area has been restocked with).

(Note: The term ‘item content’ may be used, (for what is stored in a storage area). The term ‘item content’ includes within its scope whether there is one item in in the/a storage area, or whether there is more than one item in a storage area. Thus, if a user unlocks a storage area, and there is one item, (eg a beverage, (eg a bottled beverage)), then that one item, (ie the bottled beverage, in this example), is the ‘item content’. And if there is more than one item in the storage area, (eg a bottle of wine/champagne, for example, plus also multiple items of ‘drinkware’ (eg (plastic) cups, mugs, glasses or the like), then all of those items together are still the ‘item content’ of that storage area. Thus if a user buys an item, there being only one item in the storage area, they have bought/purchased the ‘item content’ of that storage area. And if there is more than one item, (eg a drink/beverage and a chocolate bar (or any other food item to go with the drink, for example)), for example, and the user pays to unlock that storage area, then can again be said to have paid for the ‘item content’ of that storage area, (with the ‘item content’, in this example, being multiple items). Thus this has been made clear.

It should also be stated, if a user pays for an item in a storage area, then even if there are other ‘free’ item(s) in that storage area, then that is still within the scope of the user ‘paying for an item’, (and is within the scope of the user ‘paying for at least one item’), (and is still considered to be within the scope of the user ‘paying for the item content’ of the storage area). (It can also be said to be an example of the user ‘paying to unlock the storage area’, (and many examples have been shown/denoted and/or disclosed and/or alluded to of a user ‘paying to unlock a storage area(s)’, (ie ‘paying to unlock at least one storage area). It can also be stated as being an example of a user ‘paying to get an unlocking code’. To explain, if a user wants to get a fizzy drink/beverage that is locked in a storage area, and the payment required is two dollars, for example, then they must pay the two dollars in order to get the unlocking code. Thus they can be said to have ‘paid to get the unlocking code’. Thus it can be said that many examples have been shown/denoted and/or disclosed and/or alluded to of a user ‘paying to get an unlocking code(s)’. (And it can be said that many examples have been shown/denoted and/or disclosed and/or alluded to of a user ‘paying for an unlocking code(s)’). (And if so desired, wherever there is disclosure using terminology such as ‘paying for an item’, (involving getting an unlocking code to unlock an item from a storage area), that is deemed support for terminology such as ‘paying for an unlocking code’, (and such terminology may be used).

(It should also be stated, terminology such ‘paying to get an unlocking code’ and ‘paying for an unlocking code (s’ can also be used in situations where there is not an item initially in the storage aca, and where the user uses the storage area(s) to put their own item(s), (their own belongings), in the storage area. This has been disclosed in the present application, and such terminology may be used where it is applicable).

There are numbers, (‘1-9’) on the example nine storage areas. However, as has been stated, numbering is just one example of ‘identifiers’. Any storage area identifiers may be provided.

For example, it is possible an embodiment could be provided where there are different colours for the different storage areas. (eg A whole of an openable and closable portion of a storage area(s) may be a particular colour, (or just a portion of an openable and closable portion of the storage area(s) may be a different colour). (Thus, broadly speaking, this is within a scope of a portion or a whole of a storage area(s) being a particular/different colour). Thus different colours for different storage areas can be a differentiating factor). It is even possible that a differently coloured sticker(s) may be applied to each storage area. Thus, broadly speaking, ‘colour’ can be an ‘identifier’. (This could also be the case with reference to ‘storage unit’ identifiers). Colours could include red, blue, orange, green, etc. Thus various options and/or embodiments are possible, with reference to ‘identifiers’.

In FIG. 8, there is shown an example (phone) number 122 users can text, (shown as ‘555-55’ by way of example). For example, it may be that when a user texts the (phone) number, the user receives a text, for example, asking them to message in the chat a storage unit identifier, (which is number ‘232’, feature 106, in the example). (As stated, an identifier does not have to be on the apparatus. It could be above the apparatus, for example, eg on a wall. Or on a placard, for example). Perhaps then, after the user text messages the identifier, the user is then sent a text message in the same chat asking them to state/confirm what storage area(s) 12 they wish to get an item from. (User, in the example, could use the storage area numerical identifiers (‘1-9’) to do this). Furthermore, the user may receive a payment link, for example, for making a purchase. And/or user may receive a link to a contact form to enter their contact information. After the user makes a payment via the link and/or enters their contact information to receive an item such as a free sample, they may, for example, be texted an unlocking code(s) for getting the item(s) in the storage area(s) they originally texted (and thus selected) in the chat. If the user texted to receive a free sample, they may receive follow up communication, (eg such as a survey), in the text chat. (This could be to ask about their experience with the item(s), for example).

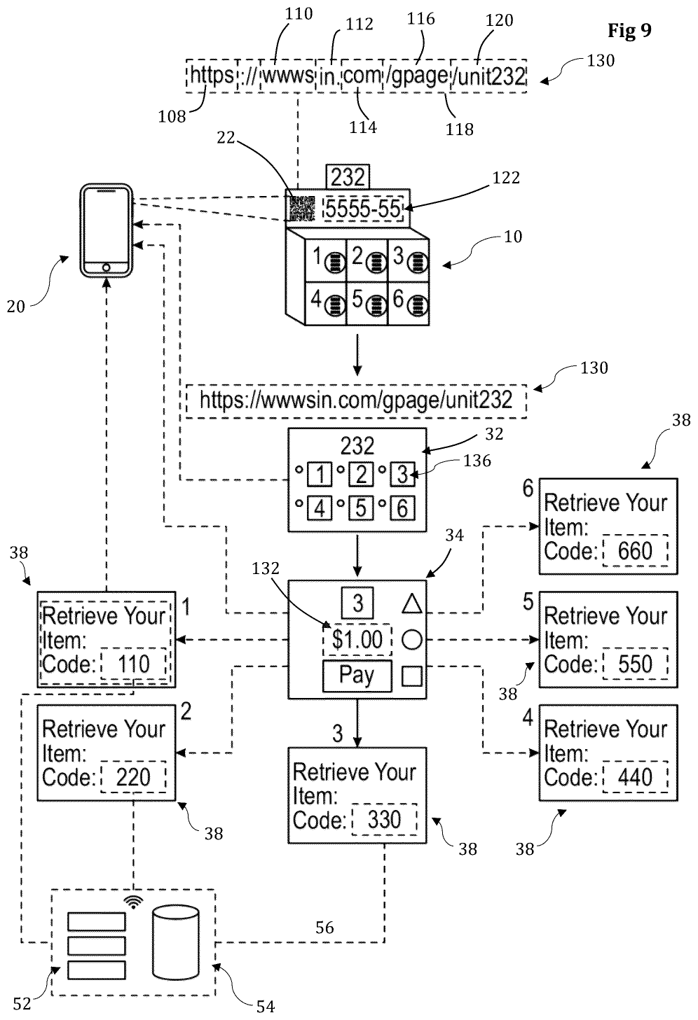

In FIG. 9, there is shown an example system and process for how a user may be able to access an interface with an electronic device, (a smartphone, in this example), to get an item for sale, (in the example), from the storage apparatus. The example, (provided simply by way of example only), includes a smartphone scanning an example QR code 22. (There is also shown a phone number option 122. (Either or both options may be provided, for example, and these are just two possible options, as has been stated). There is shown a unique website

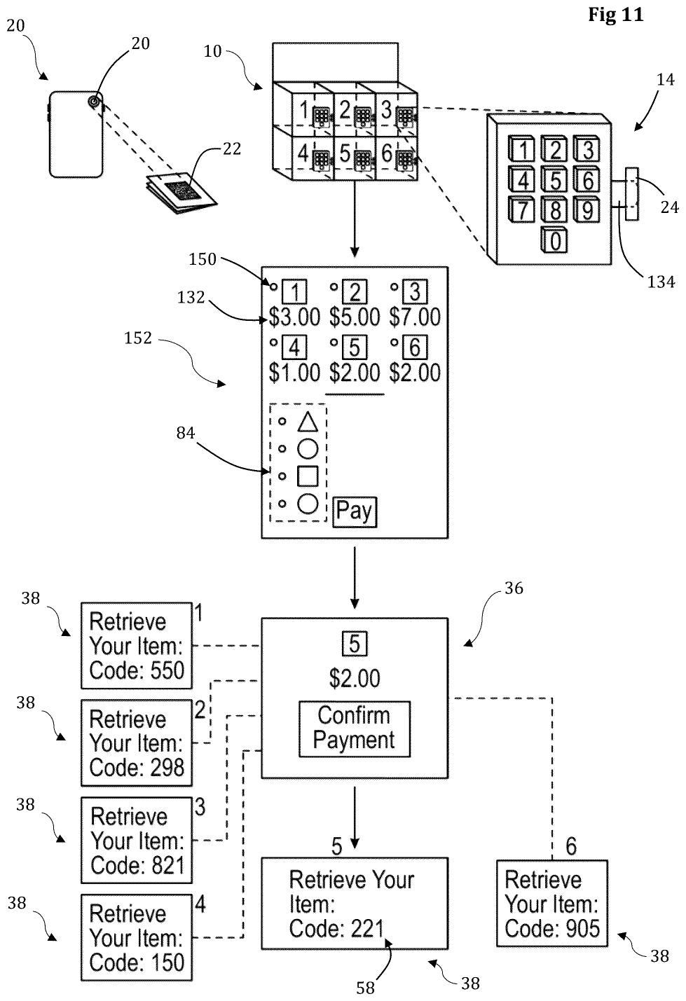

URL 130. This, in the example, has been used to create the QR code 22 that the smartphone scans with its camera. (Example camera 21 shown in FIG. 11, for example). The example a website URL 130 is shown including a protocol 108, subdomain 110, root domain 112, top-level domain 114, subdirectory 116, path 118, and slug 120. (This is shown simply by way of example only-it is feasible, of course, that the/some URLs utilized do not have all of these URL parameters, for example). In the example, after a user scans the QR code 22, based on the URL 130 ‘embedded’ in the QR code, the user is directed to a page 32 for their item selection. In the example, on the webpage there are image tiles 136 or other graphics This can facilitate moving ahead with purchase. Item(s) available for purchase may be shown. (In this example, (provided by way of example only), image(s) of the item(s) are not shown). (Note: These are represented merely as numbers, but as stated, imagery of item(s) in storage area(s) may be provided/displayed/shown). In the example, when the user selects their desired item(s), they are directed to a payment page 34 showing the price 132 of the item(s) selected. (In the example, the price is $1.00). In the example, they select their desired payment method and pay. The user may then be directed to a payment confirmation page 36. (Various examples of this are shown/provided, (provided by way of example only)). In the example, after the user pays for their item(s), the user is presented with an unlocking code(s) 58 on their smartphone, (in this example). (As stated, there may be a payment confirmation step). In the example, the user uses their unlocking code(s) to unlock a storage area(s) and get their item(s). Later on, if/when the storage apparatus is being restocked, (an) admin party (eg staff) may use a system including technology such as a server 52 and database 54, for example or other (online) (communication/interaction) method to change the or any unlocking code(s), (perhaps in bulk). (Any method may be used, to change any unlocking code(s). The examples provided are provided by way of example only). Later, (or in any order to achieve the desired result), the unlocking codes may be physically changed, (eg by (an) admin party (eg staff)). In the example, this can be done manually (by hand), to match the new unlocking code(s). (Thus the unlocking codes can be manually changed, to match the new unlocking codes, changed/updated in/by the system. (However, as has been stated, these things are not limited to being done in this order. Thus the unlocking code of a lock(s) itself mya be changed. It is possible that then, (after this), the unlocking code is updated on the system, (to match). Thus various options and/or embodiments are possible)).

In another embodiment, when a user selects a particular item(s) on the item selection page 32, they tap an example selection feature 150, in the example, (which is a ‘bubble’ in the example, but many other possibilities are possible, eg radio button, checkbox, etc, (the example bubble feature simply being an example of a means for selecting/feature to facilitate selecting)), to make their selection, in the example. (This, broadly speaking, is just an example of making a selection. (Thus it is an example of selecting)), The ‘bubble’ example is just an example of way to be able to select. It is an example of wherein a storage area(s) is selectable. (As stated, selecting an item(s), (in order to unlock a storage area(s)), is considered to be selecting a storage area(s), (for unlocking). For payment of an item, it's feasible that a user can confirm their payment on the same page they select their payment method. Various options and/or embodiments are possible. If the user is not making a payment and instead requesting/getting a free sample (free item(s)), they may therefore not go to a payment page. However, (as has been stated), even for a free item(s), the user may have to store payment information on the system. (This may increase the chance of them buying item(s) in the future).

It is possible, in some embodiments, that URL, (see example URL 130), used to create the QR code 22 has a slug (eg see feature number ‘120’), unique to each storage unit and/or storage apparatus. (As stated in the present application, it is even feasible this could be unique to a storage area). For example, one storage apparatus may have the slug “unit232”, (see feature number ‘120’). Another storage apparatus/unit may have the slug “unit105”.

Another storage apparatus may have the slug “apparatus527”, for example. (A storage area could have the slug “area167”, for example, (provided simply by way of example only). (Thus this may help to identify different storage apparatuses 12). (And as has been stated, this can even be used to identify different storage areas). (Broadly speaking, (not limited to any other terms such as ‘slug’, for example), examples here of different URLs being provided are given. It is shown how this can be helpful. It is shown how this can facilitate getting the unlocking code(s) for a storage area(s) to a user. However, the particular example given, (with reference to ‘slugs’), may be particularly useful). Broadly speaking, a change/difference to a portion or a URL is shown, (the example URLs mentioned having the same ‘domain’ (eg example.com). In the example, the portion that changes/is different is at an end of the URL).

(Examples of providing an unlocking code, (examples provided using feature number ‘38’) are provided/shown in various Figures. In various of the Figures, unlocking codes are shown provided for each storage area. This is depicted simply by way of example only. Of course, a user, (as is clear in many examples given), may only get one unlocking code. (And may not seek to get any more). It should also be stated, of course, a user may get an unlocking code, and use it to get item(s) of a storage area. That storage area may then be restocked, and another user (or even the same user) may then get an unlocking code for that same storage area, perhaps before one or more than one of the other storage areas have had their unlocking code got by any users. Thus the order of how things play our can vary. The examples and depictions provided are provided simply by way of example only).

In some embodiment(s), a website URL 130, QR code 22, item selection page 32, payment page 34 and multiple item retrieval pages 38 showing an unlocking code(s) may be created uniquely for each storage apparatus. (It is possible, (dependent on nature of the embodiment), that this could be the case for each storage unit. It is even possible, (dependent on nature of the embodiment), that this could be the case for each storage area). For example, one storage unit/apparatus with the unit number “232”, (which is an example of an identifier 106, (and thus is an example of ‘identifying data)), may have a unique item selection page, and/or payment page and/or unlocking code page created for it that includes different item(s), and/or pricing and and/or data compared to a storage unit/apparatus with unit number “105”, (which is another example of an ‘identifier), which may have its own set of pages corresponding to its unit/apparatus number, for example. (As stated, numbers are just one type of identifier).

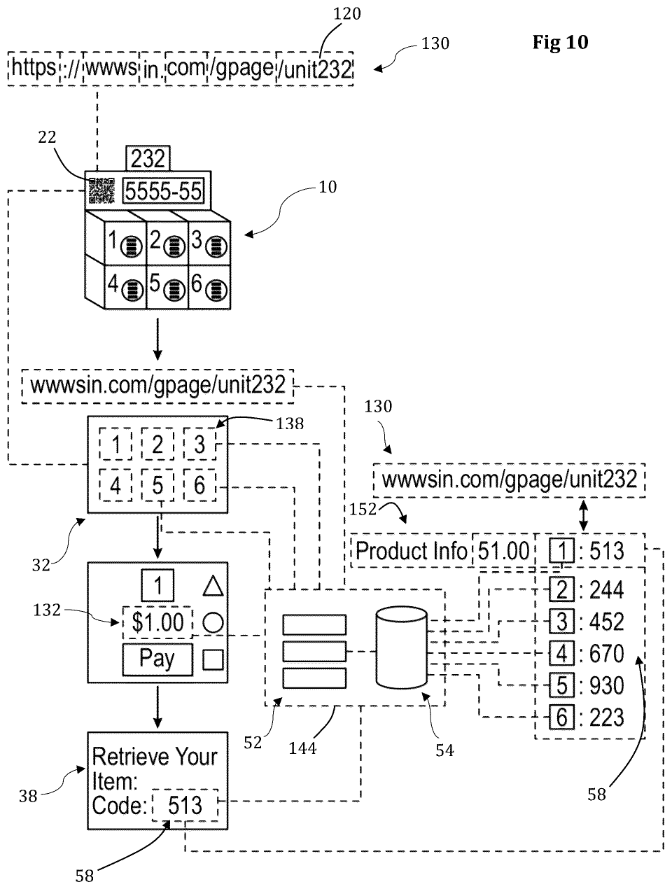

With reference to FIG. 10, another embodiment of a system/process for accessing an interface for getting an item from a storage apparatus is shown. (The example interface is an online interface). A QR code 22 can be used to access an online interface by a user with a smartphone, in the example. (A QR code can be created by using a URL to generate a QR code. There are many QR code creating services/providers that can be used for this, for example). (Aside from other technologies such as NFC, for example, less technological solutions can be provided, such as simply showing/providing a URL to a user, who could manually input the URL into a browser, for example. Thus this could be manually done on a smartphone of the user, for example, (a smartphone being an example of a mobile device, (and, more broadly, of an electronic device), and being provided by way of example here). In this embodiment, the items shown on the example item selection page/screen/interface 32, (on example area 138 of the example interface/page) are different based on/dependent on what slug 120 is in the URL 130, (when a user visits the example item selection page/screen/interface 32 with their electronic device, (eg smartphone)). For example, if a user scans the QR code associated with a storage apparatus with a apparatus/unit number, (or, more broadly speaking, ‘identifier’), that is “232”, the user may be directed to a web page, for example, (eg by a system 144, (provided by way of example only)), where the image tile(s) (imagery) 136 would match (and may have updated, (eg dynamically), to match), the example data 152 stored, (in the example on example database 148, (maty simply be considered a system), for that apparatus/unit number. (ie ‘identifier’ 106), and thus this can be done for that (or any) storage apparatus). (Note: Providing of an ‘identifier; is provided simply by way of example only).

(Note: Rather than the term ‘image tile(s)’ or ‘graphics’ (and the like), simply the term ‘image(s)’ may be used. The term ‘imagery’ may also be used).

Similarly, the area showing the price on the payment page may dynamically update to the price 132, (eg stored in a specific database 148), based, for example, on the URL, (eg based on slug 120), the user visits the page with, for example, (and/or on any relevant data). This database may also contain other information/data, such as the associated apparatus/unit identifier (eg number) and unlocking code(s) for unlocking the storage area(s) of the storage apparatus. (Six example unlocking codes 58 can be seen in FIG. 10, for the example six storage areas). The unlocking code displayed on the example code page/screen 38 may be able to dynamically update, (shown by way of example on an area of the page 142), based on any relevant parameter, (eg detected by the example system 144), that uniquely identifies a storage apparatus/unit based on its apparatus/unit number 106 (or any identifier), for example. (To explain, those with skill in the art will know about ‘UTM parameter’, for example. Thus UTM parameter could be used to dynamically update a webpage, for example, to data relating to a particular storage apparatus. Thus storage apparatus data may be dynamically updated in this or a similar way. This could include data relating to storage unit(s). This could include data relating to storage area(s). This could data relating to item(s). This could data relating to pricing, etc. This could include any or all such data. (Any or all data may dynamically update). Thus various options and/or embodiments are possible. (This is just one example of the correct data being ‘pulled’, dependent on data, for example, (eg URL, in this example). (In the example, (provided simply by way of example only, correct code is dynamically pulled from the/a database). In the example, this is facilitated via QR code. However, as the present application makes clear, this is just one example of how this can be facilitated

With reference to FIG. 11, there is shown an example system (and method) for accessing the interface associated with the storage apparatus, for getting an item. In this example, the/a storage apparatus does not have a QR code on it, or any URL, number, (or any identifier), but instead there is an example QR code 22 nearby the storage apparatus. (In the example, the QR code is on/in a booklet 126. (Thus this is an example of wherein a booklet comprises the/a QR code)). In the example, there is an example interface/page/screen 152 that the user accesses after scanning the QR code 22 with their electronic device, (which is a smartphone, in this example). In the example, on the same page/screen, there is an example area to make payment. In the example, on the page/screen, there are multiple product image tiles 136, (which is an example of imagery/images). Tappable (ie selectable) example bubbles 150 (which are radio buttons, in the example (and are simply an example of a means for selecting/feature(s) to facilitate selecting)), each with a different price 132, are shown. In the example, there is shown an example area 84 on the interface/page/screen to make payment. In the example, there is also shown an example payment confirmation page 36. In the example, there is shown an example item retrieval page 38, (which, in the example, may be called a ‘code page’), with an example unlocking code 58. In the example, users proceed to each page/screen after completing steps, (such as making a payment), starting, in the example, with item selection on example page/screen/interface 152, (after scanning the QR code, in the example).

In the embodiment shown in FIG. 11, the example locks that lock the storage areas are square in form. The are shown including an example keypad. (A tactile keypad is shown). (This is provided simply by way of example only). In the example, the locks comprise a keypad (This is provided by way of example only). In the example, there is a latch element that holds an example storage area closure element 19 closed. (The term ‘openable and closable portion’ may be used). In the example, this is by example portion 134 being held back by example portion 24. (In the example, (provided simply by way of example), there is a ‘notch/recess’ that feature 134 goes in. It is held back by example portion 24).

It is also feasible that a user could access the example page/screen/interface 152 through other means rather than a QR code. For example, user could access the page/screen/interface via any or all of: a search engine; Bluetooth technology; a third party app; hotel website, or any other way. Any one or more may be possible.

In FIG. 12, a perspective back view of an example storage apparatus 10 is shown. Thus the back is shown of the example. An example extra opening is denoted. (This is denoted by virtue of example closure element 166). The example closure element is openable and closable. (As has been stated previously, the term ‘closing element’ may be used). (As has been stated previously, the term ‘openable and closable portion’ may be used). The extra opening may be lockable. (In some embodiments, it may be less important for it to be lockable. For example, it is feasible, if used in a vehicle, (eg car, eg taxi), that the extra opening could face more towards the driver (and/or be more on the driver's side/area, thus making it fairly hard (or even impossible) for a passenger to get to the extra opening(s). In this case, it may be less important for it to be lockable. However, locking may be important, for security, to prevent item(s) being stolen). In the example, (provided by way of example only), there is a lock 156 that allows for locking the extra opening. (In the example, it is a key-operated lock). However, in other embodiments, this (ie a lock), may or may not be provided. Furthermore, the (or any) extra opening(s) may or may not be lockable. (And the example lock, (and example type of lock), is provided simply by way of example only). It will be apparent that the example extra opening shown, (in FIG. 12), is an example within a scope of not being subject to the (or any) unlocking code for the/any user(s). However, even an extra opening(s) that is not lockable could be said to ‘not be subject’ to the unlocking code(s) of any user(s), because it is not lockable, (and therefore not subject to such things). (Thus it can be said that disclosure has been provided of wherein the/an extra opening(s), whether lockable or not, is not subject to the (or any) unlocking code(s) provided to the user). (Thus both examples given can be said to be within a scope of wherein the unlocking code(s) (provided to a user(s)) are not relevant to opening the extra opening(s)). (The example extra opening shown in FIG. 12, (which is lockable in the example), is an example of wherein the/an extra opening(s) is lockable, and is not unlockable by an unlocking code(s) provided to the/a user). (The example extra opening in FIG. 12 is not unlockable by a user(s)). In the example, the extra opening allows access to all the storage areas of the storage unit/apparatus. In the example, it does this from the back. However, in other embodiments, the extra opening(s) may not be at the back. (It will be apparent how an extra opening(s) can be useful. For example, it can be useful for restocking. (Thus disclosure is provided, for example, of item(s) being put into the/a storage area(s), by using the extra opening. Thus it may be used in this way. (Eg disclosure of admin restocking a storage area(s). (And it should be said, items could be removed from storage areas(s), using the/an extra opening(s). This could be for various reasons, including removing stock that is not selling, for example). There is shown an example QR code 168. In the example, this is for admin (eg staff, (or any admin party, eg owner)) use. Scanning of the QR code, in the example, (provided by way of example only), takes the scanning person to a web page destination 158, (a basic example shown in basic fashion in FIG. 13). In the example, this displays a login form 160 for admin (eg staff, (or any admin party, eg owner)) to log into, in order to update inventory details/data and/or unlocking code 58 details/data. Thus this can be done, associated with the item(s) in the/a storage apparatus/unit. After admin (eg staff, (or any admin party, eg owner)) login to the example form 160, they are sent, in the example, (provided by way of example only), to an example page interface 162, (a basic example shown in basic fashion in FIG. 13). This, in the example, may be usable to update details/data relating to the/a storage/apparatus/unit. This, in the example, may be usable to update details/data relating to items such as inventory and/or items and/or pricing, etc. Admin (eg staff, (or any admin party, eg owner)) are able, in the example, to click or tap on selectable items, (via, in the example, features 164), on the page/screen/interface. The example page/screen/interface shows example identifiers, (which are numbers, in the example, shown as numbers ‘1’ to ‘6’), representing, in the example, specific storage areas, (ie storage area identifiers). (In the example, there are six storage areas. Hence why numbers ‘1’ to ‘6’ are shown on the interface). In the example, unlocking codes 58 are shown for the storage areas. The interface allows for/facilitates the unlocking code(s) being updated/changed. And/or the interface allows for/facilitates any other information/data, (eg data associated with item(s) stored by the stored apparatus, (eg item name(s), and/or image(s), and/or item quantity data, and/or SKU (which is a code that helps the company/provider, (ie broadly, an admin party) know what the product is) or the like))) being updated/changed./inputted/created.

In FIG. 14, there is shown an example holding arrangement 216. (In FIG. 14, there is shown a perspective back side view, showing an example storage apparatus/unit, held to an example seating apparatus(es)). The example holding arrangement is shown holding an example storage apparatus/unit to an example seating apparatus 301. Thus what is shown is within a scope of at least one storage area being held to a seating apparatus(es). In the example, the holding arrangement comprises example connecting element 218. However, there are many way to hold a storage apparatus/unit to a seating apparatus(es) and the example in provided by way of example only. In the example, the holding arrangement comprises a zip-tic(s). (One zip tie is used, in the example). An example zip-tie is shown, floating, next to the seating apparatus, to better show such an example zip-tic. A zip-tie is just one example of an elongate element(s) that could be used. A zip-tie is just one example of a connecting element(s) that could be used. In other embodiments, a strap(s), for example, could be used.

In the example, the zip-tic goes around the seating apparatus. (This can be seen in the Figure, in FIG. 14). In the example, the example seating apparatus has what could be called a ‘gap’ 220. In the example, this area is useful, for the example elongate element(s). In other embodiments, a seating apparatus may not have such a ‘gap’. In such an embodiment, a strap(s), for example, may be more useful, for going around the seating apparatus. Thus a strap(s) can be more useful, in such case, for holding the/a storage apparatus/unit(s). It is feasible more than one storage unit could be held to a seating apparatus). It should also be stated, a connecting element does not need to be elongate. For example, a relatively compact clip(s) could be used. Thus various options and/or embodiments are possible, which will be apparent. The examples shown and/or described for how to hold a storage apparatus/unit to a seating apparatus(s) are provided by way of example only.

(Two example QR codes 22 are shown in FIG. 14. In the example, these QR codes do the same job, and can facilitate getting an unlocking code for ant of the storage areas. There are simply two to perhaps peak the interest more of a potential user, for example. (As has been stated, it is feasible.

Now looking at FIG. 15, showing a very similar embodiment/situation, it can be seen how the example storage apparatus/unit comprises features to facilitate it being held to the example seating apparatus. In the example, there are ‘aperture(s)’ through which the example elongate element(s) can go. In the example, the aperture(s) 222 are provided by way of feature(s) 224. However, this is simply one example embodiment. It will be apparent that ‘arches’/′rings' are provided as an example, simply by way of example. In other embodiments, for example, there may be an aperture(s) that goes the whole way through the/a storage unit. (And there may be no visible ‘protrusions’ (eg ‘arches’/′rings′, for example)). This, (the example aperture(s) 222), helps secure/hold the storage apparatus/unit to the seating apparatus, in this example. It can be seen, in the example, that another zip-tie, (in the example) has been used. This is intended to help secure the storage apparatus/unit to the back of the example seat. (It should be stated, any or all of these such feature(s), (or any other ways of doing this), could be used to hold/secure a storage area(s) to a position/thing other than a seating apparatus(es).

Thus any holding/attaching/securing feature(s)/element(s) mentioned/disclosed, for example, (and any at all), is not limited to use with regard to a ‘seating apparatus’, which is shown by way of example only.

In FIG. 15, it can be seen that the example storage unit comprises an example keyhole. This is for unlocking an extra opening. (In the example, (provided by way of example only), a whole of the back of the storage unit can be opened. In the example, the whole back can be closed and locked. Preferably, as stated, it is a key lock. In the example, no unlocking code, for unlocking any of what could be called, (with respect to the example in FIG. 15 and especially the view/angle), the front openings, is usable to open the example extra opening. In the example, (provided by way of example only), opening the example extra opening opens all the storage areas.

In both FIG. 14 and FIG. 15, it can be said that at least one storage area is held to a seating apparatus(es). (In both Figures, a plurality of storage areas are held to a seating apparatus(es). In both Figures, a storage unit is shown held to a seating apparatus(s).

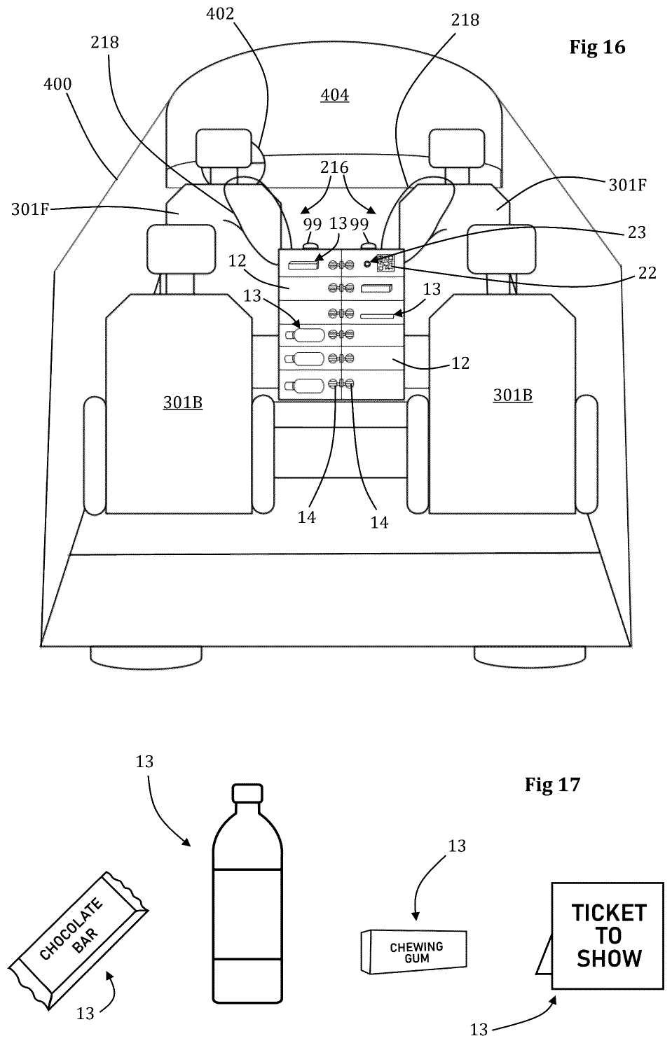

In FIG. 16, an open view (partial view) of an example vehicle 400 is shown. The example vehicle shown is a car. (The vehicle could be a taxi, for example). The example is shown with the roof removed, and not showing the back of the vehicle. This is to help see the features shown in the Figure. Two example back seats are shown. (Numbered with a ‘B’ after ‘301’, to represent they are ‘back’ seats). Two example front seats are shown. (Numbered with a ‘F’ after ‘301’, to represent they are ‘front’ seats). (This configuration (of scats) is simply shown by way of example only, and it will be known that many vehicles have different seating configurations. For example, a minivan may have far more seats). A steering wheel 402 can be seen. A windscreen is depicted in basic fashion 404. An example storage apparatus is shown. Examples storage area(s) 12 are shown. (There are a plurality of storage areas, in the example). The storage areas are shown locked. Various of the storage areas are shown storing an item(s) 13. In the example, the items are purchasable. In the example, chocolate bars, drinks/beverages, and a pack of mints are shown in the example storage areas, shown by way of example only. Some of the storage areas are empty. People may have already purchased items from them. As stated, in the example, the items are purchasable. However, it has been stated in the present application how free item(s) may be provided/available. (It has been explained how a user may be able to get an unlocking code(s), to unlock a storage area(s)). The example shown shows an example holding arrangement 216, (provided simply by way of example only). In the example, the example holding arrangement secures the example storage apparatus. (In the example, (provided simply by way of example only), the example storage apparatus has feature(s) that can receive the example holding element(s), shown in the example. (In the examples, these can also be called connecting elements. In the example, these can also be called securing elements). (One is shown going around a portion or a whole of one of the front seating apparatuses. The other is shown going around a portion or a whole of the other of the front seating apparatuses). (The example element(s) could be a zip tic(s), for example. Thus it is disclosed that an example, holding arrangement may comprise a zip tie(s)). However, this is just one example of such an element. (The elements are both elongate elements as can be seen). In the example, (provided by way of example only), the elements can be tightened. (Whilst in the example, the storage apparatus is held to more than one seating apparatus, in other embodiments, it may simply be held to one seating apparatus. It should also be stated, it could be held to anywhere in the vehicle, (not limited to being held to a seating apparatus(es)). In the example, the storage apparatus is on the floor of the vehicle. (It is not suspended). But in other embodiments, it may be suspended. (It should be stated, being held to a seating apparatus(s), (or to anything) and being ‘on the ground/floor’ is not limited to being with reference to use for vehicles). (It should be stated, it is technically feasible, in the embodiment shown, that the storage apparatus could be suspended. For example, if the example connecting elements can be tightened/shortened, it could/would have the effect of suspending/raising the example storage apparatus off the floor). (It should be stated, it is possible a seat (ing apparatus) could be folded, and a storage apparatus/unit could be placed on it. For example a seat could be folded forward, (relative to direction the seat is facing), and a storage apparatus/unit could be placed on it. It is even possible a portion or a whole of a seat could be removed, and that a storage unit is positioned on it/where said portion or a whole of it was. Thus various options and/or embodiments are possible). The example storage apparatus, in the example, is a storage unit. (It is a storage unit that comprises a plurality of storage areas). In other embodiments, there could be a plurality of storage units). (As stated, looking at FIGS. 14 and 15, it will be clear, looking at FIG. 16, that a storage unit could be held to one of the front seats, suspended, and/or an (other) storage unit could be held to the other of the front seats, suspended. Thus this is made clear). It should be stated, the example holding arrangement is provided simply by way of example only. In other examples, it is feasible more ‘integral’ feature(s)/solutions may be provided. For example, the example storage apparatus/unit could comprise a hook(s), (eg a back hook(s), for example).

The vehicle might have a place where a corresponding feature(s), (that the hook can hook on), is. This other feature(s) could be drilled in, glued powerfully, (all these being example of being attached). It should also be stated, it is feasible such a feature(s), (or any relevant feature(s)) could be designed in to the vehicle. (And it should be stated, the feature(s)/disclosure provided here, (with reference to the/a vehicle), is not limited to a vehicle. For example, such feature(s), may be useful, eg for holding and/or suspending and/or attaching the/a storage apparatus/unit(s), in place(s) other than a vehicle. And it should also be stated, being held to a seating apparatus(es) is not limited to only being possible in a vehicle. For example, a storage apparatus/unit(s) could be held to a seating apparatus(es) elsewhere, (eg an event, a theatre, etc).

In the example of FIG. 16, the storage apparatus/unit has feature(s) that can receive the example elements 218 which, in the example, hold it to the seating apparatuses. In the example, this feature(s) is/are at the back of the storage unit, (by way of example only). In the example, the feature(s) are much like the example features 224 shown in FIG. 15. (Thus the example storage unit in FIG. 16, (provided by way of example only), comprises aperture(s) 22. But these are not visible from the angle shown).

In the example of FIG. 16, there is a QR code. (It has been disclosed how useful this can be, in facilitating a user getting an unlocking code). In the example, the example QR code is on one of the storage areas. However, the example QR code, in the example, can be used to get an unlocking code for any of the storage areas. (Much disclosure has been provided in the present application of how this can be facilitated). (It should be clearly stated, whilst a QR code is shown on multiple occasions, rather than a QR code(s), (or as well as a QR code(s), there could be NFC, and/or any other solution(s)).

In the example storage apparatus shown in the example vehicle (eg taxi), the example storage apparatus is shown comprising example features 99. Thus the/a storage unit may comprise a feature(s) 99). (In the example, more than one is provided. It should be stated, in other embodiments, one could be provided, (rather than more than one). Thus another feature that can play a role in the storage unit being held is provided, in the example. (In other embodiments, (with regard to the connecting element(s) 218 shown, and these other feature(s) 99, (which, in the example, provided by way of example only, are generally ring-like, but could be any shape), the/a storage apparatus/unit may comprise both, either or none of such features). In the example, such feature(s) can be used to hang the storage apparatus/unit. (Eg hang on a wall, eg hung on a seat, (eg which may require further element(s) to achieve). It could be hung anywhere.

(It should also be stated, looking at FIG. 14 and FIG. 15, it can be imagined, now looking at FIG. 16, that there could be a storage unit held behind one or both of the example front seats. This could be a good configuration. Furthermore, it can be understood that on vehicles such as trains especially, buses or even planes, where there tend to be many rows of passengers sitting behind seats of other passengers, many storage units could be provided in this way. Thus this has been made clear).

(It should be stated, examples of seating apparatuses are shown where the seating apparatus has what could be called a ‘gap’ 220. In such cases, there tends to be a pole element(s) 221.

In other embodiments, there may not be such features, and the seating apparatus may just ‘continue’ in this area, rather than there being a gap. As has been stated, a holding arrangement can still be provided. Feature(s) such as strap(s), for example, may/can work better for such an embodiment. An added benefit of a strap(s) type element is it can be significantly flat. On seating apparatuses that do not have a gap 220, this may be important, so as not to make a person sitting in the seat in front (significantly) uncomfortable). (It should be stated, whilst a QR code is shown in FIG. 16, it has been made clear in the present application that various options and/or embodiments are possible. For example, an example NFC feature 23 is denoted in basic fashion, to show this may be possible. (The example NFC feature is depicted in basic fashion, simply intended to show that NFC is a possible alternative to QR code, (ie instead of providing the QR code). (There has been much disclosure relating to this in the present application). (However, it is technically feasible both are provided). (This is simply denoted to show this as a possibility). (Thus there may be an NFC feature(s)). Thus various options and/or embodiments are possible).

It will be apparent that disclosure is provided in the present application, (provided by way of example only), of a user using the electronic device of the user, (preferably a smartphone), to interface with a QR code, to facilitate providing the unlocking code to the user.

Various examples of locks are shown (in the Figures) and/or disclosed. It should be stated, it is feasible a padlock can be used as a lock. Thus, looking at FIG. 1 as an example, for example, one, or more than one, or all the example storage areas could feasibly be locked with a padlock. Thus various options and/or embodiments are possible. (Whilst it may be more elegant that the same type of lock is used with each storage area, (if there are a plurality of storage areas), it is possible different types of locks are used. Thus various options and/or embodiments are possible).

Various examples have been shown (and/or disclosed) of mechanical locks. Various examples have been shown of locks that are non-electronic (in lock function). Various examples have been shown of manual locks, (that require manual inputting of an unlocking code). (It is extremely clear, for example, looking at the example shown in FIG. 2, that this is an example of a lock that requires manual unlocking).

Various examples are shown and/or disclosed of non-electronic mechanical locks. The example shown are provided simply by way of example only. (It is feasible a lock as simple as a padlock could be used, for example).

(Various examples are shown and/or disclosed of an unlocking code(s) being provided to the user electronically).

(Various dashes lines are shown in some of the Figures, often representing transfer of data. (Various accessing/providing/retrieving of data is denoted)).

(Various examples are shown and/or disclosed of lock(s) that are not able to be unlocked by a remote device, (eg a smartphone, for example). Thus various examples are shown of lock(s) that are non-remote, in the sense of not being able to be unlocked by a remote device, (eg smartphone, for example)).

(Example storage area identifiers are shown in multiple Figures).

Various examples are shown in the Figures of where a user uses an electronic device, (a smartphone often shown in the Figures), for selecting. For example, in examples where there are a plurality of storage areas, examples are shown of how the user can select a storage area(s) that they want to unlock. Thus this could be considered a ‘remote electronic selection system’, (the electronic device (eg smartphone)), being ‘remote’ to the storage apparatus), (as opposed to a storage apparatus/unit/machine that has its own interface (ie as part of the storage apparatus/unit/machine)). (Note: To make clear, the term ‘remote’ does not require significant distance between the storage apparatus and the electronic device, (eg smartphone). It will be apparent from the nature of our disclosure that the/an electronic device of a user (eg a smartphone) can be extremely close to the storage apparatus. (There are many examples of this disclosed in the present application. A good example would be use of the storage apparatus in a taxi, for example)).

(The method may comprise: the unlocking code being provided to the user via text message to a smartphone).

(The method may comprise: a contact number being provided to the user; the user contacting the contact number via a smartphone; and, resultant of the user contacting the contact number via the smartphone, the unlocking code being provided to the user via the smartphone).

Disclosure has been provided in the present application within a scope of a mobile device of the user interfacing with a QR code, to facilitate providing the unlocking code to the user. (Preferably the QR code is provided on the storage apparatus).

(It should be stated, many different possibilities, such as QR code, NFC, Bluetooth, providing a URL, (and generally the concept of providing an identifier that the user can manually utilize (eg by putting into a browser, using/inputting into an App, etc), a phone number, texting a number, etc have been provided, to facilitate a user getting an unlocking code(s) for a storage area(s). (And disclosure has been provided that more than one may be provided, for example). It should be stated, in all such cases, this could be described as an ‘identifying’ step, because it ultimately helps the user get an unlocking code for a storage area, (and where there is more than one storage area, disclosure has been provided of it facilitating the user in getting an unlocking code(s) of a specific storage area(s)). Thus this can be considered to be an identifying step/part of the process, and can be considered to be an example of ‘identifying’, and where ‘identifying’ takes place).

(Example identifiers 46 are shown in FIG. 13, (shown by way of example only), which, in the example, area numbers, (and in the example, are storage area identifiers).

(In the example of FIG. 16, not all the storage areas have item(s) in them. But of course, it is possible that can be the case).

(Various examples are shown of a storage unit being held to at least one seating apparatus, (this stated as not being limited to being a seating apparatus of a vehicle). (Example(s) are shown of a storage unit being held to at least one seating apparatus of a vehicle).

(A portion or a whole of the/a storage apparatus may be built into a location, (the portion or whole of the storage apparatus comprising at least one said storage area). For example, built into a wall, (to give just an example)).

It should be stated, it has been stated that a QR code could be provided for each storage area. This is denoted, (with basic representations of QR codes 22′ denoted in square dashed lines in FIG. 8, simply to denote this possibility. Thus, broadly speaking, this (if such features are provided), would be within a scope of wherein there is a QR code for each of a plurality or all of the storage areas. (It has been made clear in the present application that there are many possible options other than QR code. Thus there feasibly could be NFC (technology) for each of a plurality or all of the storage areas. Thus it is technically feasible, (although may not be as efficient and/or low-tech), that there is Bluetooth for for each of a plurality or all of the storage areas. Similarly, any other method may be provided for each of a plurality or all of the storages areas, (eg providing a URL, (and generally the concept of providing an identifier that the user can manually utilize (eg by putting into a browser, using/inputting into an App, etc), a phone number, texting a number, etc to facilitate a user getting an unlocking code(s) for a storage area(s). Thus whenever one such option is disclosed in the present application, (anywhere in the present application), it is considered that any or all such options are possible/supported, (and may be provided). Thus this has been made clear). Looking at the example of FIG. 8, and how there could be a QR code for each storage area, it will be apparent how this could streamline the process of a user getting an unlocking code. If they decide they want an item(s) that is locked in one of the storage areas, then rather than in an embodiment where there could/would scan a QR code that takes them onto an interface to make their decision as to what storage area(s) they want to unlock, they instead, eg if they want to unlock storage area number ‘5’ in the example of FIG. 8, could just scan the QR code for that storage area. If the item content is free for that storage area, this could potentially give them the unlocking code without further steps required. (For example, the unlocking code could be provided on a webpage that the QR code directs the user's device (eg smartphone) to). If payment is required, it could potentially direct them to payment, without further steps required. Thus it can streamline the process in this way. Thus various option and/or embodiments are possible.

It should be stated, it is feasible the user could carry out (a portion or a whole of) the process(es) without using an electronic device ‘of the user’. To explain, if a storage apparatus, for example, was provided on a ground floor, for example, of a hotel, (this example being taken/provided simply by way of example only), it is feasible an interface could be provided, (eg built into a wall, for example, acting much like a computer, (perhaps even looking a lot like an internet TV), via which the user could carry out any (or possibly all) relevant action(s)/step(s) required by the user. (This could involve selecting a storage area(s), (if there are a plurality of storage areas, etc). This could be called a ‘console’, in this example. Thus it would be an electronic device. But in such case, it would not be an electronic device that belongs to the user. The example given would also be an example that is not a ‘mobile’ device. Thus it may stay in the same place. It would still, for the sake of the present application, be considered ‘remote’ to the storage apparatus, (as opposed to a storage apparatus/unit/machine that has its own interface (ie as part of the storage apparatus/unit/machine)). Another example of what could be considered a ‘console’, would be, in the use in a taxi (or any vehicle, for example), if there was a tablet-type device, which could be used to carry out a portion or a whole of any action(s)/step(s) required by the user. In such case, it is possible such a device could be used by the user, (rather than a device of their own, eg rather than using their smartphone, for example). The example of a ‘tablet-like’ device would be an example of a ‘mobile device’. However, it is possible it could be tethered in some way, (or in any way held/retrained/attached). (This could be to the taxi (vehicle) itself and/or the storage apparatus). One reason for this is to stop it being stolen, (eg by passengers). It should also be stated, whilst the example of a ‘tablet-type’ device is given, this is provided simply by way of example only. Similarly to the hotel example, there may be a more (or completely) permanent console. For example, an interface (electronic) could be attached very well to a part of the taxi, (eg the partition/wall shown/mentioned elsewhere in the present application), or could even be ‘built in’ to a part of the taxi, (eg the partition/wall shown/mentioned elsewhere in the present application). The hotel example and the taxi example may be afforded any of the feature(s)/disclosure apportioned to each other, the example provided by way of example only. And a ‘hotel’ and ‘taxi’ (vehicle) example are provided simply by way of example only. It will be apparent such feature(s)/disclosure/possibility(s) may be provided, not at all limited to these examples of use and/or location, and may be provided, not limited to any particular location, and thus this feature(s)/disclosure/possibility(s) is broadly disclosed. Thus various options and/or embodiments are possible. (Thus various examples of possible electronic device(s) are disclosed, not limited to the electronic device being an electronic device of the user. Thus various examples of possible electronic interface(s) are disclosed).

Furthermore, with regard to hotel use, (but not limited to hotel use, hers provided simply as an example), it is feasible a tv (eg internet TV) in a hotel room could be used, for example, to carry out any or all action(s). However, it should be stated, if the user is in accommodation they are occupying, then use of such an electronic device is considered, for the sake of the present application, to be an electronic device of the user. (Note: It would not be considered an electronic device of the user merely for being in a generic location of the hotel/location, (eg on the ground floor in a common are. But a device, (such as an internet TV, in this example), in a hotel room that the user is occupying, is considered, for the sake of the present application, to be an electronic device of the user.

It should be stated, it is possible the user may carry out step(s) on different electronic devices, (ie not using only one electronic device. For example, in the example of a hotel room where the user can use an (internet) TV for a portion or a whole of the process, it could be that the user could carry out a selection step(s), for example. Once they have selected, they may ultimately be sent an unlocking code(s) on a different electronic device. For example, they may be able to input their smartphone number, (eg on the internet TV, in this example), to get the/an unlocking code(s) sent to that device. Their phone number could even be stored, for example. (Eg The hotel may have taken their phone number previously. (Their phone number could even be associated with their room, for example. (The (internet) TV, in this example, may be associated with the room in some way, electronically, (ie more so than just being in the room)). Thus the unlocking code could then be texted to the user's phone, for example. (It is even feasible audio of the unlocking code could be sent to the phone, (eg via automated call, for example). It is even feasible the process can be designed in such way to force a user to use more than one electronic device to carry out the process. (Eg, in this example, they may only be able to commit to buying/getting something through the (internet) TV, in this example, and they may then only be able to receive the unlocking code to their smartphone, for example. Thus it is stated that it is possible for it to be designed so that more than one electronic device is needed, to complete the process.

According to another aspect of what is invented, a method for providing item access, comprising: an item being locked in a storage area of a storage apparatus via a lock; an unlocking code, to unlock the lock, being provided to a user, via an electronic device of the user; and the storage area being unlocked by the user via using the unlocking code. (Thus, according to this aspect, the lock is not limited to being a non-electronic lock. For example, the lock may be an electronic lock).

### In Use

An example(s) will now be described in use, described by way of example only, referring to a particularly preferred embodiment(s), (and most particularly to a preferred embodiment(s) as shown in the Figures), in no way limiting a scope of the invention. (Note: Step(s) are not necessarily provided in chronological order, (even if words such as ‘then’, or ‘now’, or ‘after this’ (or the like) are used), and, within reason, may be carried out in any order that is fitting/appropriate).

Thus, referring in use (by way of example) to a particularly preferred example, preferably: A person/party orders the/a storage apparatus online. (This party/person may, in this example, (provided by way of example only), be called/considered the ‘owner’ of the storage apparatus). It is received in the mail, for example. (Eg in a cardboard box/container, for example). The person/party expands it to its full size. Let us imagine for this example that the person/party happens to be a (short-term) vacation rental host and plans to have the apparatus in their vacation rental accommodation kitchen, for example, (or any room(s)), offering snacks for sale, for example, (or any item(s), not limited to edible items), when people visit the (short-term) rental accommodation. The person/party, for example, stocks cookies, candy and other items, (in this example, provided by way of example only), in each compartment, that the user renting the (short-term) (vacation) rental accommodation may want to purchase. (Note: ‘Stocking’/′restocking′ may be done by ‘staff’. (′Stocking’/′restocking′ may be done by any admin party)). A small metal pin, for example, (or any relevant item(s)), may be used to press into a hole on each lock and then manually a combination is set for each of the multiple locks, (eg ten locks, for example), on the apparatus by spinning the combination lock dials to the desired numbers. (This is just one example of a type of lock and how to set the locks. As will be apparent, (especially in light of the disclosure of the present application), various options and/or embodiments are possible for the/a lock(s), (and how to lock/′set′ them)). The party/person/owner (any relevant admin party) may visit an admin portal by visiting a URL, for example, or scanning a QR code, for example, (which may be on the back of the apparatus, for example), (they may even simply us an App), and then logs in, for example, online, for example, with their phone, for example, with their credentials, for example, by typing in a user name, for example, and password, for example. (It should also be stated, they may even simply use an App. Thus various options and/or embodiments are possible). They may find their storage apparatus in the admin portal (that may have already been created for them when they ordered the unit online, for example). They may enter the physical code(s), for example, they set for each of the locks in the online admin portal, for example, on their smartphone. And they may submit/save this, for example, (via the interface, for example). In this example, (provided by way of example only), they may then lock each storage area of the apparatus. In this example, the ‘user’ rents the (short-term) (vacation) rental accommodation, for example, and purchase some item(s) from the unit, for example. To make the purchases, the customer-user(s) may scan a QR code, (eg near the top of the apparatus) with their phone, for example, and are presented, for example, with storage area numbers, for example. After selecting a storage area number(s) on their phone, the customer-user pays and then is prompted with an unlocking code on their phone screen after making the payment. The customer-user moves the dials, (for example, if that is the type of lock used), on the combination lock with their hands for their desired storage area(s) to numbers that match the code they received. In this example embodiment, the user then opens a storage area(s) door, for example, and retrieves their item(s). Out of curiosity, (or for any other reason(s), the owner of the apparatus (or any relevant admin party) may log into an online dashboard in their admin portal, for example, and may see some purchase(s) were made. After the user(s) leave the vacation rental accommodation, the owner (or any relevant admin party) enters the house/place and finds five storage areas empty, out of the ten storage areas, for example. (Five purchases were made, in this example. (It should be stated, it may be possible to select multiple storage areas at a time, rather than having to go through the process for each storage area). The owner of the apparatus (or any relevant admin party) may add more cookies and snacks, for example, to the various open and empty compartments. The owner (or any relevant admin party) then uses their (metal) pin, (or relevant element, if this is an embodiment that requires such a thing), to press into a small hole, for example, on each storage area lock that was opened and spins, for example, the dials, for example, on the combination locks to a new set of numbers, for example. The owner (or any relevant admin party) then visits the URL, for example, of their admin portal, for example, or scans the QR code, for example, (that may be on the back of the apparatus), and logs into the admin portal, for example, to reset the unlocking codes, for example, in the admin portal, for example, to match the new lock codes they manually just changed. (The example of visiting a particular URL (and of use of a QR code) are provided by way of example only. There may be other ways to access/get to an interface, for example).

Thus an example has been described, in use.

It should be stated, once again, that the example(s) described, in use, is/are described simply by way of example only, referring to a particularly preferred embodiment(s), and in no way limiting a scope of the invention.

Thus an example has been described, in use. (It should be stated, once again, that the example(s) described, in use, is/are described simply by way of example only, referring to a particularly preferred embodiment(s), and in no way limiting a scope of the invention). (As stated, the steps are not necessarily in chronological order, and, within reason, may be carried out (and/or may occur) in any order that is fitting/appropriate. (It should also be stated that any steps in any claim(s) for a ‘method’ may be carried out in any order that is appropriate, and are not limited to having to be carried out in the order they appear in the claim unless this is explicitly stated in the claim, (ie unless words that explicitly make order clear are used)).

It should be stated, once again, that the example(s) described, in use, is/are described simply by way of example only, referring to a particularly preferred embodiment(s), and in no way limiting a scope of the invention.

According to another aspect of what is invented, there is provided: method for providing item access, comprising: an item being locked in a storage area of a storage apparatus via a lock; an unlocking code, to unlock the lock, being provided to a user, via an electronic device; and the storage area being unlocked by the user via using the unlocking code. According to this aspect, the electronic device may be any electronic device.

According to another aspect of what is invented, there is provided: method for providing item access, comprising: an item being locked in a storage area of a storage apparatus via a lock; an unlocking code, to unlock the lock, being provided to a user, via the or another electronic device of the user; and the storage area being unlocked by the user via using the unlocking code. According to this aspect, the electronic device may be any electronic device. According to this aspect, the term ‘the or another’ device is here used to make clear that different action(s)/part(s) of the/a method/process may be done with different electronic devices. For example, paying and/or selecting may be done with one electronic device, and the unlocking code may be provided to another electronic device, for example. (The term ‘the or another’ is inclusive, in the sense it can be interpreted as ‘the and/or another’ device(s)).

According to another aspect of what is invented, there is provided: method for providing item access, comprising: an item being locked in a storage area of a storage apparatus via a lock; an unlocking code, to unlock the lock, being provided to a user, via the or another electronic device; and the storage area being unlocked by the user via using the unlocking code.

According to another aspect of what is invented, there is provided: method for providing item access, comprising: an item being locked in a storage area of a storage apparatus; an unlocking code, to unlock the lock, being provided to a user, via the or another electronic device; and the storage area being unlocked by the user via using the unlocking code.

According to another aspect of what is invented, there is provided: method for providing item access, comprising: an item being locked in a storage area of a storage apparatus; an unlocking code, to unlock the lock, being provided to a user, via an electronic device; and the storage area being unlocked by the user via using the unlocking code.

Note: Any of the aspects (of what is invented) may comprise/draw upon any of the feature(s) of any other aspect(s) of what is invented, and may draw upon any of the feature(s) and/or disclosure of the present application, as optional and/or preferable feature(s). Any aspect(s) (of what is invented) may comprise/draw upon any feature(s) of any other aspect(s) (of what is invented), whether the feature(s) be essential or preferable and/or optional to the other aspect(s) (of what is invented).

The embodiments described above are provided by way of example only, and various other modifications will be apparent to persons skilled in the art without departing from the scope of the invention as defined in the appended claims.

### Broader And/Or Different Invention(s) May Be Claimed (And Are Supported)

The appended claims define limited inventions. However, it should be recognized and understood that the disclosure of the present application includes a vast array of inventions, not limited to inventions set out in the appended claims and/or any statement(s) of invention. For example, if the present disclosure of the present application (inclusive of drawing(s) and/or description) discloses features a to z, it should be recognized and understood that any invention may be claimed, comprising any feature(s) out of features a to z. Thus if the appended claim 1 defines the invention claimed as comprising essential features a, b, and c, it should be understood that an invention may be claimed comprising solely feature a, or solely feature b, or solely feature c, or any combination of features a, b, and c. Furthermore, it should be understood that an invention may be claimed comprising any of feature(s) d to z, whether or not also comprising any of features a, b, or c.

Furthermore, no feature disclosed is limited to only being set forth in a claim when used in conjunction with other particular feature(s) it is disclosed with in the specification, but may be claimed with any other feature or combination of features disclosed in the present application. Thus if a feature is disclosed ‘clustered’ with several other feature(s) when disclosed in the specification, the applicant(s) nevertheless reserves the right to ‘extract’ that feature(s) from the several other feature(s) it is disclosed with, and set it forth in a claim, combined with any other feature(s) disclosed in the present application, which other feature(s) may, or may not, also be ‘extracted’ from any other feature(s) they are clustered with in the disclosure of the present application. Thus any permutation/combination of features may be claimed for patent in a future claim and/or patent application.

A final claim is (or may be) appended which serves to signify that I reserve the right to claim any invention (ie ‘thing’), comprising any feature, or combination of features, disclosed in the present application (inclusive of drawing(s) and/or description). This statement (and/or final appended claim), if so desired, should be seen as a statement of invention, stating any invention (ie ‘thing’), comprising any feature, or combination of features disclosed in the present application (in any permutation/combination). The applicant(s) reserves the right to claim any (such) invention (ie ‘thing’), and considers an objection by a patent office/examiner (stating that such an invention is not supported by/disclosed in the present application) to be in direct conflict with this statement of invention. Thank you to the relevant patent office/examiner for taking note of this. It is intended (or plausible) that such invention(s) may be claimed in a future application(s) which claims benefit of priority of the present application, or, for example, in future filed claims of the present application. The present disclosure of the present application supports such invention(s)/claim(s).

### Adjectival And Adverbial Use, In The Present Application, Does Not Limit The Ability To Claim Without The Adjective/Adverb

In the present application, adjectival definition of a noun/feature in no way limits the ability to claim, (or in any way include in a claim(s)), the noun/feature, without the adjective. Thus if a ‘curved edge’ is disclosed, it should be understood that it is disclosed simply by way of example, as an embodiment of ‘an edge’, and that an invention may be claimed, comprising an ‘edge’, and not limited to comprising a ‘curved edge’, even if the only disclosure in the specification is of a ‘curved edge’. This goes for every single adjective example in the present application, and also applies to adverbs in the same way, with reference to how they limit a broader verb/action, which verb/action/characterizing feature may be included in a claim (and is supported), not limited by the adverb that further defines it. This also applies to ‘usage for’ definitions. Thus if an instrument/apparatus, for example, is described, with reference to use for a particular thing (eg a ‘pet cleaning apparatus’, (which is therefore a cleaning apparatus, for use on pets)), then a ‘cleaning apparatus’ may be claimed, (or in any way be included in a claim(s)), not limited to being a ‘pet’ cleaning apparatus and/or not limited to being for use on pets, even if all disclosure in the patent application relates to a ‘pet cleaning apparatus’.

### The Title Of The Present Application Does Not Limit What May Be Claimed

The title of the present application (and the claims presented) do not limit what may be claimed futurely, based upon (and supported by) the present application. For example, if the title is ‘Pet Cleaning Apparatus’, even if all disclosure in the patent application relates to a pet cleaning apparatus (as do the claims), nevertheless, a ‘cleaning apparatus’ may be claimed (not limited to being for pets), as it is clear a ‘pet cleaning apparatus’ is an embodiment of a ‘cleaning apparatus’. As stated previously, in the present application, adjectival definition of a noun in no way limits the ability to claim, (or in any way include in a claim(s)), the noun, without the adjective. This also applies to the title. Furthermore, an invention may be claimed comprising any feature, or combination of features, disclosed in the present application.

### Any Feature Disclosed May Be More Broadly Defined/Claimed As A Feature/Arrangement

Any feature (for/with a given purpose) disclosed in the present application, whatever it is disclosed or defined as, may be more broadly defined in a claim as a feature (or arrangement) for the given purpose. Thus, if, for example, in the present application, a ‘pin’ is disclosed, for holding element ‘a’ and element ‘b’ together, such disclosure supports definition in a claim (in this, or a future patent application that claims benefit of priority to the present patent application) of a ‘holding feature’ (or ‘holding arrangement’), for holding element ‘a’ and element ‘b’ together. This is the case for all feature(s)/disclosure, even including feature(s) defined in any statement(s) of invention and/or title of the invention.

### Feature(s) Shown In The Drawings May Be Combined To Form An Invention

Any feature(s) or combination of feature(s) shown in any drawing(s) may be combined with any other feature(s) or combination of feature(s) shown in any other drawing(s), to form an invention, which may be claimed. This may be the case for any embodiment shown in any drawing(s), and applicant(s) reserves the right to claim any such invention(s). Furthermore, such feature(s) may, of course, be combined with any other feature(s) and/or disclosure of the present application, to form an invention(s), which may be claimed. Such an invention(s) may be claimed in a future application(s) which claims benefit of priority of the present application, or, for example, in future filed claims of the present application. The present disclosure of the present application supports such invention(s)/claim(s).

1. A method for providing item access, comprising:
an item being locked in a storage area of a storage apparatus via a lock;
a user paying for the item via an electronic device of the user;
an unlocking code, to unlock the lock, being provided to the user, via the electronic device of the user; and
the storage area being unlocked by the user via using the unlocking code; wherein the lock is a non-electronic lock.

2. A method for providing item access as claimed in claim 1, wherein payment for the item by the user is an ownership payment, not merely a deposit for renting the item.

3. A method for providing item access as claimed in claim 2, wherein the item is an edible item.

4. A method for providing item access as claimed in claim 1, wherein the method comprises:
short-range interaction occurring with the electronic device of the user via short-range interaction technology, to facilitate providing the user with the unlocking code via the electronic device of the user.

5. A method for providing item access as claimed in claim 4, wherein the short-range interaction is facilitated by way of a QR code, the method comprising the user scanning the QR code with the electronic device.

6. A method for providing item access as claimed in claim 5, wherein the QR code is on the storage apparatus.

7. A method for providing item access as claimed in claim 1, wherein the method comprises:
identifying data being provided to the user, to facilitate providing the user with the unlocking code via the electronic device; and
the identifying data being inputted into the electronic device of the user by the user.

8. A method for providing item access as claimed in claim 1, wherein the method comprises:
the user seeing the item that is locked inside the storage area before paying for the item, the user being able to see into the storage area, to see the item.

9. A method for providing item access as claimed in claim 1, wherein there is provided an extra openable and closable opening for opening the storage area.

10. A method for providing item access as claimed in claim 9, wherein the storage apparatus comprises more than one said storage area, and the extra openable and closable opening opens a plurality or all of the storage areas.

11. A method for providing item access as claimed in claim 9, wherein the extra openable and closable opening is lockable, and is not unlockable by the user.

12. A method for providing item access as claimed in claim 1, wherein the storage apparatus is located in a vehicle.

13. A method for providing item access as claimed in claim 12, wherein the vehicle is a passenger fare vehicle, wherein the user paying for the item is a passenger of the vehicle.

14. A method for providing item access as claimed in claim 13, wherein the vehicle is a taxi.

15. A method for providing item access as claimed in claim 9, wherein the storage apparatus is located in a vehicle, the vehicle being a taxi, wherein the extra opening faces towards a front of the vehicle.

16. A method for providing item access as claimed in claim 12, wherein the method comprises:
a portion or a whole of the storage apparatus being held to at least one seating apparatus of the vehicle.

17. A method for providing item access as claimed in claim 1, wherein the method comprises:
a portion or a whole of the storage apparatus being held to at least one seating apparatus.

18. A method for providing item access as claimed in claim 1, wherein the storage apparatus comprises more than one storage area as defined in claim 1 within which an item is locked via a lock as defined in claim 1, the method further comprising:
with the electronic device, the user selecting at least one of the storage areas to unlock; and
an unlocking code as defined in claim 1 being provided to the user, via the electronic device of the user, for each storage area selected by the user for unlocking.

19. A method for providing item access as claimed in claim 18, wherein more than one of the more than one storage area is provided by way of a storage unit, the storage unit thus comprising more than one of the storage areas.

20. A method for providing item access as claimed in claim 1, wherein the electronic device of the user is a portable electronic device, designed for portable use.

21. A method for providing item access as claimed in claim 20, wherein the electronic device of the user is a smartphone.
